(19) United States
(12) Patent Application Publication
(10) Pub. No.: US 2025/0338860 A1
(43) Pub. Date: Nov. 6, 2025

(54) SWEETENER COMPOSITION, METHOD FOR REDUCING BROWNING, AND FOOD PRODUCT

(71) Applicant: TATE & LYLE SOLUTIONS USA LLC, Hoffman Estates, IL (US)

(72) Inventors: Jenny Chun Siegfeld, Kiel (DE); Gautier Cesbron-Lavau, Kiel (DE); Sven Tiedemann, Kiel (DE)

(21) Appl. No.: 18/854,169

(22) PCT Filed: Apr. 4, 2023
(86) PCT No.: PCT/GB2023/050896

§ 371 Date: Oct. 4, 2024

(30) Foreign Application Priority Data
Apr. 4, 2022 (GB) 2204932.4
Nov. 3, 2022 (GB) 2216364.6

(51) Int. Cl. A21D 2/18; A21D 2/02; A21D 10/04; A21D 13/80; A23L 5/10; A23L 27/30; A23L 29/30

(52) U.S. Cl. CPC A21D 2/181; A21D 2/02; A21D 10/04; A21D 13/80; A23L 5/10; A23L 27/33; A23L 29/30

(57) ABSTRACT

A divalent metal ion salt, such as a calcium salt, for the reduction of browning of a reducing saccharide and/or the formation of acrylamide during heating in the presence of an amine-containing food ingredient: a sweetener composition comprising a divalent metal ion salt and a reducing saccharide: use of a divalent metal ion salt for the reduction of browning and acrylamide formation in a food product comprising a reducing saccharide during heating in the presence of an amine-containing additional food ingredient: a method for reducing browning and acrylamide formation in a food product, wherein the method comprises: a) combining a reducing saccharide with a divalent metal salt and at least one amine-containing additional food ingredient to provide an unheated food product; and b) optionally heating the unheated food product to provide a heated food product; and a food product comprising: a reducing saccharide, a divalent metal ion salt, and an amine-containing additional food ingredient.

### FIELD OF THE INVENTION

The present invention relates to the use of a divalent metal ion salt for the reduction of browning of a reducing saccharide and/or the formation of acrylamide during heating in the presence of an amine-containing food ingredient.

### BACKGROUND OF THE INVENTION

Many food and beverage products contain sucrose (generally referred to as ‘sugar’ or ‘table sugar’ and also referred to as ‘saccharose’). Sucrose imparts sweetness, bulk, texture and desirable functional properties such as browning, humectancy, freezing point depression and the like.

A desirable property of sucrose is its ability to brown when heated, for example in cooking or baking. Browning of food can proceed via enzymatic browning. Enzymatic browning occurs mostly in fruit and vegetables, and foods containing fruit and vegetables, and commonly involves the oxidation of phenols to quinones followed my enzymatic polymerization of the quinones to form brown pigment compounds. Browning of food can also proceed via non-enzymatic browning. Non-enzymatic browning can proceed via caramelisation, which is the breakdown of sugars upon heating. Caramelisation temperatures differ for different sugars. Fructose has a caramelisation onset temperature of about 110° C. Glucose and galactose have a caramelisation onset temperature of about 160° C. Non-enzymatic browning can also proceed via the Maillard reaction, which is the result of interaction between proteins or amino acids and reducing sugars. The Maillard reaction has an onset temperature of between about 140° C. and 165° C.

Sugars that are present in food, whether naturally present in the ingredients or added, therefore play an important role in the development of colour during cooking. Caramelisation and the Maillard reaction are desirable because they improve the organoleptic properties of the food product. A certain amount of browning is often acceptable, even desirable. However, too much caramelisation or Maillard reaction can lead to undesirable effects, such as the appearance of acrylamides, a burnt taste or an overly dark colour.

Mastering the balance between an acceptable and unacceptable level of browning is key in making a baked product. As a conventional sugar, the browning properties of sucrose are well characterised. For example, it is understood that the Maillard reaction does not occur with sucrose because it is non-reducing sugar.

Although desirable in terms of taste and functional properties, excess intake of nutritive sweeteners such as sucrose has long been associated with diet-related health issues, such as obesity, heart disease, metabolic disorders and dental problems. Accordingly, consumers are increasingly looking for ways to decrease the amount of nutritive sweeteners in their diets. Sugar reduction or replacement is therefore increasingly important for food manufacturers.

An important class of sweetener is represented by ‘high potency sweeteners’ or ‘high intensity sweeteners’. Sweeteners falling within this class have a sweetness many times that of sucrose, such that only very small amounts are needed to provide an equivalent level of sweetness to that of the nutritive sweetener being replaced. High potency sweeteners typically require the addition of a bulking agent (for example, a non-sweet saccharide polymer such as polydextrose or maltodextrin).

Another important class of sweetener is represented by ‘sugar alcohols’ or ‘polyols’ (for example, erythritol, xylitol, sorbitol, maltitol etc.). These sweeteners are generally able to provide a degree of calorie reduction (by way of example, sorbitol provides about 2.6 kcal/g compared to about 4 kcal/g for sucrose) while also providing bulk, but are often not able to fully mimic the desired taste characteristics (they often produce a perceived cooling sensation) or functional properties (such as browning).

A further important class of sweetener is represented by ‘rare sugars’ (for example, allulose, tagatose and allose). Sweeteners falling in this class can provide sweetness comparable to sucrose, but do not have the same energy content. By way of example, allulose provides around 70% of the sweetness of sucrose, but only around 5% of the calories (approximately 0.2 kcal/g).

However, many compounds that are important in sugar reduction and replacement exhibit excessive browning when heated, which limits their ability to use them in heated (such as cooked or baked) food products. This is particularly the case with reducing saccharides (reducing sugars and reducing polysaccharides), for example allulose and polydextrose, in contexts where they are heated in the presence of a protein or amino acid.

### SUMMARY OF THE INVENTION

In one aspect, the present invention provides a sweetener composition comprising a divalent metal ion salt and a reducing saccharide.

In some embodiments, the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

In some embodiments, the divalent metal ion salt is an alkaline earth metal salt.

In some embodiments, the divalent metal ion salt is a calcium salt.

In some embodiments, the calcium salt is any selected from the group consisting of calcium lactate, calcium carbonate, calcium citrate, calcium chloride, calcium phosphate, calcium sulfate, and any combination thereof.

In some embodiments, the sweetener composition comprises a non-reducing saccharide, such as sucrose.

In some embodiments, the sweetener composition is a dry sweetener composition.

In some embodiments, the dry sweetener composition is in granulated form, crystalline form, powder form or tablet form.

In some embodiments, the dry sweetener composition comprises the reducing saccharide in an amount of from about 1% by weight to about 99% by weight based on the total weight of the sweetener composition.

In some embodiments, the dry sweetener composition comprises a non-reducing saccharide in an amount of from about 1% by weight to about 99% by weight based on the total weight of the sweetener composition.

In some embodiments, the dry sweetener composition comprises the divalent metal ion salt in an amount of from about 1% by weight to about 20% by weight based on the total weight of the sweetener composition.

In some embodiments, the sweetener composition is a syrup.

In some embodiments, the syrup has a total dry solids content of from about 50% by weight to about 85% by weight.

In some embodiments, the syrup has a saccharide content of from about 80% by weight to about 99% by weight on a dry solids basis.

In some embodiments, the syrup has a reducing saccharide content of from about 5% by weight to about 99% by weight on a dry solids basis.

In some embodiments, the syrup has a non-reducing saccharide content of from about 5% by weight to about 99% by weight on a dry solids basis.

In some embodiments, the syrup has a divalent metal ion salt content of from about 1% by weight to about 20% by weight on a dry solids basis.

In some embodiments, the sweetener composition is less prone to browning when heated in the presence of an amine than the same sweetener composition in which the divalent metal ion salt is replaced with a corresponding potassium salt in a stoichiometric amount based on the free metal ion content.

In some embodiments, the sweetener composition is less prone to acrylamide formation when heated in the presence of an amine than the same sweetener composition in which the divalent metal ion salt is replaced with a corresponding potassium salt in a stoichiometric amount based on the free metal ion content.

In some embodiments, the reduction in browning and/or acrylamide formation is determined relative to the same system in which a corresponding potassium salt is used in place of the divalent metal ion salt in a stoichiometric amount based on the free metal ion content. In some embodiments, the reduction in browning and/or acrylamide formation is determined relative to the same system in which potassium chloride is used in place of the divalent metal ion salt in a stoichiometric amount based on the free metal ion content.

In some aspects, the invention provides the use of a divalent metal ion salt for the reduction of browning in a food product comprising a reducing saccharide during heating in the presence of an amine-containing additional food ingredient.

In some aspects, the invention provides the use of a divalent metal ion salt for the reduction of acrylamide formation in a food product comprising a reducing saccharide during heating in the presence of an amine-containing additional food ingredient.

In some aspects, the invention provides a method for reducing browning in a food product, wherein the method comprises:
a) combining a reducing saccharide with a divalent metal salt and at least one amine-containing additional food ingredient to provide an unheated food product; and
b) optionally heating the unheated food product to provide a heated food product.

In some aspects, the invention provides a method for reducing acrylamide formation in a food product, wherein the method comprises:
a) combining a reducing saccharide with a divalent metal salt and at least one amine-containing additional food ingredient to provide an unheated food product; and
b) optionally heating the unheated food product to provide a heated food product.

In some embodiments, the unheated food product is a precursor to a heated food product, for example wherein the food product is a dough or batter.

In some embodiments, the amine-containing additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

In some embodiments, the amine is a protein, an amino acid, or a combination thereof.

In some embodiments, step a) comprises combining a non-reducing saccharide, such as sucrose, with the reducing saccharide, divalent metal ion salt and amine-containing additional food ingredient to provide an unheated food product.

In some embodiments, the saccharide content of the unheated food product is from about 1% by weight to about 80% by weight relative to the total weight of the unheated food product.

In some embodiments, a reducing saccharide content of the unheated food product is from about 1% by weight to about 80% by weight relative to the total weight of the unheated food product.

In some embodiments, a non-reducing saccharide content of the unheated food product is from about 1% by weight to about 80% by weight relative to the total weight of the unheated food product.

In some embodiments, the divalent metal ion salt is provided in an amount sufficient to provide a free divalent metal ion content of from about 0.01% by weight to about 1% by weight relative to the total weight of the unheated food product.

In some embodiments, the divalent metal ion salt is provided in an amount sufficient to provide a free divalent metal ion content of from about 0.1% by weight to about 0.3% by weight relative to the total weight of the unheated food product.

In some embodiments, the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

In some embodiments, the divalent metal ion salt is an alkaline earth metal salt. In some embodiments, the divalent metal ion salt is a calcium salt.

In some embodiments, the calcium salt is any selected from the group consisting of calcium lactate, calcium carbonate, calcium citrate, calcium chloride, calcium phosphate, calcium sulfate, and any combination of the foregoing.

In some embodiments, the unheated food product is less prone to browning when heated than the same food product in which the divalent metal ion salt is replaced with a corresponding potassium salt in a stoichiometric amount based on the free metal ion content.

In some embodiments, the unheated food product is less prone to acrylamide formation when heated than the same food product in which the divalent metal ion salt is replaced with a corresponding potassium salt in a stoichiometric amount based on the metal ion content.

In some embodiments, the heated food product is lighter in colour than the same food product in which the divalent metal ion salt is replaced with a potassium salt in a stoichiometric amount based on the free metal ion content.

In some embodiments, the heated food product has a lower acrylamide content than the same food product in which the divalent metal ion salt is replaced with a potassium salt in a stoichiometric amount based on the metal ion content.

Another aspect provides a food product comprising: a reducing saccharide, a divalent metal ion salt, and an amine-containing additional food ingredient.

In some embodiments, the additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

In some embodiments, the amine is a protein, an amino acid, or a combination thereof.

In some embodiments, the food product comprises a non-reducing saccharide, such as sucrose.

In some embodiments, the food product has a saccharide content of from about 1% by weight to about 80% by weight relative to the total weight of the food product.

In some embodiments, the food product comprises the divalent metal ion salt in an amount sufficient to provide a free divalent metal ion content of from about 0.01% by weight to about 1% by weight relative to the total weight of the food product.

In some embodiments, the food product contains the divalent metal ion salt in an amount of from about 0.1% by weight to about 2.0% by weight relative to the total weight of the food product.

In some embodiments, the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

In some embodiments, the divalent metal ion salt is an alkaline earth metal salt.

In some embodiments, the divalent metal ion salt is a calcium salt.

In some embodiments, the calcium salt is any selected from the group consisting of calcium lactate, calcium carbonate, calcium citrate, calcium chloride, calcium phosphate, calcium sulfate, and any combination of the foregoing.

In some embodiments, the food product is a precursor to a heated food product.

In some embodiments, the food product is a dough or batter.

In some embodiments, the food product is less prone to browning than the same food product in which the divalent metal ion salt is replaced with potassium chloride in a stoichiometric amount based on the free metal ion content.

In some embodiments, the food product is less prone to acrylamide formation than the same food product in which the divalent metal ion salt is replaced with potassium chloride in a stoichiometric amount based on the free metal ion content.

In some embodiments, the food product is a heated food product.

In some embodiments, the heated food product is a cake or biscuit.

In some embodiments, the food product is lighter in colour than the same food product in which the divalent metal ion salt is replaced with a corresponding potassium salt in a stoichiometric amount based on the free metal ion content.

In some embodiments, the food product has a lower acrylamide content than the same food product in which the divalent metal ion salt is replaced with a corresponding potassium salt in a stoichiometric amount based on the free metal ion content.

### BRIEF DESCRIPTION OF THE DRAWINGS

FIG. 1 shows photographs of the biscuits of Example 1.

FIG. 2 shows the CIE 1976 L*a*b* colour space with axes.

FIG. 3 shows photographs of the biscuits of Example 1 before baking and after baking in different conditions.

FIG. 4 shows photographs of the biscuits of Example 2 before baking and after baking in different conditions.

FIG. 5 shows photographs of the biscuits of Example 3 before baking and after baking in different conditions.

FIG. 6 shows photographs of the biscuits of Example 4 before baking and after baking in different conditions.

FIG. 7 shows photographs of the muffins of Example 5 before baking and after baking in different conditions.

FIG. 8 shows photographs of the muffins of Example 6 after baking in different conditions.

FIG. 9 shows photographs of the muffins of Example 7 after baking in different conditions.

FIG. 10 shows photographs of the muffins of Examples 8 to 10 after baking in different conditions.

FIG. 11 shows photographs of the muffins of Example 11.

FIG. 12 shows photographs of the muffins of Examples 12-1 to 12-6 and Comparative Examples 12-1 to 12-6

FIG. 13 shows photographs of the muffins of Examples 12-7 to 12-12 and Comparative Examples 12-7 to 12-12.

FIG. 14 shows photographs of the muffins of Examples 12-13 to 12-15 and Comparative Examples 12-13 to 12-15.

FIG. 15 shows photographs of the loaf cakes of Examples 13-1, 13-2 and Comparative Example 13-1.

### DETAILED DESCRIPTION

The present invention relates to the use of a divalent metal ion salt for the reduction of browning in a food product comprising a reducing saccharide during heating in the presence of an amine-containing additional food ingredient.

The present inventors found that when using a reducing saccharide, such as allulose, fructose or soluble corn fibre, in the production of baked goods, such as biscuits or cakes, excessive browning occurred. The inventors sought a solution to the excessive browning. The inventors found that including a divalent metal ion salt, such as a calcium salt, in the recipe reduced browning of the reducing saccharide in the baked goods to an acceptable level. The inventors also found that the same effect was observed at higher moisture contents, such as in cake/muffin batter.

According to one aspect, the present invention provides a sweetener composition comprising a divalent metal ion salt and a reducing saccharide.

The reducing saccharide is preferably any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing. In some embodiments, the reducing saccharide is a rare sugar, such as allulose, tagatose or allose. In some embodiments, the reducing saccharide is allulose. In some embodiments, the reducing saccharide is a polysaccharide. In some embodiments, the reducing saccharide is a soluble dietary fibre. In some embodiments, the reducing saccharide is soluble corn fibre or polydextrose. In some embodiments, the reducing saccharide is fructose.

In some embodiments, the divalent metal ion salt is an alkaline earth metal salt. For instance, the divalent metal ion salt may be a calcium or magnesium salt. For example, the divalent metal ion salt may be any selected from the group consisting of calcium lactate, calcium carbonate, calcium citrate, calcium chloride, calcium phosphate, calcium sulfate, magnesium lactate, magnesium carbonate, magnesium citrate, magnesium chloride, magnesium phosphate, magnesium sulfate and any combination thereof. In some embodiments, the divalent metal ion salt is a calcium salt. For instance, the calcium salt may be any selected from the group consisting of calcium lactate, calcium carbonate, calcium citrate, calcium chloride, calcium phosphate, calcium sulfate, and any combination thereof. In preferred embodiments, the calcium salt is calcium chloride, calcium lactate, calcium sulfate, or calcium phosphate. In preferred embodiments, the calcium salt is calcium chloride, calcium lactate, or calcium sulfate. In a most preferred embodiment, the calcium salt is calcium chloride.

The sweetener composition may further comprise salts of other metals. For instance, the sweetener composition may further comprise monovalent metal ion salts. By way of example, the sweetener composition may further comprise alkali metal salts, such as any selected from the group consisting of sodium lactate, sodium carbonate, sodium citrate, sodium chloride, sodium phosphate, sodium sulfate, potassium lactate, potassium carbonate, potassium citrate, potassium chloride, potassium phosphate, potassium sulfate and any combination thereof.

In some embodiments, the sweetener composition comprises a non-reducing saccharide. In some embodiments, the sweetener composition comprises sucrose. In other words, in some embodiments the sweetener composition comprises a combination of the non-reducing sugar and sucrose. For example, the sweetener composition may comprise a combination of allulose and sucrose, a combination of soluble corn fibre and sucrose, or a combination of polydextrose and sucrose.

In some embodiments, the sweetener composition is a dry sweetener composition. The dry sweetener composition may be in granulated form, crystalline form, powder form or tablet form.

In some embodiments, the dry sweetener composition comprises the reducing saccharide in an amount of from about 1% by weight to about 99% by weight based on the total weight of the sweetener composition. In some embodiments, the dry sweetener composition comprises the reducing saccharide in an amount of from about 2%, about 5%, about 10%, about 20%, about 30%, about 40%, about 50%, about 60%, about 70%, about 80%, about 90%, or about 95% by weight to about 99% by weight based on the total weight of the sweetener composition. In some embodiments, the dry sweetener composition comprises the reducing saccharide in an amount of from about 1% to about 2%, about 5%, about 10%, about 20%, about 30%, about 40%, about 50%, about 60%, about 70%, about 80%, about 90%, or about 95% by weight based on the total weight of the sweetener composition. In some embodiments, the dry sweetener composition comprises the reducing saccharide in an amount of from about 50% to about 60%, about 70%, about 80%, about 90%, or about 95% by weight based on the total weight of the sweetener composition. In some embodiments, the dry sweetener composition comprises the reducing saccharide in an amount of from about 60% to about 70%, about 80%, about 90%, or about 95% by weight based on the total weight of the sweetener composition. In some embodiments, the dry sweetener composition comprises the reducing saccharide in an amount of from about 70% to about 80%, about 90%, or about 95% by weight based on the total weight of the sweetener composition. In some embodiments, the dry sweetener composition comprises the reducing saccharide in an amount of from about 80% to about 90%, or about 95% by weight based on the total weight of the sweetener composition. In some embodiments, the dry sweetener composition comprises the reducing saccharide in an amount of from about 90% to about 95% by weight based on the total weight of the sweetener composition. For example, the dry sweetener composition may comprise the reducing saccharide in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight based on the total weight of the sweetener composition.

In some embodiments, the dry sweetener composition comprises a non-reducing saccharide, such as sucrose, in an amount of from about 1% by weight to about 99% by weight based on the total weight of the sweetener composition. In some embodiments, the dry sweetener composition comprises the non-reducing saccharide in an amount of from about 2%, about 5%, about 10%, about 20%, about 30%, about 40%, about 50%, about 60%, about 70%, about 80%, about 90%, or about 95% by weight to about 98% by weight based on the total weight of the sweetener composition. In some embodiments, the dry sweetener composition comprises the non-reducing saccharide in an amount of from about 1% to about 2%, about 5%, about 10%, about 20%, about 30%, about 40%, about 50%, about 60%, about 70%, about 80%, about 90%, or about 95% by weight based on the total weight of the sweetener composition. In some embodiments, the dry sweetener composition comprises the non-reducing saccharide in an amount of from about 50% to about 60%, about 70%, about 80%, about 90%, or about 95% by weight based on the total weight of the sweetener composition. In some embodiments, the dry sweetener composition comprises the non-reducing saccharide in an amount of from about 60% to about 70%, about 80%, about 90%, or about 95% by weight based on the total weight of the sweetener composition. In some embodiments, the dry sweetener composition comprises the non-reducing saccharide in an amount of from about 70% to about 80%, about 90%, or about 95% by weight based on the total weight of the sweetener composition. In some embodiments, the dry sweetener composition comprises the non-reducing saccharide in an amount of from about 80% to about 90%, or about 95% by weight based on the total weight of the sweetener composition. In some embodiments, the dry sweetener composition comprises the non-reducing saccharide in an amount of from about 90% to about 95% by weight based on the total weight of the sweetener composition. For example, the dry sweetener composition may comprise the non-reducing saccharide in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, or 98% by weight based on the total weight of the sweetener composition.

In some embodiments, the dry sweetener composition comprises the reducing saccharide and the non-reducing saccharide in a combined amount of from about of 1% by weight to about 99% by weight based on the total weight of the sweetener composition. In some embodiments, the dry sweetener composition comprises the reducing saccharide and the non-reducing saccharide in a combined amount of from about 2%, about 5%, about 10%, about 20%, about 30%, about 40%, about 50%, about 60%, about 70%, about 80%, about 90%, or about 95% by weight to about 99% by weight based on the total weight of the sweetener composition. In some embodiments, the dry sweetener composition comprises the reducing saccharide and the non-reducing saccharide in a combined amount of from about 1% to about 2%, about 5%, about 10%, about 20%, about 30%, about 40%, about 50%, about 60%, about 70%, about 80%, about 90%, or about 95% by weight based on the total weight of the sweetener composition. In some embodiments, the dry sweetener composition comprises the reducing saccharide and the non-reducing saccharide in a combined amount of from about 50% to about 60%, about 70%, about 80%, about 90%, or about 95% by weight based on the total weight of the sweetener composition. In some embodiments, the dry sweetener composition comprises the reducing saccharide and the non-reducing saccharide in a combined amount of from about 60% to about 70%, about 80%, about 90%, or about 95% by weight based on the total weight of the sweetener composition. In some embodiments, the dry sweetener composition comprises the reducing saccharide and the non-reducing saccharide in a combined amount of from about 70% to about 80%, about 90%, or about 95% by weight based on the total weight of the sweetener composition. In some embodiments, the dry sweetener composition comprises the reducing saccharide and the non-reducing saccharide in a combined amount of from about 80% to about 90%, or about 95% by weight based on the total weight of the sweetener composition. In some embodiments, the dry sweetener composition comprises the reducing saccharide and the non-reducing saccharide in a combined amount of from about 90% to about 95% by weight based on the total weight of the sweetener composition. For example, the dry sweetener composition may comprise the reducing saccharide and the non-reducing saccharide in a combined amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight based on the total weight of the sweetener composition, as well as all intermediate values.

In some embodiments, the dry sweetener composition comprises the divalent metal ion salt in an amount of from about 1% by weight to about 20% by weight based on the total weight of the sweetener composition. In some embodiments, the dry sweetener composition comprises the divalent metal ion salt in an amount of from about 2%, about 3%, about 4%, about 5%, about 6%, about 7%, about 8%, about 9%, about 10%, about 11%, about 12%, about 12%, about 13%, about 14%, about 15%, about 16%, about 17%, about 18%, or about 19% by weight to about 20% by weight based on the total weight of the sweetener composition. In some embodiments, the dry sweetener composition comprises the divalent metal ion salt in an amount of from about 2% to about 3%, about 4%, about 5%, about 6%, about 7%, about 8%, about 9%, about 10%, about 11%, about 12%, about 12%, about 13%, about 14%, about 15%, about 16%, about 17%, about 18%, or about 19% by weight based on the total weight of the sweetener composition. In some embodiments, the dry sweetener composition comprises the divalent metal ion salt in an amount of from about 5% to about 15% by weight, from about 8% to about 7% to about 13%, or from about 9% to about 11% by weight based on the total weight of the sweetener composition. For example, the dry sweetener composition may comprise the divalent metal ion salt in an amount of about 1%, 2%, 3%, 4%, 5%, 6%, 7%, 8%, 9%, 10%, 11%, 12%, 13%, 14%, 15%, 16%, 17%, 18%, 19%, or 20% by weight based on the total weight of the sweetener composition, as well as all intermediate values.

In some embodiments, the sweetener composition is a syrup.

In some embodiments, the syrup has a total dry solids content of from about 50% by weight to about 85% by weight. In another embodiment, the total dry solids content of the syrup is from 50% to 70% by weight. For example, the total dry solids content may be 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, or 85% by weight, as well as all intermediate values.

In an embodiment, the total dry solids content of the syrup is from 70% to 80% by weight. In an embodiment, the total dry solids content of the syrup is from 71% to 80% by weight. In an embodiment, the total dry solids content of the syrup is from 71% to 78% by weight. In an embodiment, the total dry solids content of the syrup is from 70% to 78% by weight. In another embodiment, the total dry solids content of the syrup is from 71% to 73% by weight. In another embodiment, the total dry solids content of the syrup is from 76% to 78% by weight.

In some embodiments, the syrup has a saccharide content of from about 80% by weight to about 99% by weight on a dry solids basis. For example, the syrup may have a saccharide content of about 80%, 81%, 82%, 83%, 84%, 85%, 86%, 87%, 88%, 89%, 90%, 91%, 92%, 93%, 94%, 95%, 96%, 97%, 98%, or 99% by weight on a dry solids basis, as well as all intermediate values.

In an embodiment, the syrup has a saccharide content of at least 90% by weight on a dry solids basis (i.e., of the total dry solids present in the syrup, at least 90% by weight is saccharides). In an embodiment, the syrup has a saccharide content of at least 95% by weight on a dry solids basis.

In some embodiments, the syrup has a reducing saccharide content of from about 5% by weight to about 99% by weight on a dry solids basis. In some embodiments, the syrup has a reducing saccharide content of from about 2%, about 5%, about 10%, about 20%, about 30%, about 40%, about 50%, about 60%, about 70%, about 80%, about 90%, or about 95% by weight to about 99% by weight on a dry solids basis. In some embodiments, the syrup has a reducing saccharide content of from about 1% to about 2%, about 5%, about 10%, about 20%, about 30%, about 40%, about 50%, about 60%, about 70%, about 80%, about 90%, or about 95% by weight on a dry solids basis. In some embodiments, the syrup has a reducing saccharide content of from about 50% to about 60%, about 70%, about 80%, about 90%, or about 95% by weight on a dry solids basis. In some embodiments, the syrup has a reducing saccharide content of from about 60% to about 70%, about 80%, about 90%, or about 95% by weight on a dry solids basis. In some embodiments, the syrup has a reducing saccharide content of from about 70% to about 80%, about 90%, or about 95% by weight on a dry solids basis. In some embodiments, the syrup has a reducing saccharide content of from about 80% to about 90%, or about 95% by weight on a dry solids basis. In some embodiments, the syrup has a reducing saccharide content of from about 90% to about 95% by weight on a dry solids basis. For example, the dry sweetener composition may comprise the reducing saccharide in an amount of about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight on a dry solids basis, as well as all intermediate values.

In some embodiments, the syrup has a non-reducing saccharide content of from about 5% by weight to about 99% by weight on a dry solids basis. In some embodiments, the syrup has a non-reducing saccharide content of from about 2%, about 5%, about 10%, about 20%, about 30%, about 40%, about 50%, about 60%, about 70%, about 80%, about 90%, or about 95% by weight to about 98% by weight on a dry solids basis. In some embodiments, the syrup has a non-reducing saccharide content of from about 1% to about 2%, about 5%, about 10%, about 20%, about 30%, about 40%, about 50%, about 60%, about 70%, about 80%, about 90%, or about 95% by weight on a dry solids basis. In some embodiments, the syrup has a non-reducing saccharide content of from about 50% to about 60%, about 70%, about 80%, about 90%, or about 95% by weight on a dry solids basis. In some embodiments, the syrup has a non-reducing saccharide content of from about 60% to about 70%, about 80%, about 90%, or about 95% by weight on a dry solids basis. In some embodiments, the syrup has a non-reducing saccharide content of from about 70% to about 80%, about 90%, or about 95% by weight on a dry solids basis. In some embodiments, the syrup has a non-reducing saccharide content of from about 80% to about 90%, or about 95% by weight on a dry solids basis. In some embodiments, the syrup has a non-reducing saccharide content of from about 90% to about 95% by weight on a dry solids basis. For example, the dry sweetener composition may comprise the non-reducing saccharide in an amount of about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight on a dry solids basis, as well as all intermediate values.

In some embodiments, the syrup has a divalent metal ion salt content of from about 1% by weight to about 20% by weight on a dry solids basis. In some embodiments, the syrup comprises the divalent metal ion salt in an amount of from about 2%, about 3%, about 4%, about 5%, about 6%, about 7%, about 8%, about 9%, about 10%, about 11%, about 12%, about 12%, about 13%, about 14%, about 15%, about 16%, about 17%, about 18%, or about 19% by weight to about 20% by weight on a dry solids basis. In some embodiments, the syrup comprises the divalent metal ion salt in an amount of from about 2% to about 3%, about 4%, about 5%, about 6%, about 7%, about 8%, about 9%, about 10%, about 11%, about 12%, about 12%, about 13%, about 14%, about 15%, about 16%, about 17%, about 18%, or about 19% by weight on a dry solids basis. In some embodiments, the syrup comprises the divalent metal ion salt in an amount of from about 5% to about 15% by weight, from about 8% to about 7% to about 13%, or from about 9% to about 11% by weight on a dry solids basis. For example, the syrup may comprise the divalent metal ion salt in an amount of about 1%, 2%, 3%, 4%, 5%, 6%, 7%, 8%, 9%, 10%, 11%, 12%, 13%, 14%, 15%, 16%, 17%, 18%, 19%, or 20% by weight on a dry solids basis, as well as all intermediate values.

In some embodiments, the sweetener composition is less prone to browning when heated in the presence of an amine than the same sweetener composition in which the calcium salt is replaced with a corresponding potassium salt in a stoichiometric amount based on the metal ion content.

In some embodiments, the sweetener composition is less prone to acrylamide formation when heated in the presence of an amine than the same sweetener composition in which the divalent metal ion salt is replaced with a corresponding potassium salt in a stoichiometric amount based on the metal ion content.

In some embodiments, the sweetener composition (dry or syrup) comprises the reducing saccharide in an amount of from about 1% by weight to about 99% by weight based on the combined weight of the reducing saccharide and the non-reducing saccharide in the sweetener composition. In some embodiments, the sweetener composition comprises the reducing saccharide in an amount of from about 2%, about 5%, about 10%, about 20%, about 30%, about 40%, about 50%, about 60%, about 70%, about 80%, about 90%, or about 95% by weight to about 99% by weight based on the combined weight of the reducing saccharide and the non-reducing saccharide in the sweetener composition. In some embodiments, the sweetener composition comprises the reducing saccharide in an amount of from about 1% to about 2%, about 5%, about 10%, about 20%, about 30%, about 40%, about 50%, about 60%, about 70%, about 80%, about 90%, or about 95% by weight based on the combined weight of the reducing saccharide and the non-reducing saccharide in the sweetener composition. In some embodiments, the sweetener composition comprises the reducing saccharide in an amount of from about 10% to about 90%, from about 20% to about 80%, from about 30% to about 70%, from about 40% to about 60%, or from about 45% to about 55% by weight based on the combined weight of the reducing saccharide and the non-reducing saccharide in the sweetener composition. In some embodiments, the sweetener composition comprises the reducing saccharide in an amount of from about 10% to about 30%, about 15% to about 25%, about 15% to about 30%, or from about 10% to about 25% by weight based on the combined weight of the reducing saccharide and the non-reducing saccharide in the sweetener composition. In some embodiments, the sweetener composition comprises the reducing saccharide in an amount of from about 10% to about 20%, from about 20% to about 30%, from about 30% to about 40%, from about 40% to about 50%, from about 50% to about 60%, from about 60% to about 70%, from about 70% to about 80%, or from about 80% to about 90% by weight based on the combined weight of the reducing saccharide and the non-reducing saccharide in the sweetener composition. For example, the sweetener composition may comprise the reducing saccharide in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight based on the combined weight of the reducing saccharide and the non-reducing saccharide in the sweetener composition, as well as all intermediate values.

In a preferred embodiment, the sweetener composition (dry or syrup) comprises at least one high intensity sweetener. According to an embodiment, the sweetener composition comprises the reducing saccharide in an amount of from about 5% by weight to about 95% by weight relative to the total weight of the sweetener composition, for example in an amount of from about 20% to about 50% by weight relative to the total weight of the sweetener composition. According to an embodiment, the at least one high intensity sweetener of the sweetener composition is selected from the group consisting of stevia extracts, monk fruit extracts, a combination of stevia and monk fruit extracts, and sucralose. In some embodiments, the sweetener composition comprises the reducing saccharide in an amount of from about 50% to about 99% by weight relative to the total weight of the sweetener composition, stevia extract in an amount of from about 0.10% to about 0.20% by weight relative to the total weight of the sweetener composition; monk fruit extract in an amount of from about 0.02% to about 0.09% by weight relative to the total weight of the sweetener composition, and the divalent metal ion salt in an amount of from about 0.1% to about 10% by weight relative to the total weight of the sweetener composition.

The amount of high intensity sweetener can be varied according to the target application and the potency of the high intensity sweetener used. It will often be convenient for the at least one high intensity sweetener to be provided in an amount such that the sweetener composition is able to provide an equivalent sweetness per unit volume to that of the one or more nutritive sweeteners being replaced. In embodiments where a combination of stevia and monk fruit extracts is used as the at least one high intensity sweetener, an amount of stevia extract of from about 0.05% to about 0.25% by weight relative to the total weight of the sweetener composition has shown itself to be advantageous, for example an amount of from about 0.10% to about 0.20%, for example an amount of 0.10%, 0.11%, 0.12%, 0.13%, 0.14%, 0.15%, 0.16%, 0.17%, 0.18%, 0.19% or 0.20% by weight relative to the total weight of the sweetener composition. This amount of stevia extract may be usefully combined with an amount of monk fruit extract of from about 0.01% to about 0.10% by weight relative to the total weight of the sweetener composition, for example an amount of from about 0.02% to about 0.09%, for example an amount of 0.02%, 0.03%, 0.04%, 0.05%, 0.06%, 0.07%, 0.08% or 0.09% by weight relative to the total weight of the sweetener composition. When the sweetener composition is able to provide an equivalent sweetness per unit volume to that of the one or more nutritive sweeteners being replaced, it may be called a “scoop-for-scoop” sweetener.

According to an embodiment, the food product or sweetener composition comprises the reducing saccharide and a stevia extract. According to an embodiment, the stevia extract comprises at least one steviol glycoside. The at least one steviol glycoside may be selected from the group consisting of Rebaudioside A, Rebaudioside B, Rebaudioside C, Rebaudioside D, Rebaudioside E, Rebaudioside F, Rebaudioside M, Rebaudioside X, Rubusoside, Stevioside and Dulcosides, and mixtures thereof. In an embodiment, the at least one steviol glycoside comprises Rebaudioside A. In another embodiment, the at least one steviol glycoside comprises Rebaudioside B. In a further embodiment, the at least one steviol glycoside comprises both Rebaudioside A and Rebaudioside B. In an embodiment, the stevia extract comprises steviol glycosides in a total amount of at least 90 weight %, preferably in a total amount of 95 weight % or more, relative to the total weight of the stevia extract on a dry solids basis. In an embodiment, the stevia extract comprises Rebaudioside A and Stevioside in a combined total amount of at least 70 weight %, preferably in a combined total amount of 75 weight % or more, relative to the total weight of the stevia extract on a dry solids basis. In an embodiment, the stevia extract comprises Rebaudioside A in an amount of from about 60 weight % to about 85 weight %, preferably from about 75 weight % to about 80 weight %, relative to the combined total weight of steviol glycosides in the stevia extract on a dry solids basis. In an embodiment, the stevia extract comprises Rebaudioside B in an amount of from about 15 weight % to about 30 weight %, preferably from about 19 weight % to about 23 weight %, relative to the combined total weight of steviol glycosides in the stevia extract on a dry solids basis. In an embodiment, the food product or sweetener composition comprises the reducing saccharide in an amount of at least about 85% by weight and stevia extract in an amount of at least about 0.07% by weight relative to the total weight of the reducing saccharide and stevia extract in the composition on a dry solids basis. In another embodiment, the food product or sweetener composition comprises the reducing saccharide in an amount of from about 97% to about 99.95% by weight and stevia extract in an amount of about 0.05% to about 3% by weight relative to the total weight of the reducing saccharide and stevia extract in the composition on a dry solids basis. In another embodiment, the food product or sweetener composition comprises the reducing saccharide in an amount of from about 97.5% to about 99.9% by weight and stevia extract in an amount of about 0.1% to about 2.5% by weight relative to the total weight of the reducing saccharide and stevia extract in the composition on a dry solids basis. In another embodiment, the food product or sweetener composition comprises the reducing saccharide in an amount of from about 98% to about 99.9% by weight and stevia extract in an amount of about 0.1% to about 2% by weight relative to the total weight of the reducing saccharide and stevia extract in the composition on a dry solids basis. In another embodiment, the food product or sweetener composition comprises the reducing saccharide in an amount of from about 98.9% to about 99.9% by weight and stevia extract in an amount of about 0.1% to about 1.1% by weight relative to the total weight of the reducing saccharide and stevia extract in the composition on a dry solids basis. In another embodiment, the food product or sweetener composition comprises the reducing saccharide in an amount of from about 98.9% to about 99.8% by weight and stevia extract in an amount of about 0.2% to about 1.1% by weight relative to the total weight of the reducing saccharide and stevia extract in the composition on a dry solids basis. In another embodiment, the food product or sweetener composition comprises the reducing saccharide in an amount of from about 99.5% to about 99.8% by weight and stevia extract in an amount of about 0.2% to about 0.5% by weight relative to the total weight of the reducing saccharide and stevia extract in the composition on a dry solids basis. In another embodiment, the food product or sweetener composition comprises the reducing saccharide in an amount of from about 98.9% to about 99.4% by weight and stevia extract in an amount of about 0.6% to about 1.1% by weight relative to the total weight of the reducing saccharide and stevia extract in the composition on a dry solids basis. In another embodiment, the food product or sweetener composition comprises the reducing saccharide in an amount of from about 99.0% to about 99.3% by weight and stevia extract in an amount of about 0.7% to about 1.0% by weight relative to the total weight of the reducing saccharide and stevia extract in the composition on a dry solids basis. In another embodiment, the food product or sweetener composition comprises the reducing saccharide in an amount of about 99.03% by weight and stevia extract in an amount of about 0.97% by weight relative to the total weight of the reducing saccharide and stevia extract in the composition on a dry solids basis. In another embodiment, the food product or sweetener composition comprises the reducing saccharide in an amount of from about 99.4% to about 99.9% by weight and stevia extract in an amount of about 0.1% to about 0.6% by weight relative to the total weight of the reducing saccharide and stevia extract in the composition on a dry solids basis. In another embodiment, the food product or sweetener composition comprises the reducing saccharide in an amount of from about 97.5% to about 99.0% by weight and stevia extract in an amount of about 1.0% to about 2.5% by weight relative to the total weight of the reducing saccharide and stevia extract in the composition on a dry solids basis. In another embodiment, the food product or sweetener composition comprises the reducing saccharide in an amount of from about 98.0% to about 98.9% by weight and stevia extract in an amount of about 1.1% to about 2.0% by weight relative to the total weight of the reducing saccharide and stevia extract in the composition on a dry solids basis. According to an embodiment, the food product or sweetener composition further comprises a sweet taste improving additive, a bulking agent, a flavoring agent, or a stabilizer.

In another aspect, the invention provides use of a divalent metal ion salt for the reduction of browning in a food product comprising a reducing saccharide during heating in the presence of an amine-containing additional food ingredient. For example, the divalent metal ion salt may be used to reduce the browning of a food product during cooking, baking or frying.

In another aspect, the invention provides the use of a divalent metal ion salt for the reduction of acrylamide formation in a food product comprising a reducing saccharide during heating in the presence of an amine-containing additional food ingredient. For example, the divalent metal ion salt may be used to reduce acrylamide formation in a food product during cooking, baking or frying.

In some embodiments, the invention provides use of a divalent metal ion salt for the reduction of browning and/or acrylamide formation in a food product comprising a reducing saccharide during heating in the presence of an amine-containing additional food ingredient.

In another aspect, provided is a method for reducing browning in a food product, wherein the method comprises:
a) combining a reducing saccharide with a divalent metal salt and at least one amine-containing additional food ingredient to provide an unheated food product; and
b) optionally heating the unheated food product to provide a heated food product.

In another aspect, provided is a method for reducing acrylamide formation in a food product, wherein the method comprises:
a) combining a reducing saccharide with a divalent metal salt and at least one amine-containing additional food ingredient to provide an unheated food product; and
b) optionally heating the unheated food product to provide a heated food product.

In some embodiments, the method is for reducing browning and/or reducing acrylamide formation in a food product.

In some embodiments, the unheated food product is a precursor to a heated food product, for example wherein the food product is a dough or batter. In some embodiments, the unheated food product is an uncooked dough or batter. In some embodiments, the unheated food product is an uncooked dough or batter for making a bakery product. In some embodiments, the unheated food product is an uncooked dough or batter for making a roll, a cake, a pie, a pastry, or a biscuit. In certain preferred embodiments, the unheated food product is an uncooked dough or batter for making a cake or a biscuit.

The heating may be carried out by any means conventional in the art. For example, the unheated food product may be fried (shallow fried, deep fried, air fried), baked, autoclaved, or ultra high temperature (UHT) treated.

In embodiments of the present invention, heating a food product involves heating the food product at a temperature of from about 100° C. to about 250° C., preferably from about 120° C. to about 220° C. The heating may occur for from about 1 min to about 60 min, more preferably from about 5 min to about 45 min. The food product may be baked, for example at a temperature of from about 140° C. to about 200° C., preferably from about 145° C. to about 185° C. The food product may be baked for from about 5 min to about 20 min. The food product may be fried, for example at a temperature of from about 160° C. to about 220° C., preferably from about 170° C. to about 190° C. The food product may be fried for from about 2 min to about 12 min, preferably from about 3 min to about 5 min. Thus, a heated food product may be one which has been subjected to the heating process described herein.

When the food product is baked, the baking conditions will be adjusted according to the size and shape of the food product. For example, a biscuit dough according to the invention may be baked at from about 140° C. to about 200° C. for from about 5 min to about 20 min. In a preferred embodiment, biscuit dough is baked at from about 145° C. to about 185° C. for from about 9 min to about 15 min. When the temperature is lower, e.g. 145° C. to 175° C., the bake time may be longer, e.g. 11 min to 15 min. When the temperature is higher, e.g. 165° C. to 195° C., the bake time may be shorter, e.g. 7 min to 13 min. In another embodiment, a cake batter according to the invention may be baked at from about 140° C. to about 200° C. for from about 15 min to about 40 min. If the cake is a muffin, the bake time may be shorter, e.g. from about 25 min. If the cake is a larger cake, such as a loaf cake, tray bake or birthday cake, the bake time may be longer, e.g. from about 25 min to about 40 min.

In some embodiments, the amine-containing additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

In some embodiments, the amine is a protein, an amino acid, or a combination thereof. In other words, the amine-containing additional food ingredient may be a protein- or amino-acid containing food ingredient. The amine-containing additional food ingredient may be one or more proteins or one or more amino acids as such, or a combination of one or more proteins with one or more amino acids.

In some embodiments, step a) comprises combining a non-reducing saccharide, such as sucrose, with the reducing saccharide, divalent metal ion salt and amine-containing additional food ingredient to provide an unheated food product.

In some embodiments of the methods and food products described herein, a saccharide content of the unheated food product is from about 1% by weight to about 80% by weight relative to the total weight of the unheated food product. That is, the reducing saccharide and the non-reducing saccharide are present in a combined amount of from about of 1% by weight to about 80% by weight based on the total weight of the unheated food product. In some embodiments, the unheated food product comprises the reducing saccharide and the non-reducing saccharide in a combined amount of from about 2%, about 5%, about 10%, about 20%, about 30%, about 40%, about 50%, about 60%, or about 70% to about 80% by weight based on the total weight of the unheated food product. In some embodiments, the unheated food product comprises the reducing saccharide and the non-reducing saccharide in a combined amount of from about 1% to about 2%, about 5%, about 10%, about 20%, about 30%, about 40%, about 50%, about 60%, about 70%, or about 80 by weight based on the total weight of the unheated food product. In some embodiments, the unheated food product comprises the reducing saccharide and the non-reducing saccharide in a combined amount of from about 60% to about 70%, about 80%, about 90%, or about 95% by weight based on the total weight of the unheated food product. In some embodiments, the unheated food product comprises the reducing saccharide and the non-reducing saccharide in a combined amount of from about 1% to about 2%, about 5%, about 10%, about 20%, about 30%, about 40%, about 50%, or about 60% to about 70% by weight based on the total weight of the unheated food product. For example, the unheated food product may comprise the reducing saccharide and the non-reducing saccharide in a combined amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80% by weight based on the total weight of the unheated food product, as well as all intermediate values.

In some embodiments, a reducing saccharide content of the unheated food product is from about 1% by weight to about 80% by weight relative to the total weight of the unheated food product. That is, the reducing saccharide is present in an amount of from about of 1% by weight to about 80% by weight based on the total weight of the unheated food product. In some embodiments, the unheated food product comprises the reducing saccharide in an amount of from about 2%, about 5%, about 10%, about 20%, about 30%, about 40%, about 50%, about 60%, or about 70% to about 80% by weight based on the total weight of the unheated food product. In some embodiments, the unheated food product comprises the reducing saccharide in an amount of from about 1% to about 2%, about 5%, about 10%, about 20%, about 30%, about 40%, about 50%, about 60%, about 70%, or about 80 by weight based on the total weight of the unheated food product. In some embodiments, the unheated food product comprises the reducing saccharide in an amount of from about 60% to about 70%, about 80%, about 90%, or about 95% by weight based on the total weight of the unheated food product. In some embodiments, the unheated food product comprises the reducing saccharide in an amount of from about 1% to about 2%, about 5%, about 10%, about 20%, about 30%, about 40%, about 50%, or about 60% to about 70% by weight based on the total weight of the unheated food product. For example, the unheated food product may comprise the reducing saccharide in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80% by weight based on the total weight of the unheated food product, as well as all intermediate values.

In some embodiments, a non-reducing saccharide content of the unheated food product is from about 1% by weight to about 80% by weight relative to the total weight of the unheated food product. That is, the non-reducing saccharide is present in an amount of from about of 1% by weight to about 80% by weight based on the total weight of the unheated food product. In some embodiments, the unheated food product comprises the non-reducing saccharide in a combined amount of from about 2%, about 5%, about 10%, about 20%, about 30%, about 40%, about 50%, about 60%, or about 70% to about 80% by weight based on the total weight of the unheated food product. In some embodiments, the unheated food product comprises the non-reducing saccharide in an amount of from about 1% to about 2%, about 5%, about 10%, about 20%, about 30%, about 40%, about 50%, about 60%, about 70%, or about 80 by weight based on the total weight of the unheated food product. In some embodiments, the unheated food product comprises the non-reducing saccharide in an amount of from about 60% to about 70%, about 80%, about 90%, or about 95% by weight based on the total weight of the unheated food product. In some embodiments, the unheated food product comprises the non-reducing saccharide in an amount of from about 1% to about 2%, about 5%, about 10%, about 20%, about 30%, about 40%, about 50%, or about 60% to about 70% by weight based on the total weight of the unheated food product. For example, the unheated food product may comprise the non-reducing saccharide in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80% by weight based on the total weight of the unheated food product, as well as all intermediate values.

In some embodiments, the divalent metal ion salt is provided in an amount sufficient to provide a free divalent metal ion content of from about 0.01% by weight to about 1% by weight relative to the total weight of the unheated food product.

The free divalent metal ion content of a metal salt is the amount of metal ion content contained in solution in the food product. The free metal ion content of a metal salt containing food product is related to the metal salt content by the following formulae and is the lowest of:

$$C ( M ) = m \times C ( {M}_{m} {X}_{n} ) \times [ {A}_{r} ( M ) / {M}_{r} ( {M}_{m} {X}_{n} ) ]$$

$$C ( M ) = C ( water ) \times s ( {M}_{m} {X}_{n} )$$

where MₘXₙ represents the chemical formula for a salt of metal ion M and counterion X;
m represents the number of moles of metal M per mole of metal salt MₘXₙ;
C(M) represents the % free metal ion content of a metal salt containing food product by weight based on the total weight of the food product;
C(MₘXₙ) represents the % metal salt content of the food product by weight based on the total weight of the food product;
Aᵣ(M) represents the atomic mass of metal M;
Mᵣ(MₘXₙ) represents the molecular mass of metal salt MₘXₙ;
C(water) represents the % water content of the food product by weight based on the total weight of the food product; and
s(MₘXₙ) represents the solubility of the metal salt in water in g/mL at a given temperature, pressure and pH.

For example, for a food product with added anhydrous calcium chloride a metal salt content (C(MₘXₙ)) of 2% by weight and a water content C (water) of 10% by weight, the free calcium ion content is 0.72% by weight. Accordingly, for a given metal salt and water content the skilled person can calculate the free metal ion salt content and vice versa without undue burden. Information about the solubility of different salts at different temperature, pressure and pH is widely available. Due account shall be taken of the solvated water in the molecular mass of hydrated metal salts.

In some embodiments, the divalent metal ion salt is provided in an amount sufficient to provide a free divalent metal ion content of from about 0.01% to about 0.9%, 0.02% to about 0.8%, about 0.05% to about 0.7%, about 0.05% to about 0.6%, about 0.1% to about 0.6%, about 0.1% to about 0.5%, about 0.15% to about 0.4%, or about 0.2% to about 0.3% by weight relative to the total weight of the unheated food product. In a preferred embodiment, the divalent metal ion salt is provided in an amount sufficient to provide a free divalent metal ion content of from about 0.1% by weight to about 0.3% relative to the total weight of the unheated food product, preferably 0.2% by weight. In some embodiments, the divalent metal ion salt is provided in an amount sufficient to provide a free divalent metal ion content of about 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29% 0.3%, 0.31%, 0.32%, 0.33%, 0.34%, 0.35%, 0.36%, 0.37%, 0.38%, 0.39% 0.4%, 0.41%, 0.42%, 0.43%, 0.44%, 0.45%, 0.46%, 0.47%, 0.48%, 0.49%, 0.5%, 0.51%, 0.52%, 0.53%, 0.54%, 0.55%, 0.56%, 0.57%, 0.58%, 0.59% 0.6%, 0.61%, 0.62%, 0.63%, 0.64%, 0.65%, 0.66%, 0.67%, 0.68%, 0.69%, 0.7%, 0.71%, 0.72%, 0.73%, 0.74%, 0.75%, 0.76%, 0.77%, 0.78%, 0.79%, 0.8%, 0.81%, 0.82%, 0.83%, 0.84%, 0.85%, 0.86%, 0.87%, 0.88%, 0.89%, 0.9%, 0.91%, 0.92%, 0.93%, 0.94%, 0.95%, 0.96%, 0.97%, 0.98%, 0.99%, or 1.00% by weight based on the total weight of the unheated food product, as well as all intermediate values.

Alternatively or additionally, the content of the metal salt can be set according to the quantity of metal salt added. In this scenario, the unheated food product comprises the metal ion salt in an amount of from about 0.1% to about 2%. For example, the metal salt may be contained in the unheated food product in an amount of about 0.1%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29% 0.3%, 0.31%, 0.32%, 0.33%, 0.34%, 0.35%, 0.36%, 0.37%, 0.38%, 0.39% 0.4%, 0.41%, 0.42%, 0.43%, 0.44%, 0.45%, 0.46%, 0.47%, 0.48%, 0.49%, 0.5%, 0.51%, 0.52%, 0.53%, 0.54%, 0.55%, 0.56%, 0.57%, 0.58%, 0.59% 0.6%, 0.61%, 0.62%, 0.63%, 0.64%, 0.65%, 0.66%, 0.67%, 0.68%, 0.69%, 0.7%, 0.71%, 0.72%, 0.73%, 0.74%, 0.75%, 0.76%, 0.77%, 0.78%, 0.79%, 0.8%, 0.81%, 0.82%, 0.83%, 0.84%, 0.85%, 0.86%, 0.87%, 0.88%, 0.89%, 0.9%, 0.91%, 0.92%, 0.93%, 0.94%, 0.95%, 0.96%, 0.97%, 0.98%, 0.99%, 1.0%, 1.1%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29% 1.3%, 1.31%, 1.32%, 1.33%, 1.34%, 1.35%, 1.36%, 1.37%, 1.38%, 1.39% 1.4%, 1.41%, 1.42%, 1.43%, 1.44%, 1.45%, 1.46%, 1.47%, 1.48%, 1.49%, 1.5%, 1.51%, 1.52%, 1.53%, 1.54%, 1.55%, 1.56%, 1.57%, 1.58%, 1.59% 1.6%, 1.61%, 1.62%, 1.63%, 1.64%, 1.65%, 1.66%, 1.67%, 1.68%, 1.69%, 1.7%, 1.71%, 1.72%, 1.73%, 1.74%, 1.75%, 1.76%, 1.77%, 1.78%, 1.79%, 1.8%, 1.81%, 1.82%, 1.83%, 1.84%, 1.85%, 1.86%, 1.87%, 1.88%, 1.89%, 1.9%, 1.91%, 1.92%, 1.93%, 1.94%, 1.95%, 1.96%, 1.97%, 1.98%, 1.99%, or 2.0% by weight based on the total weight of the unheated food product, as well as all intermediate values. In some embodiments, the metal salt may be contained in the unheated food product in an amount of from about 0.1% to about 1.8%, 0.2% to about 1.6%, about 0.3% to about 1.2%, about 0.4% to about 1%, about 0.5% to about 0.7%, about 0.5% to about 0.8%, about 0.4% to about 0.7%, or about 0.6% by weight based on the total weight of the unheated food product. In preferred embodiments, the metal salt is contained in the unheated food product in an amount of from about 0.3% to about 0.7% by weight based on the total weight of the unheated food product. In particular, the unheated food product may comprise calcium chloride, calcium lactate, calcium sulfate or calcium phosphate in an amount of from about 0.3% to about 0.7% by weight based on the total weight of the unheated food product.

Alternatively or additionally, the amount of divalent metal ion salt content may be adjusted according to the amount of reducing saccharide that is present. For example, the divalent metal ion content may be provided in an amount sufficient to provide a free divalent metal ion content of from about 0.5% to about 10% by weight relative to the reducing saccharide content. For example, if the reducing saccharide (e.g. allulose) is provided in an amount of 10% by weight based on the total weight of the food product or sweetener composition, then the divalent metal ion salt may be provided in an amount sufficient to provide a free divalent metal ion content of about 0.05% by weight based on the total weight of the food product or sweetener composition (1% by weight based on the weight of the allulose). In a preferred embodiment, the divalent metal ion content is provided in an amount sufficient to provide a free divalent metal ion content of from about 1% to about 10%, preferably 2% to about 8%, more preferably about 3% to about 7% by weight relative to the reducing saccharide content.

In some embodiments, the reducing saccharide is any selected from the group consisting of allulose, fructose, glucose, lactose, maltose, a polysaccharide, e.g. a soluble dietary fibre such as soluble corn fibre or polydextrose, or maltodextrin, or any combination of the foregoing. In a preferred embodiment, the reducing saccharide is allulose. In another preferred embodiment, the reducing saccharide is soluble corn fibre or polydextrose. In another preferred embodiment, the reducing saccharide is fructose.

In some embodiments, the reducing saccharide is any selected from the group consisting of Promitor® L70 (soluble gluco fibre), Krystar® (Crystalline Fructose), and Dolcia Prima® (Crystalline Allulose and Allulose Syrup).

In some embodiments, the unheated food product comprises a reducing saccharide that is allulose a non-reducing saccharide that is sucrose. The combined amount of allulose and sucrose may be any of the amounts as defined above for the combined amount of the reducing saccharide and non-reducing saccharide. In particular, the food product may comprise sucrose in an amount of from about 5% to about 50% and allulose in an amount of from 1% to about 25%, sucrose in an amount of from about 10% to about 40% and allulose in an amount of from 2% to about 20%, sucrose in an amount of from about 10% to about 25% and allulose in an amount of from 2% to about 10%, sucrose in an amount of from about 10% to about 20% and allulose in an amount of from 5% to about 10%, or sucrose in an amount of from about 10% to about 20% and allulose in an amount of from 1% to about 10%, by weight based on the total weight of the unheated food product.

In some embodiments, the unheated food product comprises a reducing saccharide that is soluble dietary fibre, such as soluble corn fibre or polydextrose, and a non-reducing saccharide that is sucrose. The combined amount of soluble dietary fibre and sucrose may be any of the amounts as defined above for the combined amount of the reducing saccharide and non-reducing saccharide. In particular, the food product may comprise sucrose in an amount of from about 5% to about 50% and soluble dietary fibre in an amount of from 1% to about 25%, sucrose in an amount of from about 10% to about 40% and soluble corn fibre in an amount of from 2% to about 20%, sucrose in an amount of from about 10% to about 25% and soluble corn fibre in an amount of from 2% to about 10%, sucrose in an amount of from about 10% to about 20% and soluble corn fibre in an amount of from 5% to about 10%, or sucrose in an amount of from about 10% to about 20% and soluble corn fibre in an amount of from 1% to about 10%, by weight based on the total weight of the unheated food product.

In some embodiments of the method of the present invention, the divalent metal ion salt is an alkaline earth metal salt as defined above in respect of the sweetener composition of the present invention.

In some embodiments, the unheated food product is less prone to browning when heated than the same food product in which the divalent metal ion salt is replaced with a corresponding potassium salt in a stoichiometric amount based on the metal ion content.

In some embodiments, the heated food product is lighter in colour than the same food product in which the divalent metal ion salt is replaced with a corresponding potassium salt in a stoichiometric amount based on the metal ion content.

Another aspect relates to a food product comprising: a reducing saccharide, a divalent metal ion salt, and an amine-containing additional food ingredient. The reducing saccharide, divalent metal ion salt, and an amine-containing additional food ingredient are as defined above in respect of the sweetener composition of the present invention.

Unless otherwise stated, all content amounts are stated with reference to food products in their uncooked states, i.e. prior to any moisture loss which may occur during cooking (heating).

In some embodiments, the food product is a precursor to a heated food product.

According to one aspect, the food product is a sweet bakery product comprising a reducing saccharide in an amount of from about 1% by weight to about 45% by weight relative to the total weight of the uncooked sweet bakery product (e.g. the dough or the batter) and the divalent metal ion salt in an amount sufficient to provide a free divalent metal ion content of from about 0.01% by weight to about 1% by weight relative to the total weight of the uncooked product. The product is preferably selected from the group consisting of rolls, cakes, pies, pastries, and biscuits. In certain embodiments, the product comprises a reducing saccharide in an amount of from about 5% by weight to about 35% by weight relative to the total weight of the uncooked sweet bakery product. In certain embodiments, the product comprises the divalent metal ion salt in an amount sufficient to provide a free divalent metal ion content of from about 0.1% by weight to about 0.5% by weight relative to the total weight of the uncooked product. In some embodiments, the product comprises the divalent metal ion salt in an amount of from about 0.3% by weight to about 0.9% by weight relative to the total weight of the uncooked product.

In some embodiments, the food product is a dough or batter. For example, the food product is a dough or batter for making rolls, cakes, pies, pastries, or biscuits. The dough or batter preferably comprises a reducing saccharide in an amount of from about 1% by weight to about 45% by weight relative to the dough or batter. In certain embodiments, the product comprises saccharides in an amount of from about 5% by weight to about 35% by weight relative to the total weight of the dough or batter.

In addition to the reducing saccharide, the sweet bakery product according to the present invention typically comprises one or more starchy ingredients, including all suitable types of flours (including bleached, unbleached and self-raising flours) and starches (including native and modified starches). The starchy ingredient may be derived from any suitable source including, but not limited to, wheat, rice, maize (corn), oat, rye, barley, tapioca, sago, amaranth, arrowroot, sorghum, pea, banana, potato and sweet potato. The source may be waxy or non-waxy.

The sweet bakery product according to the present invention may include one or more ingredients selected from the group consisting of leavening agents (such as yeast, bicarbonate of soda, baking soda, cream of tartar and the like), eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a sweet bakery product.

By way of example, sweet bakery products according to the present invention may comprise allulose, fructose or soluble dietary fibre in an amount of from about 1% by weight to about 45% by weight relative to the total weight of the uncooked product, for example in an amount of from about 5% to about 40% by weight relative to the total weight of the uncooked product, for example in an amount of from about 10% by weight to about 35% by weight relative to the total weight of the uncooked product, for example in an amount of from about 10% to about 25% by weight relative to the total weight of the uncooked product, for example in an amount of about 1%, 2%, 3%, 4%, 5%, 6%, 7%, 8%, 9%, 10%, 15%, 20%, 25%, 30%, 35%, 40% or 45% by weight relative to the total weight of the uncooked product.

In some embodiments, the reducing saccharide is used as a partial or complete replacement for sucrose in conventional recipes. In order to optimize certain physical properties of the sweet bakery products according to the present invention, it may be desirable to make certain other adjustments to the conventional recipes, besides the complete or partial replacement of sucrose by a reducing saccharide. Physical properties which it may be desired to optimize include crumb structure (e.g. of biscuits, pie crusts and the like), spread (e.g. in the case of biscuits), surface appearance, softness (e.g. in the case of biscuits), degree of rise (e.g. in the case of cakes), moisture retention (humectancy), and the like.

In the case of partial replacement of sucrose, one possibility for influencing one or more of the above physical properties is to adjust the amount of the nutritive sweetener replaced by the reducing sugar. In the case of biscuits, for example, such adjustment can help to optimize both texture and browning. Thus, according to a preferred embodiment, the sweet bakery product of the present invention is a biscuit and comprises a reducing saccharide, such as allulose, fructose or soluble dietary fibre (e.g. in an amount of from about 25% to about 37% by weight, for example about 29% to about 33% by weight, based on the total weight of the biscuit dough) and a non-reducing saccharide, such as sucrose (e.g. in an amount of from about 4% to about 10% by weight, for example about 6% to about 8% by weight, based on the total weight of the biscuit dough). According to another preferred embodiment, the sweet bakery product of the present invention is a biscuit and comprises a reducing saccharide, such as allulose, fructose or soluble dietary fibre (e.g. in an amount of from about 1% to about 10% by weight, for example about 3% to about 8% by weight, based on the total weight of the biscuit dough) and a non-reducing saccharide, such as sucrose (e.g. in an amount of from about 7% to about 20% by weight, for example about 10% to about 12% by weight, based on the total weight of the biscuit dough).

A further possibility for influencing one or more of the above physical properties is to include texture modifiers and/or moisture retaining agents. Examples of such texture modifiers and/or moisture retaining agents are specialist bakery starches. Such specialist bakery starches include starches which are one or more of cold-water-swelling, granular, pre-gelatinized and instant. Thus, according to certain embodiments, the sweet bakery product according to the present invention includes a specialist bakery starch.

Egg whites may also be used to influence one or more of the above physical properties, especially in the case of risen products such as cakes, muffins and the like, particularly when higher amounts of allulose are used.

According to one embodiment, the sweet bakery product of the present invention is a biscuit and comprises a specialist bakery starch, preferably a cold-water-swelling, granular, instant starch. Such specialist bakery starch may be included in the biscuit in an amount of up to around 1% by weight, for example up to around 0.5% by weight, up to around 0.3% by weight, or around 0.24% by weight, based on the total weight of the biscuit dough.

According to another embodiment, the sweet bakery product of the present invention is a cake and comprises a specialist bakery starch, preferably a granular instant starch. Such specialist bakery starch may be included in the cake in an amount of up to around 3% by weight, for example up to around 2% by weight, up to around 1.5% by weight, or around 1% by weight, based on the total weight of the cake batter.

Careful control of baking conditions may also be used to influence the physical properties of the sweet bakery product according to the present invention.

In a preferred embodiment, the sweet bakery product is a cake comprising sucrose, allulose and a calcium salt in an amount of from about 5% by weight to about 30% by weight of sucrose, from about 1% by weight to about 10% by weight of allulose, and from about 0.1% by weight to about 2% by weight of a calcium salt relative to the total weight of the uncooked cake batter.

In another preferred embodiment, the sweet bakery product is a cake comprising fructose and a calcium salt in an amount of from about 1% by weight to about 15% by weight of fructose and from about 0.1% by weight to about 2% by weight relative to the total weight of the uncooked cake batter.

In another preferred embodiment, the sweet bakery product is a cake comprising sucrose, soluble dietary fibre and a calcium salt in an amount of from about 6% by weight to about 30% by weight of sucrose, from about 1% by weight to about 10% by weight of soluble dietary fibre, and from about 0.1% by weight to about 2% by weight relative to the total weight of the uncooked cake batter.

In another preferred embodiment, the sweet bakery product is a biscuit comprising allulose, sucrose and a calcium salt in an amount of from about 6% by weight to about 30% by weight of sucrose, from about 1% by weight to about 10% by weight of allulose, and from about 0.1% by weight to about 2% by weight relative to the total weight of the uncooked biscuit dough.

According to another embodiment, the present invention provides a pre-made baking mix for preparing a sweet bakery product, wherein the pre-made baking mix comprises the reducing saccharide in an amount sufficient to provide from about 1% by weight to about 45% by weight in the uncooked sweet bakery product (i.e. uncooked dough or batter). For example, the pre-made baking mix may comprise from about 2% by weight of allulose to about 75% by weight of reducing saccharide relative to the total weight of the pre-made baking mix.

In the case where the sweet bakery product according to the present invention has a sweet filling, such as a pie filling or a filling for biscuits, cakes, pastries, confectionary products and the like, such as a fat-based cream filling, the sweet filing may suitably comprise the reducing saccharide in an amount of from about 1% by weight to about 50% by weight relative to the total weight of the uncooked sweet filling. Such sweet fillings may also comprise at least one plant-derived component (such as a fruit, vegetable, legume, nut or coconut component, for example). Such plant-derived component may be present in an amount of from around 1% by weight to about 60% by weight relative to the total weight of the uncooked sweet filling. The plant product may be in any suitable form, for example in whole form, in pieces, minced, crushed, as a paste or puree, as juice, as a concentrate, as a sauce or as an extract. The sweet fillings according to the present invention may include one or more ingredients selected from the group consisting of eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a sweet filling. By way of example, the sweet fillings according to the present invention may comprise the reducing saccharide in an amount of from about 1% by weight to about 50% by weight relative to the total weight of the uncooked sweet filling, for example in an amount of from about 5% to about 45% by weight relative to the total weight of the uncooked sweet filling, for example in an amount of from about 10% by weight to about 45% by weight relative to the total weight of the uncooked sweet filling, for example in an amount of about 5%, 10%, 15%, 20%, 25%, 30%, 35%, 40% or 50% by weight relative to the total weight of the uncooked sweet filling. In addition, the sweet filling may comprise the divalent metal ion salt in any amount described herein.

In embodiments of any of the foregoing, the sweet bakery product may comprise the reducing saccharide and a non-reducing saccharide. The sweet bakery product may comprise the reducing saccharide and a non-reducing saccharide in a combined amount of from about 8% by weight to about 45% by weight relative to the total weight of the uncooked sweet bakery product, for example in an amount of from about 15% by weight to about 35% by weight relative to the total weight of the uncooked product, for example in an amount of about 8%, 9%, 10%, 15%, 20%, 25%, 30%, 35%, 40% or 45% by weight relative to the total weight of the uncooked product. In these instances, the sweet bakery product preferably comprises the non-reducing saccharide, such as sucrose, in an amount of from about 5% to about 40% by weight, and the non-reducing saccharide, such as allulose, fructose, or soluble dietary fibre in an amount of from about 5% to about 40% by weight relative to the total weight of the uncooked product. For instance, the sweet bakery product may comprise the non-reducing saccharide, such as sucrose, in an amount of from about 10% to about 25% by weight, and the non-reducing saccharide, such as allulose, fructose, or soluble dietary fibre in an amount of from about 3% to about 15% by weight relative to the total weight of the uncooked product.

In some embodiments, the moisture (water) content of the food product is from about 1% to about 30% by weight relative to the total weight of the uncooked product. By way of example, the moisture content may be from about 5% by weight to about 25% relative to the total weight of the uncooked product, for example from about 10% to about 25% by weight relative to the total weight of the uncooked product.

The pre-made baking mix for preparing a sweet bakery product is a pre-made mix for use in preparing a sweet bakery product according to the present invention. Accordingly, the pre-made mix may comprise any combination of the ingredients discussed above with respect to the sweet bakery product. The description relating to the sweet bakery product of the present invention therefore applies mutatis mutandis.

Generally, the pre-made baking mix will comprise only the ‘dry’ ingredients required for preparing the sweet bakery product. Thus, the pre-made baking mix will typically not contain ‘wet’ ingredients such as eggs or egg-derived products, fats, oils, water, milk and/or other dairy products, or other ‘wet’ ingredients. Dried forms of such ingredients (e.g. dried egg or milk products) may be included, and oils and/or fats may also be included according to some embodiments. Anti-caking agents may also be advantageously incorporated in the pre-made baking mixes of the present invention.

By way of example, the pre-made baking mixes according to the present invention may comprise the reducing saccharide, such as allulose, fructose or soluble dietary fibre in an amount of from about 1% by weight to about 75% by weight relative to the total weight of the pre-made baking mix, for example in an amount of from about 10% to about 67% by weight relative to the total weight of the pre-made baking mix, for example in an amount of from about 25% by weight to about 58% by weight relative to the total weight of the pre-made baking mix, for example in an amount of about 1%, 2%, 3%, 4%, 5%, 6%, 7%, 8%, 9%, 10%, 11%, 12%, 13%, 14%, 15%, 20%, 25%, 30%, 35%, 40%, 50%, 60%, 70% or 75% by weight relative to the total weight of the pre-made baking mix.

In some embodiments, the food product is a bread product comprising the reducing saccharide in an amount of from about 1% by weight to about 15% by weight relative to the total weight of the uncooked bread product and the divalent metal ion salt in an amount of from about 0.1% by weight to about 2% by weight relative to the total weight of the uncooked bread product.

Sweet bakery products, such as cakes and biscuits, and pre-made baking mixes for making such products, typically include a leavening agent. Accordingly, the sweet bakery products and pre-made baking mixes described herein may comprise a leavening agent. In some embodiments, the leavening agent is egg white, included in an amount of from about 5% to about 10% by weight relative to the total weight of uncooked product. In some embodiments, the leavening agent is Baker's yeast included in an amount of from about 0.1% to about 1% by weight relative to the total weight of uncooked product. In some embodiments, the leavening agent is sodium bicarbonate, potassium bicarbonate, ammonium bicarbonate, or baking powder (tartaric acid and potassium bitartrate), or any combination of the foregoing, included in an amount of from about 0.1% to about 1% by weight relative to the total weight of uncooked product. In a particularly preferred embodiment, the leavening agent is ammonium bicarbonate and is included in an amount of from about 0.1% to about 1% by weight relative to the total weight of uncooked product. The inventors found that when ammonium bicarbonate is used as the leavening agent, off notes associated with the divalent metal ion salt are reduced. In a particularly preferred embodiment, the food product comprises a calcium salt, especially calcium chloride, in an amount of from about 0.1% to about 1.0% by weight and ammonium bicarbonate in an amount of from about 0.1% to about 1.0% by weight relative to the total weight of the uncooked food product.

In some embodiments, the food product is a confectionary product, wherein the confectionary product comprises the reducing saccharide in an amount of from about 1% by weight to about 50% by weight relative to the total weight of the uncooked confectionary product; and the divalent metal ion salt in an amount of from about 0.1% by weight to about 2% by weight relative to the total weight of the uncooked confectionary product.

In some embodiments, the food product is a snack bar comprising the reducing saccharide in an amount of from about 1% by weight to about 25% by weight relative to the total weight of the snack bar; and the divalent metal ion salt in an amount of from about 0.1% by weight to about 2% by weight relative to the total weight of the snack bar.

In some embodiments, the food product is a sweetened breakfast cereal comprising the reducing saccharide in an amount of from about 1% by weight to about 50% by weight relative to the total weight of the sweetened breakfast cereal; and the divalent metal ion salt in an amount of from about 0.1% by weight to about 2% by weight relative to the total weight of the sweetened breakfast cereal.

In some embodiments, the food product is a sweet filling comprising the reducing saccharide composition in an amount of from about 1% by weight to about 50% by weight relative to the total weight of the uncooked sweet filling; and the divalent metal ion salt in an amount of from about 0.1% by weight to about 2% by weight relative to the total weight of the uncooked sweet filling.

In some embodiments, the food product is a condensed milk comprising the reducing saccharide composition in an amount of from about 1% by weight to about 50% by weight relative to the total weight of the condensed milk; and the divalent metal ion salt in an amount of from about 0.1% by weight to about 2% by weight relative to the total weight of the condensed milk.

In some embodiments, the food product is a non-dairy vegetable milk or drink comprising vegetable solids, water, a reducing saccharide, and a divalent metal ion salt. Non-dairy vegetable milk or non-dairy vegetable drinks or milks include milks or drinks prepared from barley, fonio, maize, millet, oat, rice, rye, sorghum, teff, triticale, spelt, wheat amaranth, buckwheat, quinoa lupin, pea, peanut, soy almond, brazil, cashew, hazelnut, macadamia, pecan, pistachio, walnut chia seed, flax seed, hemp seed, pumpkin seed, sesame seed, sunflower seed, coconut, potato or tiger nut. In preferred examples, the vegetable is oat, rice, pea, soy, almond, cashew or coconut. In some embodiments, the non-dairy vegetable milk or drink has a fat content of from about 1% by weight to about 8% by weight, preferably from about 2% to about 4% by weight relative to total weight of the non-dairy vegetable milk or drink.

In some embodiments, the non-dairy vegetable milk or drink comprises vegetable solids in an amount of from about 1% to about 30%, for example 2% to about 20%, for example 5% to about 15% preferably around 10% by weight vegetable solids by weight relative to total weight of the non-dairy vegetable milk or drink. In some embodiments, the non-dairy vegetable milk or drink comprises a reducing saccharide in an amount of from about 1% to about 20%, for example about 2% to about 15%, for example about 5% to about 12%, preferably from about 6% to about 11% by weight relative to total weight of the non-dairy vegetable milk or drink. In some embodiments, the non-dairy vegetable milk or drink comprises a divalent metal ion salt in an amount of from about 0.1% to about 2%, for example around 0.2% to about 1.5%, preferably from about 0.1% to about 0.5% by weight relative to total weight of the non-dairy vegetable milk or drink. In some embodiments, the non-dairy vegetable milk or drink comprises a non-reducing saccharide, such as sucrose, in an amount of from about 1% to about 20%, for example about 2% to about 15%, for example about 5% to about 12%, preferably from about 6% to about 11% by weight relative to total weight of the non-dairy vegetable milk or drink. In some embodiments, the non-dairy vegetable milk or drink comprises water in an amount of from about 40% to about 99%, for example from about 60% to about 95%, for example from about 70% to about 89%, preferably from about 75% to about 85% by weight relative to total weight of the non-dairy vegetable milk or drink. In preferred embodiments, the reducing saccharide is allulose, fructose or a soluble dietary fibre such as soluble corn fibre or polydextrose. In some preferred embodiments, the non-dairy vegetable milk or drink comprises allulose or fructose in an amount of from about 7% to about 13% by weight relative to total weight of the non-dairy vegetable milk or drink. In some preferred embodiments, the non-dairy vegetable milk or drink comprises soluble dietary fibre such as soluble corn fibre or polydextrose in an amount of from about 4% to about 8% by weight relative to total weight of the non-dairy vegetable milk or drink. In some preferred embodiments, the divalent metal ion salt is a calcium salt. In some preferred embodiments, the divalent metal ion salt is calcium chloride, calcium lactate or calcium phosphate. In some embodiments, the non-dairy vegetable milk or drink has a fat content of from about 1% by weight to about 8% by weight, preferably from about 2% to about 4% by weight relative to total weight of the non-dairy vegetable milk or drink.

In a preferred embodiment, the non-dairy vegetable milk or drink described above is subject to UHT treatment to provide a UHT-treated on-dairy vegetable milk or drink.

In particular preferred embodiments of the foregoing, the non-dairy vegetable milk or drink is an oat milk or drink and the non-dairy vegetable solids are oat solids.

According to the present invention, the unheated food product is less prone to browning than the same food product in which the calcium salt is replaced with potassium chloride in a stoichiometric amount based on the free metal ion content.

In some embodiments, the food product is a heated food product. In some embodiments, the food product is a heated food product prepared by heating any unheated or uncooked food product described herein.

In some embodiments, the food product is lighter in colour than the same food product in which the divalent metal ion salt is replaced with a corresponding potassium salt in a stoichiometric amount based on the free metal ion content.

Where a food product is less prone to browning than the same food product in which the divalent metal ion salt is replaced with a corresponding potassium salt in a stoichiometric amount based on the free metal ion content, the food product will not become as brown when heated in the presence of a food ingredient that comprises an amine, e.g. a food product that contains a protein or an amino acid.

The color of the food product of the present invention can be characterized using the CIE 1976 L*a*b* scale (CIE International Commission on Illumination, Recommendations on Uniform Color Spaces, Color-Difference Equations, Psychometric Color Terms, Supplement No. 2 to CIE Publication No. 15, Colorimetry, 1971 and 1978), which is in widespread use. On the CIE 1976 L*a*b* scale, the “L*” value measures lightness and varies from 100 for perfect white to 0 for black. The chromaticity dimensions on CIE 1976 L*a*b* scale, the “a*” value and the “b*” value, give designations of color as follows: “a” measures redness when positive, grey when zero and greenness when negative and “b*” measures yellowness when positive, grey when zero and blueness when negative.

In some embodiments, the unheated food product has an “L*” value of greater than about 50, 55, 60, 65, 70 or 75, for example greater than 50, greater than 60, or greater than 70. In some embodiments, the “L*” value of the unheated food product falls by less than about 30, 25, 20, 15, 10 or 5 when heated, for example less than about 20 or less than about 10.

In some embodiments, the heated food product has an “L*” value of greater than about 50, 55, 60, 65, 70 or 75, for example greater than 50, greater than 60, or greater than 70.

In some embodiments, the heated food product has an “L*” value that is greater than the “L*” of the same food product in which the divalent metal ion salt is replaced with a corresponding potassium salt in a stoichiometric amount based on the free metal ion content after both products have been heated in the same way. In some embodiments, the heated food product has an “L*” value that is greater than the “L*” of the same food product in which the divalent metal ion salt is not added after both products have been heated in the same way.

Where a food product is less prone to acrylamide formation than the same food product in which the divalent metal ion salt is replaced with a corresponding potassium salt in a stoichiometric amount based on the free metal ion content, less acrylamide will form in the food product when heated in the presence of a food ingredient that comprises an amine, e.g. a food product that contains a protein or an amino acid.

In some embodiments, the heated food product has an acrylamide content of 20 μg/kg, preferably 15 μg/kg, or more preferably 10 μg/kg or less, 9 μg/kg or less, 8 μg/kg or less, 7 μg/kg or less, 6 μg/kg or less or 5 μg/kg or less. The acrylamide content may be determined by any suitable means known in the art. It is common for food samples to be sent for testing at an independent laboratory.

Acrylamide levels are determined quantitatively using LC-MS techniques. In one such technique, quantitative determination is performed by performing extraction on the food product using a water/acetonitrile mixture and degreasing using n-hexane. An additional solid-phase extraction clean-up may be performed. LC-ESI-MS/MS (positive ion mode) may be used. An internal standard using deuterated acrylamide (acrylamide-d₃) is used.

In some embodiments, acrylamide content may be determined as follows:

### Reagents and Consumables

Acrylamide (Sigma Chemical Company. St. Louis, MO); ¹³C₃-labeled acrylamide (Cambridge Isotope Laboratory, Andover, MA); HPLC grade acetonitrile (Omnisolv, EM Science, Gibbstown, NJ); HPLC grade methanol (Omnisolv, EM Science, Gibbstown, NJ; HPLC grade 2-propanol (Omnisolv, EM Science, Gibbstown, NJ; HPLC grade water (Omnisolv, EM Science, Gibbstown, NJ; Formic acid 99% (Sigma Chemical Company, St. Louis, MO); Glacial acetic acid 99% (Sigma Chemical Company, St. Louis, MO); Maxi-Spin filter tube, 0.45 μm PVDF (Alltech Associates, Deerfield, IL), 50 mL polypropylene conical tube with cap (Becton Dickinson); Hydro-RP 80A HPLC column (2×250 mm), 4 micron packing (Phenomonex, Torrance, CA). Wash column a minimum of 20 min with 50:50 methanol:acetonitrile after 48 samples or at end of daily operations. Mobile phase re-equilibration for analyses will require 1.5 hr. OASIS HLB 6 mL solid phase extraction cartridge, 200 milligram packing (Waters Corporation, Milford, MA). Bond Elut-Accucat (mixed mode. C8, SAX and SCX) 3 mL solid phase extraction cartridge, 200 milligram packing (Varian Inc., Harbor City, CA).

### Instrumentation

Agilent (Palo Alto, CA) Model 1100 autosampler, binary HPLC pump and column heater Micromass Inc. (Manchester, UK) Quattro micro triple quadrupole mass spectrometer

### Sample Preparation

1. Crush and homogenize a portion of sample equal to the manufacturer's recommended serving size with a food processor or equivalent device.
2. Weigh a one-gram portion of crushed sample into a 50 mL polypropylene graduated conical tube with cap.
3. Add 1 mL of internal standard solution (¹³C₃-labeled acrylamide in 0.1% formic acid, 200 ng/ml), followed by 9 mL of water to the test portion. Shake by hand or vortex briefly to disperse test portion in water prior to step 4.
4. Mix for 20 minutes on a rotating shaker. (MN: Do not heat or sonicate, as this may generate an extract that will clog the SPE column.)
5. Centrifuge at 9000 rpm for 15 min. Promptly remove 5 mL portion of clarified aqueous phase for spin filtration and SPE. Avoid top oil layer and bottom solids layer when removing portion of aqueous phase.
6. Place 5 mL portion in Maxi-Spin filter tube, 0.45 μm PVDF (Alltech #2534). Centrifuge at 9000 rpm for 2-4 min. If filter clogs, insert new filter into tube, pour unfiltered liquid onto new filter and continue centrifugation until most of the liquid has passed through filter.
7. Condition OASIS SPE cartridge with 3.5 mL methanol, followed by 3.5 mL of water. Discard methanol and water portions used to prepare cartridge. A number of SPE cartridges were tested during development of this method, and all of them had different analyte retention and elution characteristics. Do not substitute another SPE sorbent in this step without testing.
8. Load OASIS SPE cartridge with 1.5 mL of the 5 mL test portion extract. Allow extract to pass completely through the sorbent material. Elute column with 0.5 ml water and discard. Elute column with additional 1.5 ml water and collect for Varian SPE cartridge cleanup. Do not use a vacuum to speed up the elution process in any of the SPE steps.
9. Place mark on outside of Varian SPE cartridge at height of 1 mL liquid above sorbent bed. Condition Varian SPE cartridge with 2.5 mL methanol, followed by 2.5 ml of water. Discard methanol and water portions used to prepare cartridge. Load 1.5 mL portion collected in step 8 and elute to 1 mL mark before collecting remainder of eluted portion. Transfer to 2 mL amber auto-sampler vial for LC/MS/MS analysis. This step removes a number of early eluting co-extractives, resulting in better precision for sub-50 ppb measurements. Do not load more than 1.5 mL of extract onto Varian SPE cartridge.

### Liquid Chromatography/Mass Spectrometry

1. Mobile phase composition: Aqueous 0.1% acetic acid, 0.5% methanol
2. Column flow rate: 200 μL/min
3. Post-column makeup flow rate: 50 μL/min 1% acetic acid in 2-propanol
4. Injection volume: 20 μl
5. Column temperature: 26° C.
6. Acrylamide elution time: approximately 7.1 minutes
7. Ionization Mode: Positive ion electrospray
8. Probe temperature: 240° C.
9. Source temperature: 120° C.
10. Desolvation gas flow: 710 L/hr nitrogen
11. Cone Gas flow: 153 L/hr nitrogen
12. Collision gas pressure: 1 Torr argon
13. MRM ions: Acrylamide (m/z 72, 55, 27), Internal Standard (75, 58, 29). Collision energy of transitions for MRM: 72>72 and 75>75, 5 volts; 72>55 and 75>58, 10 volts: 72>27 and 75>29, 19 volts. Dwell time 0.3 sec each with 0.02 sec inter-channel and inter-scan delay.
14. Quantitation: Parts per billion acrylamide=(200 ng internal standard) (area of m/z 55)/(area of m/z 58) (g of portion analyzed) (response factor). The response factor is the average response factor obtained from a concurrently run standard curve encompassing the range of apparent acrylamide levels in the test portions. Limit of quantitation is defined as the level at which a 10:1 signal/noise ratio is observed for the analyte quantitation ion (m/z 55).

In some embodiments, the heated food product has an acrylamide content that is 90% or less of the acrylamide content of the same food product in which the divalent metal ion salt is replaced with a corresponding potassium salt in a stoichiometric amount based on the free metal ion content, preferably 85% or less, more preferably 80% or less, 75% or less, 70% or less, 65% or less, 60% or less, 55% or less 50% or less, 45% or less, 40% or less, 35% or less, 30% or less, or 25% or less.

### EXAMPLES

### Biscuits

These examples were conducted to determine how the inclusion of a divalent metal ion salt affected the browning, taste and texture properties of biscuits. Biscuits were prepared according to the ingredient list in Table 1. All quantities in Table 1 are quoted in parts per the total number of parts listed in the Total section for each example, on a by weight basis.

TABLE 1

| | Example 0 | | | | | | | Example 1 | | |
|---|---|---|---|---|---|---|---|---|---|---|
| | CEX | CEX | CEX | CEX | CEX | EX | EX | CEX | EX | EX |
| Ingredients | 0-1 | 0-2 | 0-3 | 0-4 | 0-5 | 0-1 | 0-2 | 1-1 | 1-1 | 1-2 |
| Wheat flour | 53.00 | 53.00 | 53.00 | 53.00 | 53.00 | 53.00 | 53.00 | 56.00 | 56.00 | 56.00 |
| T45 | | | | | | | | | | |
| Caster sugar | 10.62 | 10.62 | 10.62 | 10.62 | 10.62 | 10.62 | 10.62 | 11.00 | 11.00 | 11.00 |
| 400 | | | | | | | | | | |
| Erythritol | | | | | | | | | | |
| Oat flakes | 10.00 | 10.00 | 10.00 | 10.00 | 10.00 | 10.00 | 10.00 | | | |
| Sunflower oil | 13.00 | 13.00 | 13.00 | 13.00 | 13.00 | 13.00 | 13.00 | 13.00 | 13.00 | 13.00 |
| Table salt | 0.45 | 0.45 | 0.45 | 0.45 | 0.45 | 0.45 | 0.45 | 0.45 | 0.45 | 0.45 |
| Rapeseed | 0.53 | 0.53 | 0.53 | 0.53 | 0.53 | 0.53 | 0.53 | 0.53 | 0.53 | 0.53 |
| Lecithin | | | | | | | | | | |
| Natural | 0.09 | 0.09 | 0.09 | 0.09 | 0.09 | 0.09 | 0.09 | | | |
| vanilla | | | | | | | | | | |
| flavour | | | | | | | | | | |
| Tap water | 7.50 | 7.50 | 6.68 | 6.68 | 6.68 | 7.50 | 7.50 | 10.00 | 10.00 | 10.00 |
| Crystalline | 5.00 | | 5.00 | 5.00 | 5.00 | 5.00 | 5.00 | 5.00 | 5.00 | 5.00 |
| allulose | | | | | | | | | | |
| Crystalline | | 5.00 | | | | | | | | |
| fructose | | | | | | | | | | |
| Baking | | | | | | | | 0.50 | 0.50 | 0.50 |
| powder | | | | | | | | | | |
| Ammonium | 0.34 | 0.34 | 0.16 | 0.16 | 0.16 | 0.34 | 0.34 | | | |
| bicarbonate | | | | | | | | | | |
| Sodium | 0.14 | 0.14 | 0.13 | | | | | | | |
| bicarbonate | | | | | | | | | | |
| Sodium Acid | 0.20 | 0.20 | 0.13 | | | | | | | |
| Pyrophosphate | | | | | | | | | | |
| Salt blend A | | | | 2.65 | | | | | | |
| Salt blend B | | | | | 2.81 | | | | | |
| Salt blend C | | | | | | 3.23 | | 3.23 | | |
| Salt blend D | | | | | | | | | 3.23 | |
| Salt blend E | | | | | | | 3.60 | | | |
| Calcium | | | | | | | | | | |
| chloride | | | | | | | | | | 0.61 |
| Calcium | | | | | | | | | | |
| lactate | | | | | | | | | | |
| pentahydrate | | | | | | | | | | |
| Calcium | | | | | | | | | | |
| carbonate | | | | | | | | | | |
| Tricalcium | | | | | | | | | | |
| dicitrate | | | | | | | | | | |
| tetrahydrate | | | | | | | | | | |
| Monocalcium | | | | | | | | | | |
| phosphate | | | | | | | | | | |
| anhydrous | | | | | | | | | | |
| Tricalcium | | | | | | | | | | |
| phosphate | | | | | | | | | | |
| 50% | | | 0.60 | | | | | 0.20 | 0.20 | 0.20 |
| concentrated | | | | | | | | | | |
| citric acid | | | | | | | | | | |
| solution | | | | | | | | | | |
| DATEM | | | | | | | | | | |
| Total | 100.87 | 100.87 | 100.39 | 102.18 | 102.34 | 103.76 | 104.13 | 96.68 | 99.91 | 99.91 |
| pH | 7.44 | 7.83 | 5.48 | 6.82 | 7.27 | 7 | 7.15 | 5.35 | 6.22 | 6.15 |

| | Example 1 | | | Example 2 | | | | | | | |
|---|---|---|---|---|---|---|---|---|---|---|---|
| | EX | EX | CEX | CEX | CEX | EX | EX | EX | EX | EX | EX |
| Ingredients | 1-3 | 1-4 | 1-2 | 2-1 | 2-2 | 2-1 | 2-2 | 2-3 | 2-4 | 2-5 | 2-6 |
| Wheat flour | 56.00 | 56.00 | 56.00 | 56.00 | 56.00 | 56.00 | 56.00 | 56.00 | 56.00 | 56.00 | 56.00 |
| T45 | | | | | | | | | | | |
| Caster sugar | 11.00 | 11.00 | | 11.00 | 11.00 | 11.00 | 11.00 | 11.00 | 11.00 | 11.00 | 11.00 |
| 400 | | | | | | | | | | | |
| Erythritol | | | 14.50 | | | | | | | | |
| Oat flakes | | | | | | | | | | | |
| Sunflower oil | 13.00 | 13.00 | 13.00 | 13.00 | 13.00 | 13.00 | 13.00 | 13.00 | 13.00 | 13.00 | 13.00 |
| Table salt | 0.45 | 0.45 | 0.45 | 0.45 | 0.45 | 0.45 | 0.45 | 0.45 | 0.45 | 0.45 | 0.45 |
| Rapeseed | 0.53 | 0.53 | 0.53 | 0.53 | | 0.53 | 0.53 | 0.53 | 0.53 | 0.53 | 0.53 |
| Lecithin | | | | | | | | | | | |
| Natural | | | | | | | | | | | |
| vanilla | | | | | | | | | | | |
| flavour | | | | | | | | | | | |
| Tap water | 10.00 | 10.00 | 10.00 | 10.00 | 10.00 | 10.00 | 10.00 | 10.00 | 10.00 | 10.00 | 10.00 |
| Crystalline | 5.00 | 5.00 | | 5.00 | 5.00 | 5.00 | 5.00 | 5.00 | 5.00 | 5.00 | 5.00 |
| allulose | | | | | | | | | | | |
| Crystalline | | | | | | | | | | | |
| fructose | | | | | | | | | | | |
| Baking | 0.50 | 0.50 | 0.50 | 0.50 | 0.35 | 0.35 | 0.35 | 0.35 | 0.35 | 0.35 | 0.35 |
| powder | | | | | | | | | | | |
| Ammonium | | | | | | | | | | | |
| bicarbonate | | | | | | | | | | | |
| Sodium | | | | | | | | | | | |
| bicarbonate | | | | | | | | | | | |
| Sodium Acid | | | | | | | | | | | |
| Pyrophosphate | | | | | | | | | | | |
| Salt blend A | | | | | | | | | | | |
| Salt blend B | | | | | | | | | | | |
| Salt blend C | | | | | | | | | | | |
| Salt blend D | | | | | | | | | | | |
| Salt blend E | | | | | | | | | | | |
| Calcium | | | | | | | | | | | |
| chloride | | | | | 0.61 | | | | | | |
| Calcium | | | | | | | | | | | |
| lactate | 1.70 | | | | | 1.70 | | | | | |
| pentahydrate | | | | | | | | | | | |
| Calcium | | | | | | | 0.55 | | | | |
| carbonate | | | | | | | | | | | |
| Tricalcium | | | | | | | | 1.04 | | | |
| dicitrate | | | | | | | | | | | |
| tetrahydrate | | | | | | | | | | | |
| Monocalcium | | | | | | | | | | 1.29 | |
| phosphate | | | | | | | | | | | |
| anhydrous | | | | | | | | | | | |
| Tricalcium | | | | | | | | | | | 0.57 |
| phosphate | | | | | | | | | | | |
| 50% | 0.20 | 0.20 | 0.20 | 0.20 | 0.20 | 0.20 | 0.20 | 0.20 | 0.20 | 0.20 | 0.20 |
| concentrated | | | | | | | | | | | |
| citric acid | | | | | | | | | | | |
| solution | | | | | | | | | | | |
| DATEM | | | | | 0.40 | | | | | | |
| Total | 97.29 | 98.32 | 95.18 | 96.68 | 96.40 | 97.14 | 98.23 | 97.08 | 97.57 | 97.82 | 97.10 |
| pH | 4.56 | 5.30 | 5.43 | 5.6 | 5.1 | 5.0 | 5.3 | 5.5 | 5.4 | 4.3 | 5.4 |

| | Example 3 | | | | | Example 4 | | | | | | | | | | |
|---|---|---|---|---|---|---|---|---|---|---|---|---|---|---|---|---|
| | CEX | EX | EX | CEX | CEX | CEX | EX | EX | EX | EX | EX | EX | EX | EX | EX | EX |
| Ingredients | 3-1 | 3-1 | 3-2 | 3-2 | 3-3 | 4-1 | 4-1 | 4-2 | 4-3 | 4-4 | 4-5 | 4-6 | 4-7 | 4-8 | 4-9 | 4-10 |
| Wheat flour T45 | 56.00 | 56.00 | 56.00 | 56.00 | 56.00 | 56.00 | 56.00 | 56.00 | 56.00 | 56.00 | 56.00 | 56.00 | 56.00 | 56.00 | 56.00 | 56.00 |
| Caster sugar 400 | 11.00 | 11.00 | 11.00 | 11.00 | 11.00 | 11.00 | 11.00 | 11.00 | 11.00 | 11.00 | 11.00 | 11.00 | 11.00 | 11.00 | 11.00 | 11.00 |
| Sunflower oil | 13.00 | 13.00 | 13.00 | 13.00 | 13.00 | 13.00 | 13.00 | 13.00 | 13.00 | 13.00 | 13.00 | 13.00 | 13.00 | 13.00 | 13.00 | 13.00 |
| Table salt | 0.45 | 0.45 | 0.45 | 0.45 | 0.45 | 0.45 | 0.45 | 0.45 | 0.45 | 0.45 | 0.45 | 0.45 | 0.45 | 0.45 | 0.45 | 0.45 |
| Rapeseed Lecithin | 0.53 | 0.53 | 0.53 | 0.53 | 0.53 | 0.53 | 0.53 | 0.53 | 0.53 | 0.53 | 0.53 | 0.53 | 0.53 | 0.53 | 0.53 | 0.53 |
| Tap water | 11.00 | 11.00 | 11.00 | 11.00 | 11.00 | 11.00 | 11.00 | 11.00 | 11.00 | 11.00 | 11.00 | 11.00 | 11.00 | 11.00 | 11.00 | 11.00 |
| Crystalline | 5.00 | 5.00 | 5.00 | 5.00 | 5.00 | 5.00 | 5.00 | 5.00 | 5.00 | 5.00 | 5.00 | 5.00 | 5.00 | 5.00 | 5.00 | 5.00 |
| allulose | | | | | | | | | | | | | | | | |
| Baking powder | 0.35 | 0.35 | 0.35 | 0.35 | 0.35 | | | | | | | | | | | |
| Ammonium | | | | | | 0.34 | 0.34 | 0.34 | 0.34 | 0.34 | 0.34 | 0.34 | 0.34 | 0.34 | 0.34 | 0.34 |
| bicarbonate | | | | | | | | | | | | | | | | |
| Salt blend C | | | | | | | | | | | 3.23 | | | | | |
| Salt blend E | | | | | | | | | | | | 3.60 | | | | |
| Salt blend F | | | | | | | | | | | | | 2.80 | | | |
| Salt blend G | | | | | | | | | | | | | | 2.80 | | |
| Salt blend H | | | | | | | | | | | | | | | 3.40 | |
| Salt blend I | | | | | | | | | | | | | | | | 3.40 |
| Calcium chloride | | 0.20 | 0.10 | | | | 0.60 | 0.50 | 0.40 | 0.30 | | | | | | |
| Potassium chloride | | | | 0.20 | 0.10 | | | | | | | | | | | |
| 50% concentrated | 0.20 | 0.20 | 0.20 | 0.20 | 0.20 | 0.20 | 0.20 | 0.20 | 0.20 | 0.20 | 0.20 | 0.20 | 0.20 | 0.20 | 0.20 | 0.20 |
| citric acid solution | | | | | | | | | | | | | | | | |
| Total | 97.53 | 97.73 | 97.63 | 97.73 | 97.63 | 97.52 | 98.12 | 98.02 | 97.92 | 97.82 | 100.75 | 101.12 | 100.32 | 100.32 | 100.92 | 100.92 |
| pH | 5.6 | 4.8 | 5.0 | 5.1 | 5.2 | 7.2 | 6.8 | 6.5 | 6.8 | 7.0 | 6.3 | 6.3 | 7.2 | 7.0 | 7.2 | 7.0 |

| | Example 5 | | | | | | |
|---|---|---|---|---|---|---|---|
| | Ex | Ex | Ex | Ex | Ex | Ex | Ex |
| Ingredients | 5-1 | 5-2 | 5-3 | 5-4 | 5-5 | 5-6 | 5-7 |
| Wheat flour T45 | 56.00 | 56.00 | 56.00 | 56.00 | 56.00 | 56.00 | 56.00 |
| Caster sugar 400 | 11.00 | 11.00 | 11.00 | 11.00 | 11.00 | 11.00 | 11.00 |
| Sunflower oil | 13.00 | 13.00 | 13.00 | 13.00 | 13.00 | 13.00 | 13.00 |
| Table salt | 0.45 | 0.45 | 0.45 | 0.45 | 0.45 | 0.45 | 0.45 |
| Rapeseed Lecithin | 0.53 | 0.53 | 0.53 | 0.53 | 0.53 | 0.53 | 0.53 |
| Tap water | 10.00 | 10.00 | 10.00 | 10.00 | 10.00 | 10.00 | 10.00 |
| Crystalline allulose | 5.00 | 5.00 | 5.00 | 5.00 | 5.00 | 5.00 | 5.00 |
| Ammonium bicarbonate | 0.34 | 0.34 | 0.34 | 0.34 | 0.34 | 0.34 | 0.34 |
| Salt blend C | | | | | 3.23 | | |
| Salt blend E | | | | | | 2.80 | |
| Salt blend F | | | | | | | 2.80 |
| Calcium chloride | | 0.60 | 0.50 | 0.40 | | | |
| Calcium sulfate | 0.90 | | | | | | |
| 50% concentrated | 0.20 | 0.20 | 0.20 | 0.20 | 0.20 | 0.20 | 0.20 |
| citric acid solution | | | | | | | |
| DATEM | | | | | | | |
| Total | 97.42 | 97.12 | 97.02 | 96.92 | 99.75 | 99.32 | 99.32 |
| pH | 7.2 | 7.0 | 7.1 | 6.8 | 6.5 | 7.0 | 6.9 |

The biscuits were made with commercially available, food-grade low protein (T45) wheat flour, no. 400 mesh caster sugar, erythritol, sunflower oil, table salt, rapeseed lecithin, natural vanilla flavour, tap water, baking powder, ammonium bicarbonate, sodium bicarbonate, sodium acid pyrophosphate, calcium chloride, calcium lactate pentahydrate, calcium carbonate, tricalcium dicitrate tetrahydrate, calcium sulfate, tricalcium phosphate, potassium chloride, 50% citric acid solution and mono- and diacetyltartaric acid esters of mono- and diglycerides of fatty acids (DATEM). Crystalline allulose was provided as Dolcia Prima® Crystalline Allulose from Tate & Lyle. Crystalline fructose was provided as Krystar® Crystalline Fructose from Tate & Lyle.

Salt blend A is a raising agent with disodium diphosphate and sodium hydrogen carbonate as functional ingredients. Salt blend B is a raising agent with disodium diphosphate and potassium hydrogen carbonate as functional ingredients. Salt blends C and D are raising agents comprising approximately 37% with disodium pyrophosphate, 25% potassium hydrogen carbonate and 19% calcium chloride as functional ingredients, with wheat flour and rapeseed oil. Salt blend E is a raising agent comprising approximately 37% with disodium pyrophosphate, 25% potassium hydrogen carbonate and 25% calcium chloride as functional ingredients, with wheat flour and rapeseed oil. Salt blend F is a blend of calcium chloride (about 58% by weight) and sodium chloride (about 42% by weight). Salt blend G is a blend of calcium chloride (about 60% by weight) and sodium chloride (about 40% by weight). Salt blend H is a blend of calcium chloride (about 47% by weight) and potassium chloride (about 53% by weight). Salt blend I is a blend of calcium chloride (about 46% by weight) and potassium chloride (about 54% by weight).

### Example 0

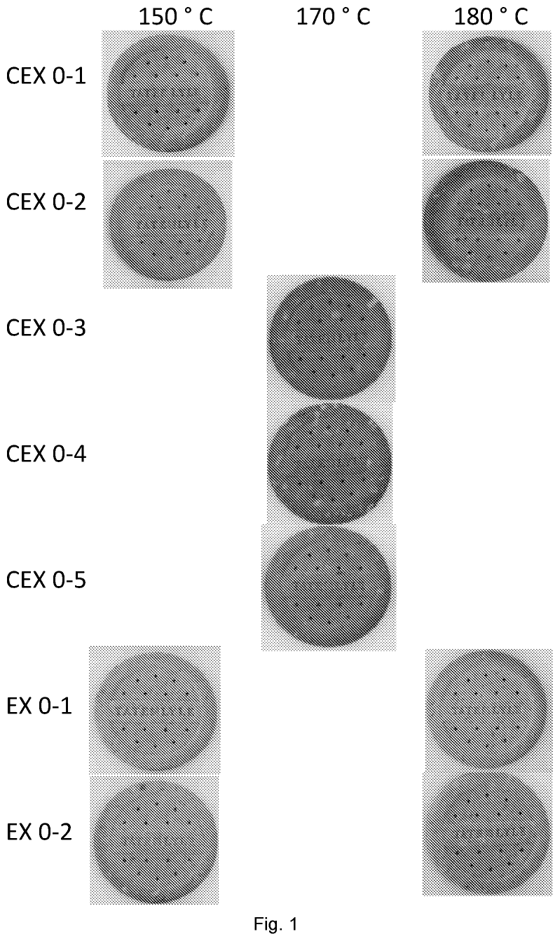

Comparative Examples 0-1 to 0-5 and Examples 0-1 and 0-2 were prepared by assembling the ingredients listed in Table 1 and mixing them together using an R-Tech rotary moulder. Comparative Examples 0-3 to 1-5 were cooked at 170° C. for 9 minutes. Samples of Comparative Examples 0-1 and 0-2 and Examples 0-1 and 0-2 were cooked at 150° C. for 12 minutes and 170° C. for 9 minutes. The biscuits prepared after baking are shown in FIG. 1.

The biscuits were analysed to determine the water activity, moisture, moisture loss and pH to ensure consistency between the biscuits. The stack height and spread of the biscuits were analysed to determine whether changes in the leavening agents impacted the shape and size of the biscuit. Colour was inspected visually after baking. The calcium content of the biscuits was calculated. The results are displayed in Table 2.

Water activity was measured by an Aw meter by Decagon Aqualab S3TE.

Moisture content was measured using a Dessicator Halogen Mettler HG 63.

Stack height is the height in centimetres of 10 biscuits when spread. The spread is the mean measure of the diameter of ten biscuits in centimetres.

### Results

TABLE 2

| | Comp. | Comp. | Comp. | Comp. | Comp. | | |
|---|---|---|---|---|---|---|---|
| Measurement | Ex 0-1 | Ex. 0-2 | Ex. 0-3 | Ex. 0-4 | Ex. 0-5 | Ex. 0-1 | Ex. 0-2 |
| Water activity after baking at 170° C. | — | — | 0.123 | 0.118 | 0.123 | — | — |
| Moisture content after baking at 170° C./% | — | — | 2.41 | 2.02 | 1.93 | — | — |
| Water activity after baking at 150° C. | 0.112 | 0.123 | — | — | — | 0.128 | 0.103 |
| Moisture content after baking at 150° C./% | 2.43 | 2.85 | — | — | — | 2.87 | 2.32 |
| Water activity after baking at 180° C. | 0.098 | 0.113 | — | — | — | 0.173 | 0.126 |
| Moisture content after baking at 180° C./% | 2.39 | 2.39 | — | — | — | 2.32 | 2.67 |
| Weight before baking at 170° C./g | — | — | 2012.4 | 2032.6 | — | — | — |
| Weight after baking at 170° C./g | — | — | 1971.2 | 1945.3 | — | — | — |
| Weight loss after baking at 170° C./% | — | — | 2.01 | 4.27 | — | — | — |
| Weight before baking at 150° C./g | 2008.5 | 2005.7 | — | — | — | 2022.8 | 2039.2 |
| Weight after baking at 150° C./g | 1960.9 | 1961.3 | — | — | — | 1977.4 | 1991.6 |
| Weight loss after baking at 150° C./% | 2.37 | 2.21 | — | — | — | 2.24 | 2.34 |
| Weight before baking at 180° C./g | 2019.5 | 2060.7 | — | — | — | 2048.2 | 1980.7 |
| Weight after baking at 180° C./g | 1972.6 | 2010.2 | — | — | — | 2002.3 | 1941.5 |
| Weight loss after baking at 180° C./% | 2.30 | 2.45 | — | — | — | 2.24 | 1.98 |
| pH | 7.44 | 7.83 | 5.48 | 6.82 | 7.27 | 7.00 | 7.15 |
| Stack height after baking at 150° C./cm | 6.85 | 6.75 | — | — | — | 6.25 | 5.85 |
| Stack height after baking at 170° C./cm | — | — | 6.35 | 6.78 | 6.58 | — | — |
| Stack height after baking at 180° C./cm | 6.45 | 6.5 | — | — | — | 6.15 | 5.85 |
| Spread after baking at 150° C./cm | 5.90 | 5.82 | — | — | — | 5.85 | 5.82 |
| Spread after baking at 170° C./cm | — | — | 5.86 | 5.84 | 5.93 | — | — |
| Spread after baking at 180° C./cm | 5.89 | 5.90 | — | — | — | 5.82 | 5.82 |
| Calcium content/% | — | — | — | — | — | 0.22 | 0.33 |

Water activity and moisture levels were found to be similar between across all examples and comparative examples, were consistent within each batch, and were within an acceptable range for biscuits. There was no significant difference between stack heights of the biscuits at any of the cooking temperatures. Only biscuits made according to Example 0-2 had a lower stack height. Diameter is not significantly impacted by composition or baking temperatures because the mixture for all examples is quite dry and does not tend to spread during baking.

Colour was evaluated by a visual appraisal of each of the receipts. The acceptability of 10 colour is subjective and will vary according to the appraiser's personal preference and the product type. An objective assessment of lightness and darkness is possible. Comparative Examples 0-3 to 0-5 resulted in very dark colour at 170° C. These recipes are considered unacceptable for many applications. Comparative Examples 0-1 and 0-2 and Examples 0-1 and 0-2 present an acceptable light brown colour at both temperatures tested, though Comparative Examples 0-1 and 0-2 are darker. Overall, the best results were shown with Examples 0-1 and 0-2. This study shows that baking temperatures are the main driver in developing colouration, fructose seems more sensitive to browning than allulose, and a higher calcium content reduces browning.

### Example 1

Comparative Examples 1-1 to 1-5 and Examples 1-1 and 1-2 were prepared by assembling the ingredients listed in Table 1. To prepare the biscuits, the dry ingredients (caster sugar, crystalline allulose, rapeseed lecithin), fat (sunflower oil) and citric acid solution were mixed for 2 minutes using a Kitchen Aid. Then, the baking powder was diluted in the tap water and added to the mix and mixed for 2 minutes. Then, the flour, salt blend/other salts were added to the mix and mixed for a further 1 minute. The biscuits were divided into batches. One batch was baked at 150° C. for 14 minutes and the other batch was baked at 180° C. for 12 minutes to represent the lower and upper ranges of normal baking temperatures.

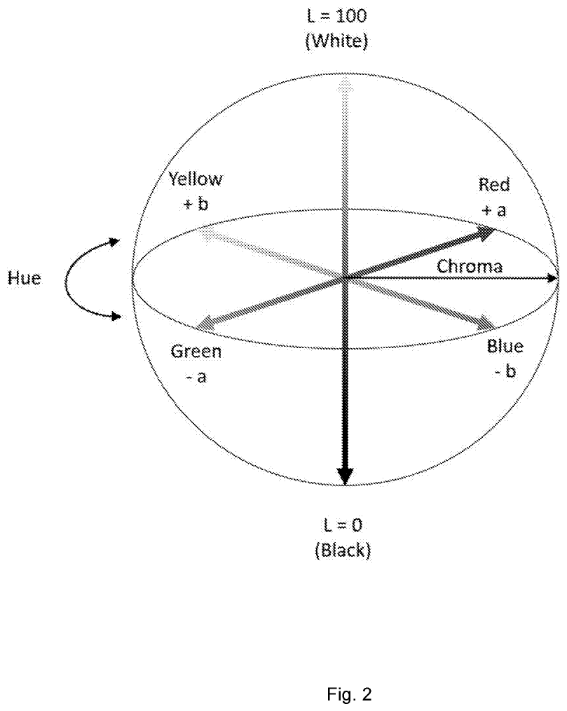

The biscuits were analysed to determine their colour after baking. The colour of the biscuits was characterized using the CIE 1976 L*a*b* scale (CIE International Commission on Illumination, Recommendations on Uniform Color Spaces, Color-Difference Equations, Psychometric Color Terms, Supplement No. 2 to CIE Publication No. 15, Colorimetry, 1971 and 1978), which is in widespread use. On the CIE 1976 L*a*b* scale, the “L*” value measures lightness and varies from 100 for perfect white to 0 for black. The chromaticity dimensions on CIE 1976 L*a*b* scale, the “a*” value and the “b*” value, give designations of color as follows: “a*” measures redness when positive, grey when zero and greenness when negative and “b*” measures yellowness when positive, grey when zero and blueness when negative. An illustration of the CIE 1976 L*a*b* scale is shown in FIG. 2. A value was determined for the top and bottom of each biscuit.

The biscuits were also taste tested by a group of employees of Tate & Lyle and assessed for the crispiness, softness, sweetness, lemon taste, salt off-note and overall preference. Biscuits were assigned a rating of up to ++++ with ++++ being very favourable.

The stack height of the biscuits was analysed to determine whether changes in the leavening agents impacted the shape and size of the biscuit. In Example 1, the stack height was taken to be the height of a stack of 8 biscuits in centimetres.

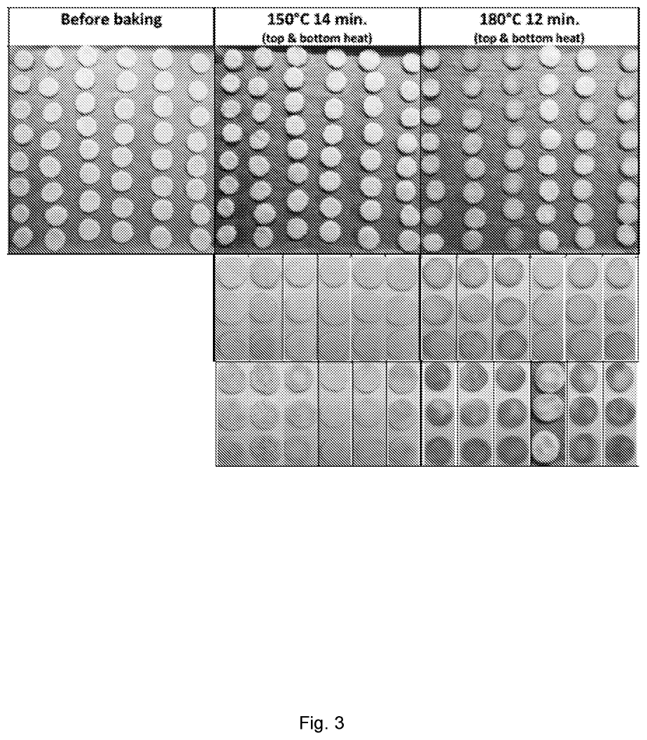

The results are displayed in Table 3. Photographs of the biscuits are shown in FIG. 3.

TABLE 3

| | 150° C., 14 min | | | | | | 180° C., 12 min | | | | | |
|---|---|---|---|---|---|---|---|---|---|---|---|---|
| | CEX | EX | EX | EX | EX | CEX | CEX | EX | EX | EX | EX | CEX |
| | 1-1 | 1-1 | 1-2 | 1-3 | 1-4 | 1-2 | 1-1 | 1-1 | 1-2 | 1-3 | 1-4 | 1-2 |
| Stack height | 6.3 | 5.3 | 4.2 | 5.5 | 5.1 | 5.7 | 5.3 | 5.0 | 6.1 | 4.5 | 5 | 5.3 |
| L*(top) | 70.0 | 71.5 | 73.9 | 74.1 | 73.5 | 71.6 | 68.1 | 67.1 | 67.5 | 74.3 | 72.5 | 67.2 |
| L*(bottom) | 66.7 | 64.5 | 71.2 | 73.0 | 70.4 | 60.8 | 52.7 | 53.7 | 54.8 | 61.4 | 61.9 | 50.4 |
| Crispiness | + | ++ | | | | | +++ | ++++ | ++ | + | + | |
| Softness | | | + | + | + | ++ | | | | | | ++ |
| Sweetness | ++ | ++ | + | + | + | ++ | ++ | ++ | + | + | + | ++ |
| Lemon taste | | | ++ | | | | | | ++ | | | |
| Salt off note | | | + | ++ | + | | | | + | ++ | + | |
| Preference | ++ | ++ | | | | ++ | ++ | ++ | | | | ++ |

Example 1-3 (pure calcium chloride) performed best in terms of colour, providing a biscuit that is the most white on the top and bottom and achieving the greatest reduction in browning. Example 1-1 (salt blend C) was the most preferred in terms of taste and texture regardless of the baking temperature.

### Example 2

Similar to Example 1, Comparative Examples 2-1 to 2-2 and Examples 2-1 and 2-6 were prepared by assembling the ingredients listed in Table 1. To prepare the biscuits, the dry ingredients (caster sugar, crystalline allulose, rapeseed lecithin), fat (sunflower oil) and citric acid solution were mixed for 2 minutes using Kitchen Aid. Then, the baking powder was diluted in the tap water and added to the mix and mixed for 2 minutes. Then, the flour, salt blend/other salts were added to the mix and mixed for a further 1 minute. The biscuits were divided into batches. One batch was baked at 150° C. for 14 minutes and the other batch was baked at 180° C. for 14 minutes to represent the lower and upper ranges of normal baking temperatures, with some measurements taken after 10 minutes.

The biscuits were analysed to determine their colour after baking in the same manner as Example 1.

The stack height of the biscuits was analysed to determine whether changes in the leavening agents impacted the shape and size of the biscuit. In Example 2, the stack height of the biscuits after baking at 150° C. for 14 min and 180° C. for 12 min was taken to be the height of a stack of 9 biscuits in centimetres. The stack height of the biscuits after baking at 180° C. for 10 min was taken to be the height of a stack of 4 biscuits in centimetres
tested by a group of employees of Tate & Lyle and assessed for the crispiness, softness, sweetness, lemon taste, salt off-note and overall preference. Biscuits were assigned a rating of of from ++ (very favourable) to −− (very unfavourable).

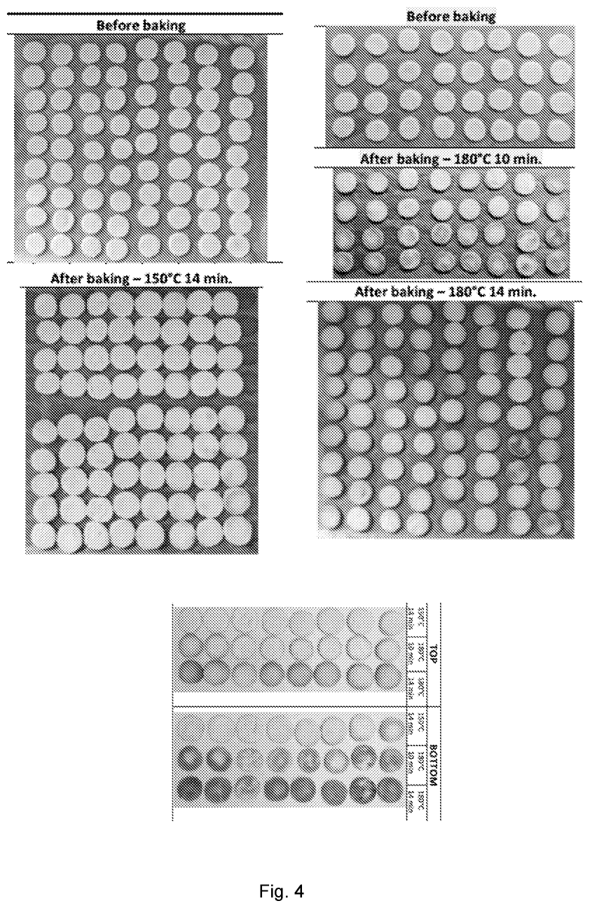

The results are displayed in Table 4. Photographs of the biscuits are shown in FIG. 4.

TABLE 4

| | 150° C., 14 min | | | | | | | |
|---|---|---|---|---|---|---|---|---|
| | CEX | CEX | EX | EX | EX | EX | EX | EX |
| | 2-1 | 2-2 | 2-1 | 2-2 | 2-3 | 2-4 | 2-5 | 2-6 |
| Stack height (before baking) cm | 3.9 | 3.3 | 4 | 4 | 3.9 | 3.3 | 3.5 | 3.5 |
| Stack height (after baking) cm | 5.2 | 4.3 | 5.7 | 5.1 | 4.2 | 4.0 | 4.5 | 4.7 |
| Stack height increase % | 33 | 30 | 43 | 28 | 8 | 21 | 29 | 34 |
| Weight before baking g | 34 | 32 | 37 | 39 | 38 | 32 | 33 | 36 |
| Weight after baking g | 30 | 29 | 34 | 35 | 35 | 28 | 29 | 32 |
| Weight loss % | 11.8 | 9.4 | 8.1 | 10.3 | 7.9 | 12.5 | 12.1 | 11.1 |
| L*(top) | 72.3 | 74.0 | 74.3 | 74.0 | 74.0 | 74.1 | 73.6 | 72.5 |
| L*(bottom) | 70.4 | 71.4 | 72.2 | 71.2 | 72.7 | 71.2 | 71.1 | 71.0 |
| Improvement of color | ∘ | ∘ | + | ∘ | ∘ | − | ∘ | − |
| Surface | | | − | | | | | |
| Hardness | ++ | + | ++ | | ++ | ++ | ++ | |
| Softness | + | | | | + | + | | |
| Sweetness | + | ++ | + | + | + | + | − | − |
| Sour taste | | | + | | | | ++ | |
| Lemon taste | | | | | | | + | |
| Salt off note | | | | ++ | | | | |
| Preference | + | + | − | | + | | − | − |
| | 180° C., 10 min | | | | | | | |
| | CEX | CEX | EX | EX | EX | EX | EX | EX |
| | 2-1 | 2-2 | 2-1 | 2-2 | 2-3 | 2-4 | 2-5 | 2-6 |
| Stack height (before baking) cm | 1.5 | 1.5 | 1.7 | 1.7 | 1.5 | 1.5 | 1.5 | 1.5 |
| Stack height (after baking) cm | 2.2 | 2.2 | 2.5 | 2.5 | 2.2 | 2.4 | 2.5 | 2.2 |
| Stack height increase % | 47 | 47 | 47 | 47 | 47 | 60 | 67 | 47 |
| Weight before baking g | 14 | 14 | 15 | 16 | 15 | 16 | 17 | 13 |
| Weight after baking g | 12 | 13 | 14 | 13 | 13 | 14 | 15 | 11 |
| Weight loss % | 14.3 | 7.1 | 6.7 | 18.8 | 13.3 | 12.5 | 11.8 | 15.4 |
| L*(top) | 71.2 | 72.9 | 73.3 | 73.2 | 73.4 | 73.2 | 72.7 | 72.3 |
| L*(bottom) | 63.2 | 67.5 | 68.6 | 64.6 | 63.4 | 65.4 | 60.9 | 53.1 |
| | 180° C., 14 min | | | | | | | |
| | CEX | CEX | EX | EX | EX | EX | EX | EX |
| | 2-1 | 2-2 | 2-1 | 2-2 | 2-3 | 2-4 | 2-5 | 2-6 |
| Stack height (before baking) cm | 4.3 | 4.2 | 4.0 | 4.0 | 3.8 | 4.0 | 4.1 | 4.0 |
| Stack height (after baking) cm | 5.7 | 5.8 | 5.8 | 5.5 | 5.1 | 5.3 | 5.3 | 5.7 |
| Stack height increase % | 33 | 38 | 45 | 38 | 34 | 33 | 29 | 43 |
| Weight before baking g | 40 | 43 | 36 | 37 | 37 | 39 | 44 | 42 |
| Weight after baking g | 34 | 37 | 31 | 32 | 32 | 33 | 38 | 36 |
| Weight loss % | 15.0 | 14.0 | 13.9 | 13.5 | 13.5 | 15.4 | 13.6 | 14.3 |
| L*(top) | 60.7 | 67.9 | 71.6 | 67.2 | 66 | 67.2 | 69.9 | 68.3 |
| L*(bottom) | 48.3 | 51.5 | 57.8 | 56.4 | 55.3 | 48.5 | 46.6 | 47.9 |
| Improvement of color | −−− | −− | + | −− | −− | −− | − | − |
| Surface | | | − | | | | | |
| Hardness | ++ | | ++ | | | ++ | | |
| Softness | | | | | ++ | | ++ | |
| Sweetness | + | | | | + | + | | + |
| Sour taste | + | ++ | + | + | + | + | − | − |
| Lemon taste | | | + | | | | ++ | |
| Salt off note | | | + | ++ | | | | |
| Preference | + | + | − | | + | | − | − |

Example 2 demonstrates that calcium chloride performs best in terms of improving whiteness in biscuits with allulose. Calcium carbonate performs better in terms of taste and overall preference.

Solid calcium chloride is known to be hygroscopic and tends to clump. If clumping can be avoided, it is likely that the calcium chloride content can be reduced, improving the overall flavor and preference for the recipe while obtaining the same reduction in colour formation. For this reason, it will be advantageous to provide the calcium chloride in solution, for example in a syrup with the reducing saccharide.

### Example 3

Similar to Examples 1 and 2, Comparative Examples 3-1 to 3-3 and Examples 3-1 and 3-2 were prepared by assembling the ingredients listed in Table 1. To prepare the biscuits, the dry ingredients (caster sugar, crystalline allulose, rapeseed lecithin), fat (sunflower oil) and citric acid solution were mixed for 2 minutes using a Kitchen Aid. Then, the baking powder was diluted in the tap water and added to the mix and mixed for 2 minutes. Then, the flour, salt blend/other salts were added to the mix and mixed for a further 1 minute. The biscuits were divided into batches. One batch was baked at 150° C. for 14 minutes and the other batch was baked at 180° C. for 11 minutes to represent the lower and upper ranges of normal baking temperatures.

The biscuits were analysed to determine their colour after baking in the same manner as Example 1.

The stack height of the biscuits was analysed to determine whether changes in the leavening agents impacted the shape and size of the biscuit. In Example 3, the stack height of the biscuits after baking at 150° C. for 14 min and 180° C. for 14 min was taken to be the height of a stack of 6 biscuits in centimetres.

The biscuits were also taste tested by a group of employees of Tate & Lyle and assessed for improvement in colour, hardness/crispiness/softness, sweetness and bitter taste. Biscuits were assigned a rating of up to ++++, with ++++ being very favourable, with o indicating an acceptable property.

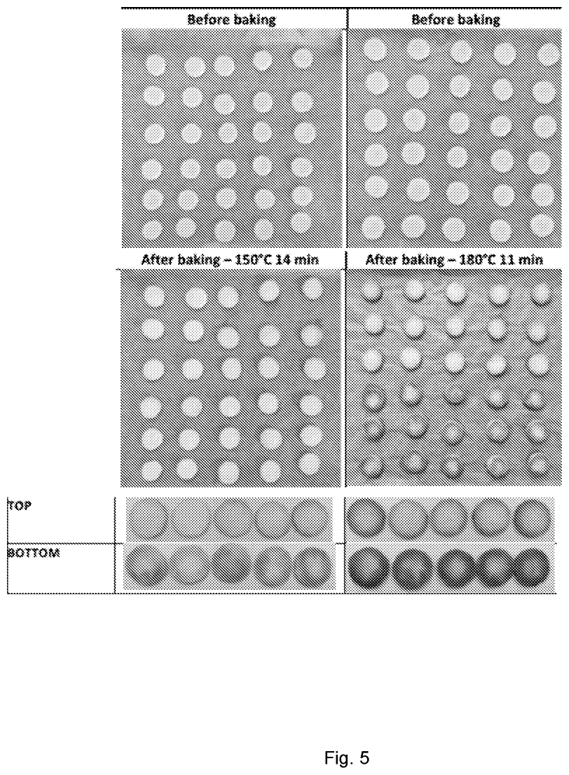

The results are displayed in Table 5. Photographs of the biscuits are shown in FIG. 5.

TABLE 5

| | 150° C., 14 min | | | | | 180° C., 11 min | | | | |
|---|---|---|---|---|---|---|---|---|---|---|
| | CEX | EX | EX | CEX | CEX | CEX | EX | EX | CEX | CEX |
| | 3-1 | 3-1 | 3-2 | 3-2 | 3-3 | 3-1 | 3-1 | 3-2 | 3-2 | 3-3 |
| Stack height (before baking) cm | 2.5 | 2.4 | 2.4 | 2.4 | 2.5 | 3 | 3 | 3.1 | 3.1 | 3.1 |
| Stack height (after baking) cm | 3.0 | 3.1 | 2.9 | 3.0 | 3.0 | 4.0 | 4.0 | 3.9 | 4.1 | 3.9 |
| Stack height increase % | 20 | 29 | 21 | 25 | 20 | 33 | 33 | 26 | 32 | 26 |
| Weight before baking g | 24 | 22 | 22 | 22 | 24 | 30 | 31 | 31 | 30 | 31 |
| Weight after baking g | 21 | 20 | 19 | 18 | 21 | 26 | 27 | 26 | 26 | 27 |
| Weight loss | 13 | 9 | 14 | 18 | 13 | 13 | 13 | 16 | 13 | 13 |
| L*(top) | 71.9 | 74.1 | 72.2 | 73.2 | 71.4 | 64.4 | 69.3 | 68.5 | 68 | 67.5 |
| L*(bottom) | 66.1 | 70.4 | 61.9 | 65.7 | 61.4 | 48.2 | 53.7 | 52.6 | 50.8 | 49.7 |
| Improvement of color | ∘ | + | ∘ | + | ∘ | ∘ | + | + | + | ∘ |
| hardness/crispy | | | | | | | | | | |
| softness | ++ | + | + | + | + | ++ | + | + | + | + |
| sweetness | + | + | + | + | + | + | + | + | ∘ | ∘ |
| bitter | | | | + | + | | | | + | + |

Example 3 shows that calcium chloride performs best in improving the whiteness of biscuits with allulose. Example 3 shows that potassium chloride performs does not show the same effect as calcium chloride. Example 3-1 (0.2% calcium chloride) outperforms Comparative Example 3-2 (0.2% potassium chloride) in terms of whiteness and reduction in browning. Moreover, Example 3-2 (0.1% calcium chloride) outperforms Comparative Example 3-3 (0.1% potassium chloride) in terms of whiteness and reduction in browning. Moreover, Comparative Example 3-2 outperforms Comparative Example 3-1 in terms of whiteness and reduction in browning, demonstrating a dose-response relationship between the calcium chloride content and the whiteness and reduction in browning.

### Example 4

Similar to Examples 1 to 3, Comparative Example 4-1 and Examples 4-1 and 4-10 were prepared by assembling the ingredients listed in Table 1. To prepare the biscuits, the dry ingredients (caster sugar, crystalline allulose, rapeseed lecithin), fat (sunflower oil) and citric acid solution were mixed for 2 minutes using Kitchen Aid. Then, the baking powder was diluted in the tap water and added to the mix and mixed for 2 minutes. Then, the flour, salt blend/other salts were added to the mix and mixed for a further 1 minute. The biscuits were divided into batches. One batch was baked at 150° C. for 14 minutes and the other batch was baked at 180° C. for 11 minutes to represent the lower and upper ranges of normal baking temperatures.

The biscuits were analysed to determine their colour after baking in the same manner as Example 1.

The stack height of the biscuits was analysed to determine whether changes in the leavening agents impacted the shape and size of the biscuit. In Example 4, the stack height of the biscuits after baking at 150° C. for 14 min and 180° C. for 11 min was taken to be the height of a stack of 6 biscuits in centimetres.

5 The biscuits were also taste tested by a group of employees of Tate & Lyle and assessed for improvement in color, sweetness, salty sour, bitter and off taste. Biscuits were assigned a rating of up to ++++, with ++++ being very favourable, with o indicating an acceptable property. Biscuits were also scored on their taste from 1 to 6, with 1 being the least preferred and 6 being the most preferred.

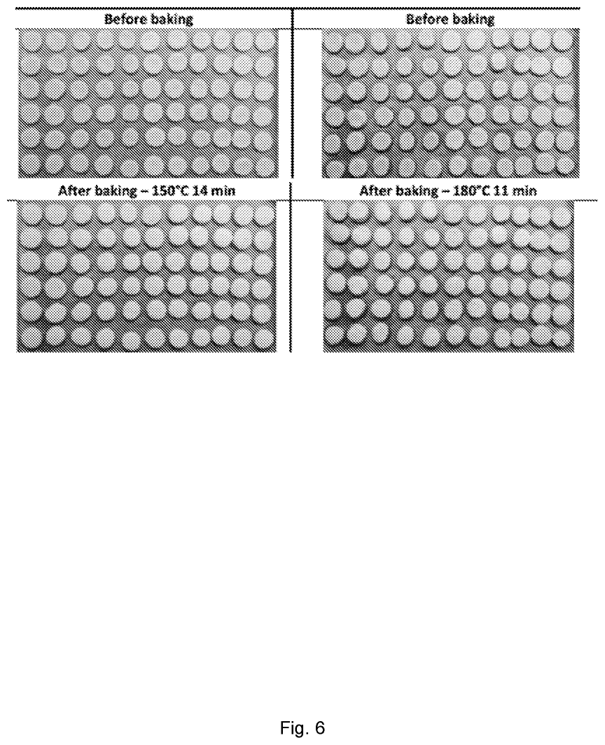

The results are displayed in Table 6. Photographs of the biscuits are shown in FIG. 6.

TABLE 6

| | 150° C., 14 min | | | | | | | | | | |
|---|---|---|---|---|---|---|---|---|---|---|---|
| | CEX | EX | EX | EX | EX | EX | EX | EX | EX | EX | EX |
| | 4-1 | 4-1 | 4-2 | 4-3 | 4-4 | 4-5 | 4-6 | 4-7 | 4-8 | 4-9 | 4-10 |
| Stack height (before baking) cm | 2.8 | 3 | 3 | 3 | 3 | 3.1 | 3.2 | 3.1 | 2.9 | 3 | 2.8 |
| Stack height (after baking) cm | 4.2 | 4.6 | 4.9 | 5.2 | 5.2 | 5.1 | 5.5 | 5.8 | 5 | 5.2 | 4.8 |
| Stack height increase % | 50 | 53 | 63 | 73 | 73 | 65 | 72 | 87 | 72 | 73 | 71 |
| Weight before baking g | 27 | 28 | 28 | 29 | 26 | 29 | 30 | 29 | 27 | 29 | 26 |
| Weight after baking g | 24 | 25 | 25 | 27 | 24 | 27 | 27 | 27 | 25 | 26 | 23 |
| Weight loss % | 11 | 11 | 11 | 7 | 8 | 7 | 10 | 7 | 7 | 10 | 12 |
| L*(top) | 65.6 | 72.5 | 73.1 | 72.4 | 71.9 | 72.2 | 70.7 | 72.3 | 70.8 | 68.7 | 68 |
| L*(bottom) | 64.5 | 65.9 | 67.7 | 67.9 | 67.2 | 67.5 | 68.8 | 70.4 | 69.7 | 64.2 | 67.9 |
| Improvement of color | ∘ | + | + | + | + | + | + | + | + | + | + |
| sweetness | + | + | + | + | + | + | + | + | + | + | + |
| salty | | | | | | | | | | | |
| sour | | + | | | + | | + | | + | | |
| bitter | | + | | | | | | | | | |
| off taste | | | | | | | | | | ++ | ++ |
| Ranking | | | | | | | | | | | |
| | 180° C., 11 min | | | | | | | | | | |
| | CEX | EX | EX | EX | EX | EX | EX | EX | EX | EX | EX |
| | 4-1 | 4-1 | 4-2 | 4-3 | 4-4 | 4-5 | 4-6 | 4-7 | 4-8 | 4-9 | 4-10 |
| Stack height (before baking) cm | 3.4 | 3.5 | 3.5 | 3.5 | 3.5 | 3.5 | 3.5 | 3.5 | 3.5 | 3.5 | 3.5 |
| Stack height (after baking) cm | 5.8 | 7.8 | 6.4 | 7 | 7 | 6.5 | 6.3 | 6.5 | 6.5 | 5.7 | 6.3 |
| Stack height increase % | 71 | 123 | 83 | 100 | 100 | 86 | 80 | 86 | 86 | 63 | 80 |
| Weight before baking g | 28 | 36 | 30 | 29 | 34 | 36 | 33 | 30 | 33 | 36 | 34 |
| Weight after baking g | 24 | 34 | 27 | 27 | 31 | 33 | 30 | 28 | 30 | 33 | 31 |
| Weight loss % | 14 | 6 | 10 | 7 | 9 | 8 | 9 | 7 | 9 | 8 | 9 |
| L*(top) | 59.1 | 71 | 68.2 | 66.6 | 66 | 65.8 | 64.9 | 69.2 | 69.9 | 60.9 | 60.4 |
| L*(bottom) | 55.2 | 57.2 | 53 | 52.6 | 59.4 | 44 | 54.3 | 57.3 | 61.4 | 58.1 | 57.4 |
| Improvement of color | ∘ | ++ | + | + | + | | | + | + | | |
| sweetness | + | + | + | + | + | + | + | + | + | ∘ | ∘ |
| salty | | | | | | + | | | | | |
| sour | | | + | | | | | | + | | |
| bitter | | + | | | | | | | | | |
| off taste | | | | | | | | | | ++ | ++ |
| Ranking | 2 | 4 | 3 | 2 | 2 | 2 | 3 | 3 | 4 | 5 | 6 |

In Example 4, allulose biscuits prepared with calcium chloride remained whiter by far after baking than other biscuits. The use of ammonium bicarbonate in the leavening agent, instead of baking powder, results in less off-taste (cf. Examples 2 and 3). In similar dosages to those used in Example 4, potassium chloride results in a very unpleasant taste. Example 4 also shows that the biscuits rise more with ammonium bicarbonate than with baking powder (cf. Examples 2 and 3).

### Example 5

Similar to Examples 1 to 5, Examples 5-1 to 5-7 were prepared by assembling the ingredients listed in Table 1. To prepare the biscuits, the dry ingredients (caster sugar, crystalline allulose, rapeseed lecithin), fat (sunflower oil) and citric acid solution were mixed for 2 minutes using a Kitchen Aid. Then, the baking powder was diluted in the tap water and added to the mix and mixed for 2 minutes. Then, the flour, salt blend/other salts were added to the mix and mixed for a further 1 minute. The biscuits were divided into batches. One batch was baked at 150° C. for 14 minutes and the other batch was baked at 180° C. for 11 minutes to represent the lower and upper ranges of normal baking temperatures.

The biscuits were analysed to determine their colour after baking in the same manner as Example 1.

The stack height of the biscuits was analysed to determine whether changes in the leavening agents impacted the shape and size of the biscuit. In Example 4, the stack height of the biscuits after baking at 150° C. for 14 min and 180° C. for 11 min was taken to be the height of a stack of 7 biscuits in centimetres.

The biscuits were also taste tested by a group of employees of Tate & Lyle and were ranked against each other for brightness, surface quality, crispiness and dryness, softness and crumbliness, and an overall favourite was chosen.

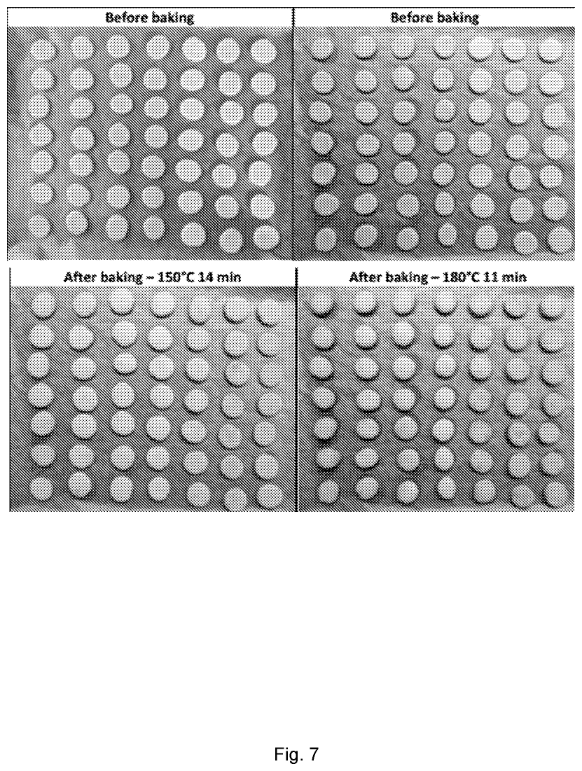

The results are displayed in Table 7. Photographs of the biscuits are shown in FIG. 7.

TABLE 7

| | Ex | Ex | Ex | Ex | Ex | Ex | Ex | Ex | Ex | Ex | Ex | Ex | Ex | Ex |
|---|---|---|---|---|---|---|---|---|---|---|---|---|---|---|
| | 5-1 | 5-2 | 5-3 | 5-4 | 5-5 | 5-6 | 5-7 | 5-1 | 5-2 | 5-3 | 5-4 | 5-5 | 5-6 | 5-7 |
| Stack height | 2.9 | 3.1 | 3.0 | 3.2 | 3.1 | 3.0 | 3.0 | 3.4 | 3.5 | 3.5 | 3.5 | 3.5 | 3.5 | 3.5 |
| (before baking) cm | | | | | | | | | | | | | | |
| Stack height | 4.7 | 5.2 | 5.2 | 5.2 | 5.1 | 4.8 | 4.6 | 5.8 | 7.8 | 6.4 | 7.0 | 7.0 | 6.5 | 6.3 |
| (after baking) cm | | | | | | | | | | | | | | |
| Stack height | 62 | 68 | 73 | 63 | 65 | 60 | 53 | 71 | 123 | 83 | 100 | 100 | 86 | 80 |
| increase % | | | | | | | | | | | | | | |
| Weight before | 27 | 32 | 29 | 31 | 32 | 29 | 30 | 28 | 28 | 31 | 29 | 31 | 31 | 32 |
| baking g | | | | | | | | | | | | | | |
| Weight after | 24 | 28 | 27 | 28 | 26 | 26 | 26 | 24 | 24 | 27 | 26 | 27 | 27 | 28 |
| baking g | | | | | | | | | | | | | | |
| Weight loss % | 11 | 13 | 7 | 10 | 19 | 10 | 13 | 14 | 14 | 13 | 10 | 13 | 13 | 13 |
| L*(top) | 66.4 | 67.6 | 69.1 | 70.5 | 66.8 | 57.1 | 57 | 63.6 | 67.3 | 68.4 | 69.1 | 66.1 | 57 | 57.7 |
| Brightness | | | | | | | | 4 | 2 | 2 | 1 | 3 | 5 | 6 |
| Surface quality | | | | | | | | 2 | 2 | 3 | 1 | 4 | 4 | 4 |
| Crisp and Soft, | | | | | | | | 1 | 1 | 2 | 3 | 2 | 3 | 4 |
| less crumbly | | | | | | | | | | | | | | |
| Comment | | | | | | | | | | | Favourite | Salty | Stale, | |
| | | | | | | | | | | | | | salty, | |
| | | | | | | | | | | | | | slightly | |
| | | | | | | | | | | | | | bitter | |

Allulose biscuits with calcium chloride remain significantly whiter after baking in all test series. The higher the dosage of calcium chloride, the more acidic and bitter the off-taste becomes. A good balance between the level of brightness and taste was achieved with a calcium chloride content of 0.4% by weight. Calcium chloride in combination with ammonium bicarbonate as a leavening agent has less off-taste than baking powder.

### Cakes

These examples were conducted to determine how the inclusion of a divalent metal ion salt affected the browning, taste and texture properties of muffins. Muffins were prepared according to the ingredient list in Table 8. All quantities in Table 8 are quoted as percent by weight based on the total weight of the cake batter.

TABLE 8

| | EX | EX | EX | EX | EX | CEX | EX | EX | CEX | EX | CEX | EX |
|---|---|---|---|---|---|---|---|---|---|---|---|---|
| | 6-1 | 6-2 | 6-3 | 6-4 | 6-5 | 6-1 | 6-6 | 6-7 | 7-1 | 7-1 | 7-2 | 7-2 |
| Sucrose | 16.4 | 16.4 | 16.4 | 16.4 | 16.4 | 16.4 | 16.4 | 16.4 | | | 16.4 | 16.4 |
| Allulose | 7.9 | 7.9 | 7.9 | 7.9 | 7.9 | 7.9 | 7.9 | 7.9 | | | | |
| Fructose | | | | | | | | | 12.9 | 12.9 | | |
| Soluble corn fibre | | | | | | | | | | | | |
| Calcium lactate | 1.70 | | | | | | | | | | | |
| Calcium carbonate | | 0.55 | | | | | | | | | | |
| Calcium citrate | | | 1.04 | | | | | | | | | |
| Calcium phophate | | | | 1.29 | | | | | | | | |
| Calcium sulfate | | | | | 0.34 | | | | | | | |
| Potassium chloride | | | | | | 0.20 | | | | | | |
| Calcium chloride | | | | | | | 0.40 | 0.20 | | 0.60 | | 0.60 |
| pH | 7.4 | 8.0 | 7.9 | 7.7 | 7.8 | 7.7 | 7.2 | 7.5 | | | | |

The muffins were made with commercially available sucrose, calcium salts and potassium salts. Allulose was provided as Dolcia Prima® Allulose Syrup available from Tate & Lyle. Fructose was provided as Krystar® Crystalline Fructose available from Tate & Lyle. Soluble corn fibre was provided as Promitor® Soluble Fibre 70 available from Tate & Lyle. The balance of the muffin batter was made up with commercially available, low protein (T45) wheat flour, rapeseed oil, whole egg liquid, water and baking powder.

### Example 6

Examples 6-1 to 6-7 and Comparative Example 6-1 were prepared by assembling the ingredients listed in Table 8 and processing them in a Kitchen Aid at speed 4 for 4 minutes.

The resulting batter was poured into muffin molds and cooked in a preheated, top and bottom heated oven at 160° C. for 17 to 23 minutes.

The muffins were analysed to determine their colour in a manner analogous to Examples 0 to 5. The taste profile of the muffins was also analysed.

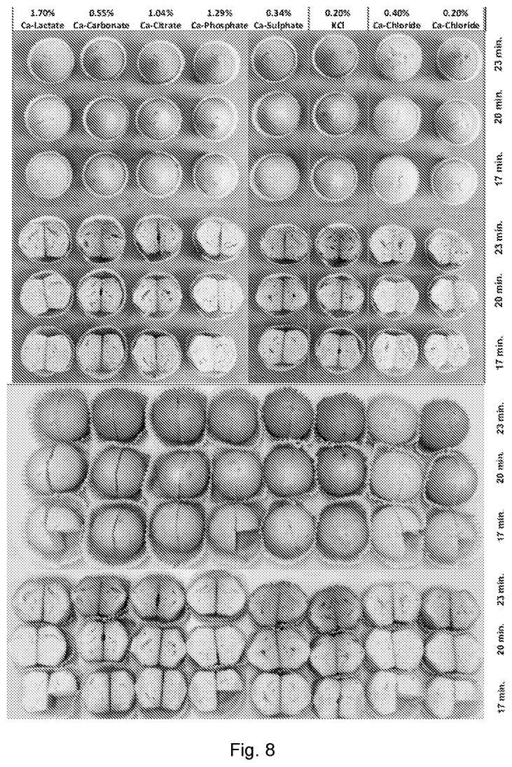

The colour of the surface and the inside of the muffins was analysed. The results are shown in Table 9. Photographs of the muffins are shown in FIG. 8.

TABLE 9

| | | EX | EX | EX | EX | EX | CEX | EX | EX |
|---|---|---|---|---|---|---|---|---|---|
| | | 6-1 | 6-2 | 6-3 | 6-4 | 6-5 | 6-1 | 6-6 | 6-7 |
| | surface | | | | | | | | |
| 23 | L* | 54.6 | 40.6 | 42.2 | 45.7 | 47.3 | 40.4 | 55.3 | 47.9 |
| min | a* | 8.3 | 12.9 | 13.1 | 14.5 | 7.4 | 13.1 | 6.1 | 10.2 |
| | b* | 25.2 | 19.9 | 20.6 | 23.4 | 21.5 | 19.5 | 23.2 | 22.7 |
| 20 | L* | 61.6 | 46.7 | 47.1 | 53.6 | 54.9 | 43.2 | 64.5 | 51.1 |
| min | a* | 2.7 | 13.4 | 12.0 | 10.7 | 3.8 | 13.1 | 1.6 | 8.2 |
| | b* | 25.3 | 23.8 | 23.6 | 27.5 | 22.0 | 21.4 | 24.0 | 24.1 |
| 17 | L* | 64.9 | 53.7 | 55.3 | 59.0 | 63.5 | 53.5 | 65.3 | 61.4 |
| min | a* | −0.3 | 8.0 | 6.4 | 1.8 | −0.5 | 7.9 | 0.1 | 1.7 |
| | b* | 23.3 | 26.3 | 26.7 | 25.5 | 22.4 | 26.5 | 23.2 | 25.2 |
| | inside | | | | | | | | |
| 23 | L* | 58.7 | 49.5 | 54.0 | 61.0 | 43.0 | 45.0 | 59.1 | 53.7 |
| min | a* | 1.2 | 7.8 | 6.9 | 2.0 | 12.4 | 8.8 | 1.0 | 3.8 |
| | b* | 20.9 | 23.0 | 24.0 | 22.7 | 21.5 | 21.6 | 20.8 | 21.4 |
| 20 | L* | 64.8 | 59.0 | 64.1 | 67.6 | 45.5 | 57.5 | 64.8 | 62.2 |
| min | a* | −0.6 | 3.3 | 1.0 | −0.9 | 12.3 | 3.9 | −1.1 | 0.2 |
| | b* | 21.3 | 23.2 | 23.0 | 22.7 | 22.8 | 23.5 | 21.1 | 22.5 |
| 17 | L* | 66.5 | 64.6 | 65.1 | 69.1 | 59.0 | 66.3 | 67.3 | 67.9 |
| min | a* | −1.6 | 0.1 | 0.4 | −1.8 | 5.6 | 1.4 | −1.9 | −1.9 |
| | b* | 20.8 | 22.4 | 23.7 | 22.3 | 27.9 | 23.4 | 20.5 | 22.1 |

Examples 6-6 and 6-7 (calcium chloride) showed the strongest reduction in browning. A slight off-note was perceived at 0.4% calcium chloride. Example 6-1 (calcium lactate) and Example 6-5 did not exhibit any off note despite the relatively high calcium lactate content. The colour of Example 6-1 was perceived as more grayish than brown.

### Example 7

Examples 7-1 to 7-2 and Comparative Examples 7-1 to 7-2 were prepared by assembling the ingredients listed in Table 8 and processing them in a Kitchen Aid at speed 4 for 4 minutes. The resulting batter was poured into muffin molds and cooked in a preheated, top and bottom heated oven at 160° C. for 17 to 23 minutes.

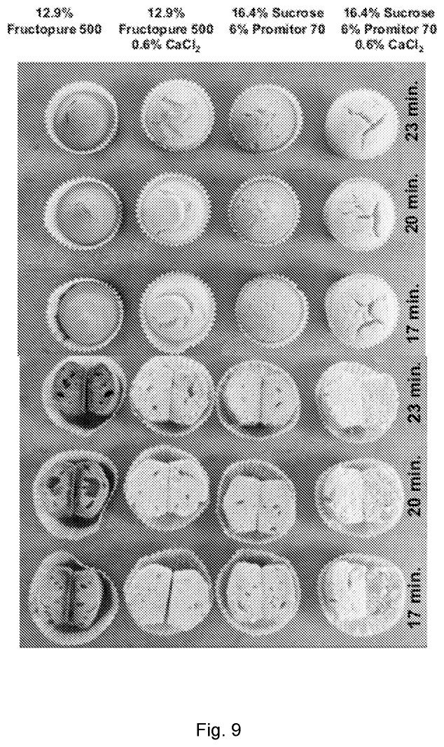

The muffins were analysed to determine their colour in a manner analogous to Examples 0 to 6. The colour of the surface and the inside of the muffins was analysed. The results are shown in Table 10. Photographs of the muffins are shown in FIG. 9.

TABLE 10

| | | CEX | EX | CEX | EX | | CEX | EX | CEX | EX |
|---|---|---|---|---|---|---|---|---|---|---|
| | surface | 7-1 | 7-1 | 7-2 | 7-2 | inside | 7-1 | 7-1 | 7-2 | 7-2 |
| 23 min | L* | 41.4 | 57.3 | 43.6 | 61 | L* | 32.8 | 56.6 | 52.8 | 62.2 |
| | a* | 9.7 | 4.8 | 8.9 | 1.1 | a* | 6.6 | 0.6 | 3.18 | −0.3 |
| | b* | 19.9 | 24.4 | 20.9 | 24.1 | b* | 14.6 | 13.5 | 22.6 | 20 |
| 20 min | L* | 44.5 | 62.5 | 46 | 61.6 | L* | 40.4 | 60.3 | 52.8 | 62.5 |
| | a* | 10.4 | 0.9 | 4.8 | 0.5 | a* | 3.5 | −0.8 | 2.2 | −0.7 |
| | b* | 21.8 | 23.3 | 21.2 | 23.4 | b* | 15.6 | 20.3 | 23.1 | 19.4 |
| 17 min | L* | 52.7 | 64.1 | 49.4 | 61.9 | L* | 42 | 61.4 | 53.9 | 62.6 |
| | a* | 7.5 | 0.2 | 2.3 | −0.2 | a* | 1.9 | −0.9 | 1.1 | −1.1 |
| | b* | 25.3 | 24.3 | 21.6 | 21.2 | b* | 15.5 | 2.1 | 21.7 | 18.6 |

Examples 7-1 and 7-2 (calcium chloride) both showed a marked reduction in browning when compared with Comparative Examples 7-1 and 7-2 (no calcium chloride).

### Oat Milk

### Examples 8 to 10

These examples were conducted to determine how the inclusion of a divalent metal ion salt affected the browning, taste and texture properties of oat milk. Oat milks were prepared according to the ingredient list in Table 11. All quantities in Table 11 are quoted as percent by weight based on the total weight of the oat milk and other ingredients.

TABLE 11

| | | CEX | EX | EX | EX | CEX | EX | EX | EX | CEX | EX | EX | EX |
|---|---|---|---|---|---|---|---|---|---|---|---|---|---|
| | REF | 8-1 | 8-1 | 8-2 | 8-3 | 9-1 | 9-1 | 9-2 | 9-3 | 10-1 | 10-1 | 10-2 | 10-3 |
| Raw oat milk | 100 | 94 | 93.43 | 93.3 | 93.85 | 90 | 89.57 | 89.46 | 89.85 | 90 | 89.83 | 89.54 | 89.85 |
| Soluble corn fibre | | 6 | 6 | 6 | 6 | | | | | | | | |
| Buffer | | | 0.4 | 0.24 | | | 0.26 | 0.08 | | | | | |
| Fructose | | | | | | 10 | 10 | 10 | 10 | | | | |
| Allulose | | | | | | | | | | 10 | 10 | 10 | 10 |
| Calcium chloride | | | 0.17 | | | | 0.17 | | | | 0.17 | | |
| Calcium lactate | | | | 0.46 | | | | 0.46 | | | | 0.46 | |
| Calcium phosphate | | | | | 0.15 | | | | 0.15 | | | | 0.15 |

The oat milks were made with a commercially available raw oat milk with a nutritional content of: 3% fat, 4% sucrose, 1% protein, dipotassium phosphate, calcium carbonate, potassium iodide, vitamins. Calcium salts are available commercially. Allulose was provided as Dolcia Prima® Crystalline Allulose available from Tate & Lyle. Fructose was provided as Krystar® Crystalline Fructose available from Tate & Lyle. Soluble corn fibre was provided as Promitor® Soluble Fibre 70 available from Tate & Lyle.

### Example 8

Comparative Example 8-1 and Examples 8-1 to 8-3 were prepared by mixing the raw oat milk, soluble corn fibre, allulose, fructose, buffer and/or calcium salt in a 200 g can with 5-10% air space in the proportions shown in Table 11.

The oat milks were analysed to determine their colour in a manner analogous to Examples 0 to 7.

The oat milks were subjected to ultra-high temperature (UHT) treatment in their cans in an autoclave at 121° C. for 20 min with rotation. The UHT oat milks were analysed to determine their colour in a manner analogous to Examples 0 to 7.

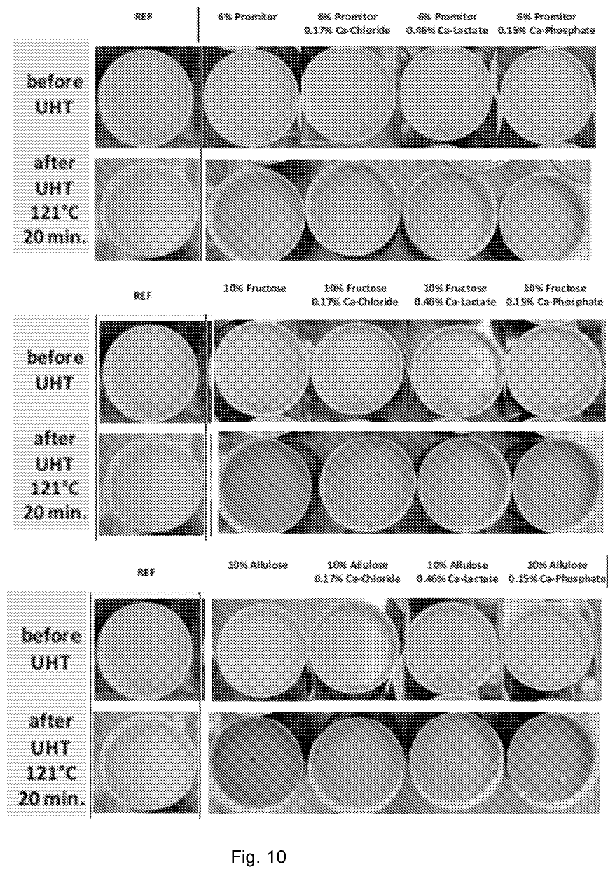

The results are shown in Table 12. Photographs of the oat milks before and after UHT are shown in FIG. 10.

TABLE 12

| | | | CEX | EX | EX | EX | CEX | EX | EX | EX | CEX | EX | EX | EX |
|---|---|---|---|---|---|---|---|---|---|---|---|---|---|---|
| | | REF | 8-1 | 8-1 | 8-2 | 8-3 | 9-1 | 9-1 | 9-2 | 9-3 | 10-1 | 10-1 | 10-2 | 10-3 |
| Before | | | | | | | | | | | | | | |
| UHT | pH | 7.50 | 7.46 | 6.82 | 6.80 | 7.49 | 7.43 | 6.81 | 6.79 | 7.42 | 7.45 | 6.87 | 6.90 | 7.44 |
| | L* | 68.7 | 67.2 | 67.8 | 67.7 | 67.3 | 66.2 | 66.4 | 66.0 | 65.9 | 66.0 | 65.9 | 65.0 | 65.0 |
| | a* | −1.2 | −1.4 | −1.4 | −1.4 | −1.3 | −1.4 | −1.4 | −1.5 | −1.5 | −1.5 | −1.5 | −1.7 | −1.6 |
| | b* | 10.3 | 10.3 | 10.4 | 10.3 | 10.3 | 10.0 | 10.1 | 10.0 | 10.0 | 10.0 | 10.3 | 9.7 | 9.7 |
| After | | | | | | | | | | | | | | |
| UHT | pH | 6.34 | 6.31 | 6.47 | 6.70 | 6.50 | 5.83 | 6.06 | 6.20 | 6.00 | 5.80 | 6.10 | 6.16 | 5.97 |
| | L* | 55.6 | 52.2 | 55.1 | 57.0 | 54.7 | 49.7 | 53.0 | 55.2 | 52.3 | 48.2 | 54.2 | 55.1 | 50.2 |
| | a* | 3.7 | 3.7 | 3.8 | 3.7 | 3.7 | 4.1 | 3.9 | 3.8 | 4.0 | 4.3 | 3.7 | 3.7 | 4.2 |
| | b* | 14.7 | 14.8 | 15.5 | 15.4 | 15.5 | 18.1 | 18.5 | 17.9 | 18.8 | 19.5 | 18.9 | 19.1 | 20.3 |

The inclusion of a calcium salt in the raw oat milk resulted in a marked decrease in browning upon UHT treatment. Despite the addition of 6% soluble corn fibre or 10% fructose or 10% allulose (all reducing saccharides) and the presence of protein, all samples using calcium salts demonstrated improved in colour retention and reduced browning, compared with the comparative examples which did not incorporate an additional divalent metal ion salt. The best performance was found using calcium lactate followed by calcium chloride and calcium phosphate.

### Cakes

### Example 11

These examples were conducted to determine how the inclusion of a divalent metal ion salt affected the browning properties and acrylamide formation of muffins. Muffins according to Examples 11-1 to 11-4 and Comparative Examples 11-1 to 11-5 were prepared according to the ingredient list in Table 13. Quantities for the muffins in Table 13 are quoted as percent by weight based on the total weight of the cake batter.

TABLE 13

| | CEX | CEX | EX | CEX | EX | CEX | EX | CEX | EX | CEX | CEX |
|---|---|---|---|---|---|---|---|---|---|---|---|
| | 11-1 | 11-2 | 11-1 | 11-3 | 11-2 | 11-4 | 11-3 | 11-5 | 11-4 | 11-6 | 11-7 |
| Sucrose | 23.4 | 16.4 | 16.4 | | | 16.4 | 16.4 | 16.4 | 16.4 | 26 | 28 |
| Allulose | 7.9 | 7.9 | 7.9 | | | | | | | | |
| Fructose | | | | 12.9 | 12.9 | | | | | | |
| Soluble corn fibre | | | | | | 6 | 6 | | | | |
| Calcium lactate | | | 1.7 | | 1.7 | | 1.7 | | 1.7 | | |
| Polydextrose | | | | | | | | 6 | 6 | | |

The muffins were made with commercially available sucrose and calcium lactate. Allulose was provided as Dolcia Prima® Allulose Syrup available from Tate & Lyle. Fructose was provided as Krystar® Crystalline Fructose available from Tate & Lyle. Soluble corn fibre was provided as Promitor® Soluble Fibre 70 available from Tate & Lyle. Polydextrose was provided as STA-LITER 90R available from Tate & Lyle. The balance of the muffin batter was made up with commercially available, low protein (T45) wheat flour, rapeseed oil, whole egg liquid, water and baking powder.

Examples 11-1 to 11-4 and Comparative Examples 11-1 to 11-5 were prepared by assembling the ingredients listed in Table 13 and processing them in a Kitchen Aid at speed 4 for 4 minutes. The resulting batter was poured into muffin molds and cooked in a preheated, top and bottom heated oven at 160° C. for 17 minutes. Comparative Examples 11-6 and 11-7 are shop-bought market samples.

The muffins were analysed to determine their colour in a manner analogous to Examples 0 to 7.

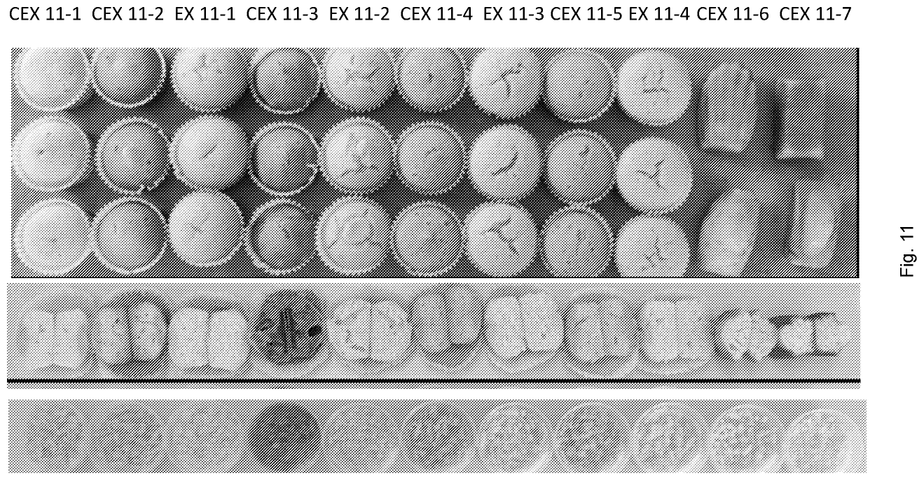

The colour of the surface and the inside of the muffins was analysed. The results are shown in Table 14. Photographs of the muffins are shown in FIG. 11.

The muffins were analysed to determine their acrylamide content. The results are shown in Table 14.

TABLE 14

| | CEX | CEX | EX | CEX | EX | CEX | EX | CEX | EX | CEX | CEX |
|---|---|---|---|---|---|---|---|---|---|---|---|
| | 11-1 | 11-2 | 11-1 | 11-3 | 11-2 | 11-4 | 11-3 | 11-5 | 11-4 | 11-6 | 11-7 |
| surface | | | | | | | | | | | |
| L* | 62.4 | 48.9 | 62.4 | 45.4 | 64.3 | 54.4 | 61.9 | 54.8 | 61.0 | 59.1 | 48.6 |
| a* | −0.6 | 11.3 | 0.2 | 7.7 | 0.6 | 4.3 | 0.9 | 3.6 | 0.6 | 2.2 | 11.7 |
| b* | 21.8 | 25.5 | 22.5 | 21.0 | 22.8 | 24.0 | 22.6 | 23.6 | 22.0 | 35.0 | 24.2 |
| inside | | | | | | | | | | | |
| L* | 64.0 | 51.9 | 65.4 | 27.4 | 64.5 | 57.1 | 64.4 | 61.4 | 66.2 | 57.5 | 59.1 |
| a* | −1.7 | 4.7 | −1.8 | 5.6 | −1.8 | 1.1 | −1.5 | −0.5 | −1.8 | −0.7 | −4.1 |
| b* | 19.8 | 21.9 | 19.8 | 10.6 | 19.6 | 21.8 | 19.7 | 22.0 | 19.8 | 17.3 | 21.0 |
| Acrylamide | <5 | 11 | <5 | 24 | 8.7 | <5 | <5 | <5 | <5 | <5 | 8.7 |
| content/μg/kg | | | | | | | | | | | |

Example 11-1 and Example 11-2 (calcium lactate) showed a marked reduction in browning and acrylamide content compared with Comparative Example 11-2 and Comparative Example 11-3 (no calcium lactate). The addition of calcium lactate reduced acrylamide levels by 54% when the muffin contained sucrose and allulose and by 64% when the muffin contained fructose. 5 to 8.7 μg/kg is a typical acceptable level of acrylamide for muffins.

### Example 12

These examples were conducted to determine how the ratio of the divalent metal ion salt to the reducing saccharide affected the browning properties of muffins. Muffins according to Examples 12-1 to 12-15 and Comparative Examples 12-1 to 12-15 were prepared according to the ingredient list in Table 15. Quantities for the muffins in Table 15 are quoted as parts by weight based on the total weight of the cake batter.

TABLE 15

| | CEX- | EX- | CEX | EX | CEX | EX | CEX | EX | CEX | EX | CEX | EX |
|---|---|---|---|---|---|---|---|---|---|---|---|---|
| Ingredients | 12-1 | 12-1 | 12-2 | 12-2 | 12-3 | 12-3 | 12-4 | 12-4 | 12-5 | 12-5 | 12-6 | 12-6 |
| Wheat flour 405 | 24.4 | 24.4 | 24.4 | 24.4 | 24.4 | 24.4 | 24.4 | 24.4 | 24.4 | 24.4 | 24.4 | 24.4 |
| Cake flour | | | | | | | | | | | | |
| Sucrose | 16.4 | 16.4 | 20.0 | 20.0 | 14.0 | 14.0 | | | | | | |
| Baking powder | 0.5 | 0.5 | 0.5 | 0.5 | 0.5 | 0.5 | 0.5 | 0.5 | 0.5 | 0.5 | 0.5 | 0.5 |
| Crystalline allulose | 7.9 | 7.9 | 4.0 | 4.0 | 10.0 | 10.0 | | | | | | |
| Fructose | | | | | | | 12.9 | 12.9 | 15.7 | 15.7 | 11.0 | 11.0 |
| Calcium lactate | | 1.7 | | 8.5 | | 2.3 | | 1.7 | | 2.1 | | 1.4 |
| Whole egg liquid | 16.0 | 16.0 | 16.0 | 16.0 | 16.0 | 16.0 | 16.0 | 16.0 | 16.0 | 16.0 | 16.0 | 16.0 |
| Rapeseed oil | 15.1 | 15.1 | 15.1 | 15.1 | 15.1 | 15.1 | 15.1 | 15.1 | 15.1 | 15.1 | 15.1 | 15.1 |
| Water | 17.3 | 17.3 | 17.3 | 17.3 | 17.3 | 17.3 | 17.3 | 17.3 | 17.3 | 17.3 | 17.3 | 17.3 |
| Total | 97.6 | 99.3 | 97.3 | 105.8 | 97.3 | 99.6 | 86.2 | 87.9 | 89.0 | 91.1 | 84.3 | 85.7 |
| pH | 7.6 | 7.6 | 7.7 | 7.7 | 7.7 | 7.7 | 7.76 | 7.75 | 7.77 | 7.77 | 7.78 | 7.78 |

| | CEX | EX | CEX | EX | CEX | EX | CEX | EX | CEX | EX | CEX | EX |
|---|---|---|---|---|---|---|---|---|---|---|---|---|
| Ingredients | 12-7 | 12-7 | 12-8 | 12-8 | 12-9 | 12-9 | 12-10 | 12-10 | 12-11 | 12-11 | 12-12 | 12-12 |
| Wheat flour 405 | 24.4 | 24.4 | 24.4 | 24.4 | 24.4 | 24.4 | | | | | | |
| Cake flour | | | | | | | 24.4 | 24.4 | 24.4 | 24.4 | 24.4 | 24.4 |
| Sucrose | 16.4 | 16.4 | 20.0 | 20.0 | 14.0 | 14.0 | 16.4 | 16.4 | 20.0 | 20.0 | 14.0 | 14.0 |
| Baking powder | 0.5 | 0.5 | 0.5 | 0.5 | 0.5 | 0.5 | 0.5 | 0.5 | 0.5 | 0.5 | 0.5 | 0.5 |
| SCF | 6.0 | 6.0 | 3.0 | 3.0 | 8.0 | 8.0 | 6.0 | 6.0 | 3.0 | 3.0 | 8.0 | 8.0 |
| Calcium lactate | | 1.7 | | 0.9 | | 2.3 | | 1.7 | | 0.9 | | 2.3 |
| Whole egg liquid | 16.0 | 16.0 | 16.0 | 16.0 | 16.0 | 16.0 | 16.0 | 16.0 | 16.0 | 16.0 | 16.0 | 16.0 |
| Rapeseed oil | 15.1 | 15.1 | 15.1 | 15.1 | 15.1 | 15.1 | 15.1 | 15.1 | 15.1 | 15.1 | 15.1 | 15.1 |
| Water | 17.3 | 17.3 | 17.3 | 17.3 | 17.3 | 17.3 | 17.3 | 17.3 | 17.3 | 17.3 | 17.3 | 17.3 |
| Total | 95.7 | 97.4 | 96.3 | 97.2 | 95.3 | 97.6 | 95.7 | 97.4 | 96.3 | 97.2 | 95.3 | 97.6 |
| pH | 7.77 | 7.78 | 7.78 | 7.79 | 7.8 | 7.8 | 7.78 | 7.78 | 7.75 | 7.73 | 7.73 | 7.69 |

| | CEX | EX | CEX | EX | CEX | EX | CEX | EX | EX |
|---|---|---|---|---|---|---|---|---|---|
| Ingredients | 12-13 | 12-13 | 12-14 | 12-14 | 12-15 | 12-15 | 13-1 | 13-1 | 13-2 |
| Wheat flour 405 | 24.4 | 24.4 | 24.4 | 24.4 | 24.4 | 24.4 | 24.4 | 24.4 | 24.4 |
| Cake flour | | | | | | | | | |
| Sucrose | 16.4 | 16.4 | 20.0 | 20.0 | 14.0 | 14.0 | 16.4 | 16.4 | 16.4 |
| Baking powder | 0.5 | 0.5 | 0.5 | 0.5 | 0.5 | 0.5 | 0.5 | 0.5 | 0.5 |
| SCF | | | | | | | 6.0 | 6.0 | 6.0 |
| PDX | 6.0 | 6.0 | 3.0 | 3.0 | 8.0 | 8.0 | | | |
| Calcium lactate | | 1.7 | | 0.9 | | 2.3 | | 1.7 | 1.7 |
| Whole egg liquid | 16.0 | 16.0 | 16.0 | 16.0 | 16.0 | 16.0 | 16.0 | 16.0 | 16.0 |
| Sunflower lecithin | | | | | | | | | 0.075 |
| Rapeseed oil | 15.1 | 15.1 | 15.1 | 15.1 | 15.1 | 15.1 | 15.1 | 15.1 | 15.1 |
| Water | 17.3 | 17.3 | 17.3 | 17.3 | 17.3 | 17.3 | 17.3 | 17.3 | 17.3 |
| Total | 95.7 | 97.4 | 96.3 | 97.2 | 95.3 | 97.6 | 95.7 | 97.4 | 97.5 |
| pH | 7.67 | 7.64 | 7.63 | 7.62 | 7.65 | 7.62 | | | |

The muffins were made with commercially available sucrose and calcium lactate. Allulose was provided as Dolcia Prima® Crystalline Allulose available from Tate & Lyle. Fructose was provided as Krystar® Crystalline Fructose available from Tate & Lyle. Soluble corn fibre was provided as Promitor® Soluble Fibre 70 available from Tate & Lyle. Polydextrose was provided as STA-LITER 90R available from Tate & Lyle.

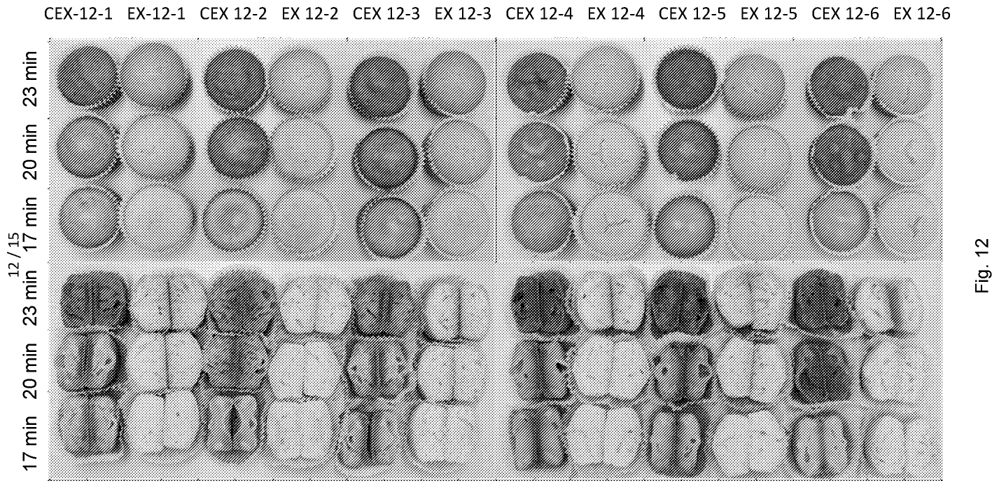

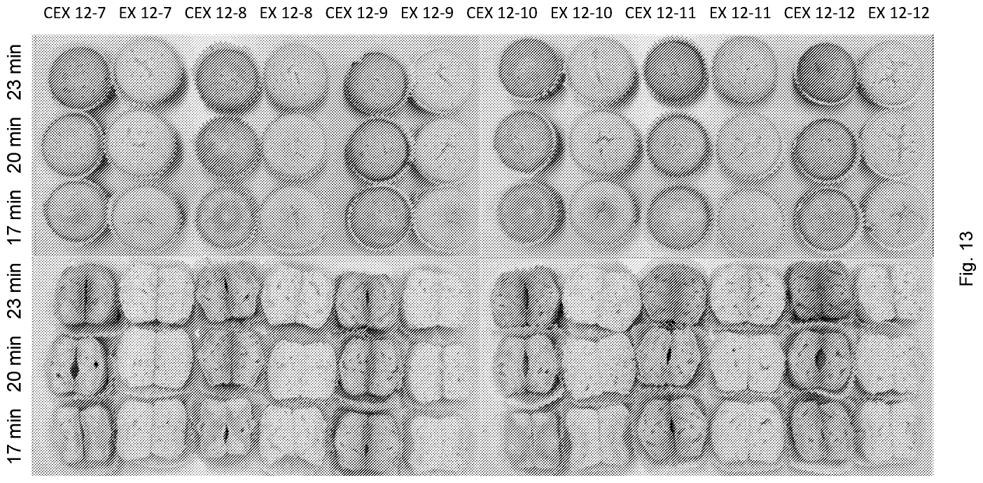

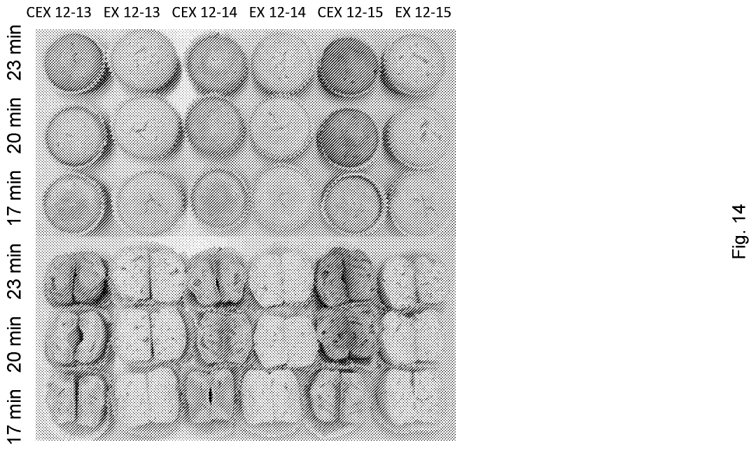

Examples 12-1 to 12-15 and Comparative Examples 12-1 to 12-15 were prepared by assembling the ingredients listed in Table 15 and processing them in a Kitchen Aid at speed 4 for 4 minutes. 52 g of the resulting batter was poured into muffin molds and cooked in a preheated, top and bottom heated oven at 160° C. for between 17, 20 or 23 minutes. Photographs of the muffins of Examples 12-1 to 12-6 and Comparative Examples 12-1 to 12-6 are shown in FIG. 12. Photographs of the muffins of Examples 12-7 to 12-12 and Comparative Examples 12-7 to 12-12 are shown in FIG. 13. Photographs of the muffins of Examples 12-13 to 12-15 and Comparative Examples 12-13 to 12-15 are shown in FIG. 14 . . . .

Examples 12-1 to 12-15 (calcium lactate) had a lighter colour and more even bake than Comparative Examples 12-1 to 12-15 (no calcium lactate) at all levels of sugar reduction.

### Example 13—Loaf Cakes

These examples were conducted to investigate whether the advantageous effects of the divalent metal ion salt were exhibited in larger batch sizes. Loaf cakes according to Examples 13-1, 13-2 and Comparative Example 13-1 were prepared according to the ingredient list in Table 15. Quantities for the muffins in Table 15 are quoted as parts by weight based on the total weight of the cake batter.

The loaf cakes were made with commercially available sunflower lecithin, sucrose and calcium lactate. Soluble corn fibre was provided as Promitor® Soluble Fibre 70 available from Tate & Lyle.

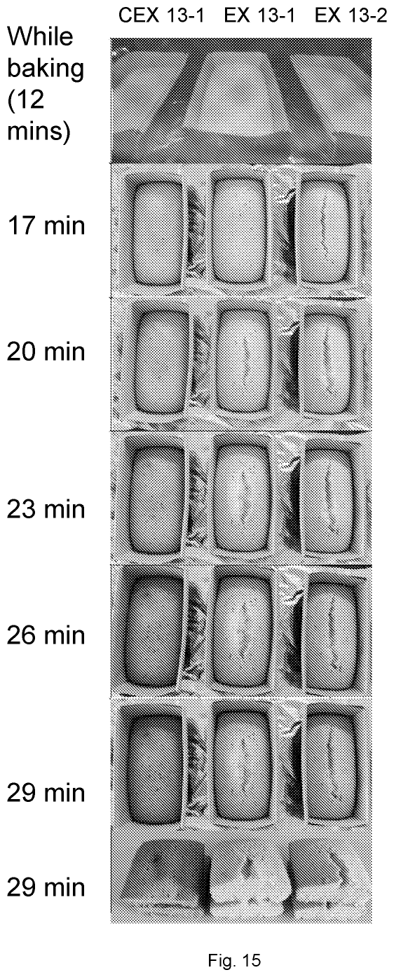

Examples 13-1, 13-2 and Comparative Example 13-1 were prepared by assembling the ingredients listed in Table 15 and processing them in a Kitchen Aid at speed 4 for 4 minutes. 182 g of the resulting batter was poured into a loaf tin and cooked in a preheated, top and bottom heated oven at 160° C. for between 17, 20, 23, 26 or 29 minutes. Photographs of the muffins of Examples 13-1, 13-2 and Comparative Example 13-1 are shown in FIG. 15.

Examples 13-1 and 13-2 (calcium lactate) had a lighter colour and better rise than Comparative Example 13-1 (no calcium lactate).

### EMBODIMENTS

Embodiment 1. A sweetener composition comprising a divalent metal ion salt and a reducing saccharide.

Embodiment 2. A sweetener composition according to embodiment 1, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

Embodiment 3. A sweetener composition according to embodiment 1, wherein the reducing saccharide is allulose, fructose or soluble corn fibre.

Embodiment 4. A sweetener composition according to embodiment 3, wherein the reducing saccharide is allulose.

Embodiment 5. A sweetener composition according to embodiment 3, wherein the reducing saccharide is fructose.

Embodiment 6. A sweetener composition according to embodiment 3, wherein the reducing saccharide is soluble corn fibre.

Embodiment 7. A sweetener composition according to any of embodiments 1 to 6, wherein the divalent metal ion salt is an alkaline earth metal salt.

Embodiment 8. A sweetener composition according to embodiment 7, wherein the divalent metal ion salt is an alkaline earth metal salt.

Embodiment 9. A sweetener composition according to embodiment 8, wherein the divalent metal ion salt is a calcium salt or a magnesium salt.

Embodiment 10. A sweetener composition according to embodiment 9, wherein the divalent metal ion salt is a calcium salt.

Embodiment 11. A sweetener composition according to embodiment 10, wherein the calcium salt is any selected from the group consisting of calcium lactate, calcium carbonate, calcium citrate, calcium chloride, calcium phosphate, calcium sulfate, and any combination thereof.

Embodiment 12. A sweetener composition according to embodiment 11, wherein the calcium salt is any selected from the group consisting of calcium lactate, calcium carbonate, calcium chloride, calcium phosphate, calcium sulfate, and any combination thereof.

Embodiment 13. A sweetener composition according to embodiment 12, wherein the calcium salt is any selected from the group consisting of calcium lactate, calcium chloride, calcium sulfate, and any combination thereof.

Embodiment 14. A sweetener composition according to embodiment 13, wherein the calcium salt is calcium lactate.

Embodiment 15. A sweetener composition according to embodiment 13, wherein the calcium salt is calcium chloride.

Embodiment 16. A sweetener composition according to embodiment 13, wherein the calcium salt is calcium sulfate.

Embodiment 17. A sweetener composition according to any of embodiments 1 to 16, wherein the sweetener composition comprises a non-reducing saccharide.

Embodiment 18. A sweetener composition according to embodiment 17, wherein the non-reducing saccharide is sucrose.

Embodiment 19. A sweetener composition according to any of embodiments 1 to 18, wherein the sweetener composition is a dry sweetener composition.

Embodiment 20. A sweetener composition according to embodiment 19, wherein the dry sweetener composition is in granulated form, crystalline form, powder form or tablet form.

Embodiment 21. A sweetener composition according to embodiment 19 or embodiment 20, wherein the dry sweetener composition comprises the reducing saccharide in an amount of from about 1% by weight to about 99% by weight based on the total weight of the sweetener composition.

Embodiment 22. A sweetener composition according to embodiment 22, wherein the dry sweetener composition comprises the reducing saccharide in an amount of from about 5% by weight to about 99% by weight based on the total weight of the sweetener composition.

Embodiment 23. A sweetener composition according to embodiment 19 or embodiment 20, wherein the dry sweetener composition comprises the reducing saccharide in an amount of from about 70% by weight to about 95% by weight based on the total weight of the sweetener composition.

Embodiment 24. A sweetener composition according to any of embodiments 19 to 23, wherein the dry sweetener composition comprises a non-reducing saccharide in an amount of from about 1% by weight to about 99% by weight based on the total weight of the sweetener composition.

Embodiment 25. A sweetener composition according to embodiment 24, wherein the dry sweetener composition comprises the non-reducing saccharide in an amount of from about 5% by weight to about 99% by weight based on the total weight of the sweetener composition.

Embodiment 26. A sweetener composition according to embodiment 25, wherein the dry sweetener composition comprises the non-reducing saccharide in an amount of from about 70% by weight to about 95% by weight based on the total weight of the sweetener composition.

Embodiment 27. A sweetener composition according to embodiment 24, wherein the dry sweetener composition comprises allulose comprises the reducing saccharide and the non-reducing saccharide in a combined amount of from about of 1% by weight to about 99% by weight based on the total weight of the sweetener composition.

Embodiment 28. A sweetener composition according to embodiment 27, wherein the dry sweetener composition comprises the reducing saccharide and the non-reducing saccharide in a combined amount of from about 5% by weight to about 99% by weight based on the total weight of the sweetener composition.

Embodiment 29. A sweetener composition according to embodiment 28, wherein the dry sweetener composition comprises the reducing saccharide and the non-reducing saccharide in a combined amount of from about 70% by weight to about 95% by weight based on the total weight of the sweetener composition.

Embodiment 30. A sweetener composition according to any of embodiments 27 to 29, wherein the sweetener composition comprises the reducing saccharide in an amount of about 10% to about 20% by weight based on the total weight of the sweetener composition and the non-reducing saccharide in a combined amount of from about 80% by weight to about 90% by weight based on the total weight of the sweetener composition.

Embodiment 31. A sweetener composition according to any of embodiments 27 to 29, wherein the sweetener composition comprises the reducing saccharide in an amount of about 80% to about 90% by weight based on the total weight of the sweetener composition and the non-reducing saccharide in a combined amount of from about 10% by weight to about 20% by weight based on the total weight of the sweetener composition.

Embodiment 32. A sweetener composition according to any of embodiments 27 to 29, wherein the sweetener composition comprises the reducing saccharide in an amount of about 40% to about 60% by weight based on the total weight of the sweetener composition and the non-reducing saccharide in a combined amount of from about 40% by weight to about 60% by weight based on the total weight of the sweetener composition.

Embodiment 33. A sweetener composition according to any of embodiments 19 to 32, wherein the dry sweetener composition comprises the divalent metal ion salt in an amount of from about 1% by weight to about 20% by weight based on the total weight of the sweetener composition.

Embodiment 34. A sweetener composition according to embodiment 33, wherein the dry sweetener composition comprises the divalent metal ion salt in an amount of from about 2% by weight to about 15% by weight based on the total weight of the sweetener composition.

Embodiment 35. A sweetener composition according to any of embodiments 10 to 34, wherein the sweetener composition comprises at least one high intensity sweetener.

Embodiment 36. A sweetener composition according to embodiment 35, wherein the at least one high intensity sweetener of the sweetener composition is selected from the group consisting of stevia extracts, monk fruit extracts, a combination of stevia and monk fruit extracts, and sucralose.

Embodiment 37. A sweetener composition according to embodiment 36, wherein the sweetener composition comprises a stevia extract.

Embodiment 38. A sweetener composition according to embodiment 37, wherein the stevia extract comprises at least one steviol glycoside.

Embodiment 39. A sweetener composition according to embodiment 37 or 38, wherein the sweetener composition comprises the reducing saccharide in an amount of from about 50% to about 99% by weight relative to the total weight of the sweetener composition, stevia extract in an amount of from about 0.10% to about 0.20% by weight relative to the total weight of the sweetener composition; monk fruit extract in an amount of from about 0.02% to about 0.09% by weight relative to the total weight of the sweetener composition, and the divalent metal ion salt in an amount of from about 0.1% to about 10% by weight relative to the total weight of the sweetener composition.

Embodiment 40. A sweetener composition according to any of embodiments 1 to 18, wherein the sweetener composition is a syrup.

Embodiment 41. A sweetener composition according to embodiment 40, wherein the syrup has a total dry solids content of from about 50% by weight to about 85% by weight.

Embodiment 42. A sweetener composition according to embodiment 41, wherein the total dry solids content of the syrup is from 70% to 80%.

Embodiment 43. A sweetener composition according to embodiment 42, wherein the total dry solids content of the syrup is from 71% to 80%.

Embodiment 44. A sweetener composition according to embodiment 43, wherein the total dry solids content of the syrup is from 70% to 78%.

Embodiment 45. A sweetener composition according to embodiment 44, wherein the total dry solids content of the syrup is from 71% to 78%.

Embodiment 46. A sweetener composition according to any of embodiments 40 or embodiment 45, wherein the syrup has a saccharide content (combined reducing saccharide and optional non-reducing saccharide) of from about 80% by weight to about 99% by weight on a dry solids basis.

Embodiment 47. A sweetener composition according to any of embodiments 40 to 46, wherein the syrup has a reducing saccharide content of from about 5% by weight to about 99% by weight on a dry solids basis.

Embodiment 48. A sweetener composition according to any of embodiments 40 to 47, wherein the syrup has a non-reducing saccharide content of from about 5% by weight to about 99% by weight on a dry solids basis.

Embodiment 49. A sweetener composition according to any of embodiments 40 to 48, wherein the syrup has a divalent metal ion salt content of from about 1% by weight to about 20% by weight on a dry solids basis.

Embodiment 49. A sweetener composition according to embodiment 49, wherein the syrup has a divalent metal ion salt content of from about 5% by weight to about 15% by weight on a dry solids basis.

Embodiment 50. A sweetener composition according to any preceding embodiment, wherein the sweetener composition is less prone to browning when heated in the presence of an amine than the same sweetener composition in which the divalent metal ion salt is replaced with a corresponding potassium salt in a stoichiometric amount based on the metal ion content.

Embodiment 51. Use of a divalent metal ion salt for the reduction of browning in a food product and/or for the reduction of acrylamide formation in a food product comprising a reducing saccharide during heating in the presence of an amine-containing additional food ingredient.

Embodiment 52. Use according to embodiment 51, wherein the divalent metal ion salt is as defined in any of embodiments 7 to 16.

Embodiment 53. Use according to embodiment 51 or 52, wherein the divalent metal ion salt is used in a sweetener composition according to any of embodiment 1 to 51.

Embodiment 54. A method for reducing browning in a food product and/or for reducing acrylamide formation in a food product, wherein the method comprises:
a) combining a reducing saccharide with a divalent metal salt and at least one amine-containing additional food ingredient to provide an unheated food product; and
b) optionally heating the unheated food product to provide a heated food product.

Embodiment 55. A method according to embodiment 54, wherein the unheated food product is a precursor to a heated food product.

Embodiment 56. A method according to embodiment 55, wherein the food product is a dough or batter.

Embodiment 57. A method according to embodiment 56, wherein the food product is a dough or batter for making for making rolls, cakes, pies, pastries, or biscuits.

Embodiment 58. A method according to embodiment 56 or 57, wherein the dough or batter comprises the reducing saccharide in an amount of from about 1% by weight to about 45% by weight relative to the dough or batter.

Embodiment 59. A method according to embodiment 58, wherein the dough or batter comprises the reducing saccharide in an amount of from about 5% by weight to about 35% by weight relative to the dough or batter.

Embodiment 60. A method according to any of embodiments 54 to 59, wherein the amine-containing additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

Embodiment 60. A method according to any embodiment 61, wherein the amine-containing additional food ingredient is an egg product (e.g. liquid whole egg, liquid egg whites, dried whole egg, dried egg white, a dairy product (e.g. milk, butter, cheese, yoghurt), vegetable solids (e.g. wheat flour, oat flour), or any combination thereof.

Embodiment 61. A method according to any of embodiments 54 to 60, wherein the amine is a protein, an amino acid, or a combination thereof.

Embodiment 62. A method according to any of embodiments 54 to 61, wherein step a) comprises combining a non-reducing saccharide, such as sucrose, with the reducing saccharide, divalent metal ion salt and amine-containing additional food ingredient to provide an unheated food product.

Embodiment 63. A method according to any of embodiments 54 to 62, wherein the saccharide content of the unheated food product is from about 1% by weight to about 80% by weight relative to the total weight of the unheated food product.

Embodiment 64. A method according to embodiment 63, wherein the saccharide content of the unheated food product is from about 5% by weight to about 30% by weight relative to the total weight of the unheated food product.

Embodiment 65. A method according to embodiment 64, wherein the saccharide content of the unheated food product is from about 10% by weight to about 25% by weight relative to the total weight of the unheated food product.

Embodiment 66. A method according to any of embodiments 54 to 65, wherein a reducing saccharide content of the unheated food product is from about 1% by weight to about 80% by weight relative to the total weight of the unheated food product.

Embodiment 67. A method according to embodiment 66, wherein the reducing saccharide content of the unheated food product is from about 5% by weight to about 30% by weight relative to the total weight of the unheated food product.

Embodiment 68. A method according to embodiment 67, wherein the reducing saccharide content of the unheated food product is from about 10% by weight to about 25% by weight relative to the total weight of the unheated food product.

Embodiment 69. A method according to any of embodiments 62 to 68, wherein a non-reducing saccharide content of the unheated food product is from about 1% by weight to about 80% by weight relative to the total weight of the unheated food product.

Embodiment 70. A method according to embodiment 69, wherein the non-reducing saccharide content of the unheated food product is from about 5% by weight to about 30% by weight relative to the total weight of the unheated food product.

Embodiment 71. A method according to embodiment 70, wherein the non-reducing saccharide content of the unheated food product is from about 10% by weight to about 25% by weight relative to the total weight of the unheated food product.

Embodiment 72. A method according to any of embodiments 69 to 71, wherein the reducing saccharide content of the unheated food product is from about 5% to about 15% by weight relative to the total weight of the unheated food product and the non-reducing saccharide content of the unheated food product is from about 50% to about 15% by weight relative to the total weight of the unheated food product.

Embodiment 73. A method according to any of embodiments 54 to 72, wherein the divalent metal ion salt is provided in an amount sufficient to provide a free divalent metal ion content of from about 0.01% by weight to about 1% by weight relative to the total weight of the unheated food product.

Embodiment 74. A method according to embodiment 73, wherein the divalent metal ion salt is provided in an amount sufficient to provide a free divalent metal ion content of from about 0.1% by weight to about 0.3% by weight relative to the total weight of the unheated food product.

Embodiment 75. A method according to any of embodiments 54 to 74, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

Embodiment 76. A method according to embodiment 75, wherein the reducing saccharide is allulose, fructose or soluble corn fibre.

Embodiment 77. A method according to embodiment 76, wherein the reducing saccharide is allulose.

Embodiment 78. A method according to embodiment 77, wherein the reducing saccharide is fructose.

Embodiment 79. A method according to embodiment 77, wherein the reducing saccharide is soluble corn fibre.

Embodiment 80. A method according to any of embodiments 54 to 79, wherein the divalent metal ion salt is an alkaline earth metal salt.

Embodiment 81. A method according to embodiment 80, wherein the divalent metal ion salt is a calcium salt or a magnesium salt.

Embodiment 82. A method according to embodiment 81, wherein the divalent metal ion salt is a calcium salt.

Embodiment 83. A method according to embodiment 82, wherein the calcium salt is any selected from the group consisting of calcium lactate, calcium carbonate, calcium citrate, calcium chloride, calcium phosphate, calcium sulfate, and any combination thereof.

Embodiment 84. A method according to embodiment 83, wherein the calcium salt is any selected from the group consisting of calcium lactate, calcium carbonate, calcium chloride, calcium phosphate, calcium sulfate, and any combination thereof.

Embodiment 85. A method according to embodiment 84, wherein the calcium salt is any selected from the group consisting of calcium lactate, calcium chloride, calcium sulfate, and any combination thereof.

Embodiment 86. A method according to embodiment 85, wherein the calcium salt is calcium lactate.

Embodiment 87. A method according to embodiment 85, wherein the calcium salt is calcium chloride.

Embodiment 88. A method according to embodiment 85, wherein the calcium salt is calcium sulfate.

Embodiment 89. A method according to any of embodiments 54 to 88, wherein the unheated food product is less prone to browning when heated than the same food product in which the divalent metal ion salt is replaced with a corresponding potassium salt in a stoichiometric amount based on the metal ion content and/or the unheated food product is less prone to acrylamide formation when heated than the same food product in which the divalent metal ion salt is replaced with a corresponding potassium salt in a stoichiometric amount based on the metal ion content.

Embodiment 90. A method according to any of embodiments 54 to 89, wherein the heated food product is lighter in colour than the same food product in which the divalent metal ion salt is replaced with a potassium salt in a stoichiometric amount based on the metal ion content and/or the heated food product has a lower acrylamide content than the same food product in which the divalent metal ion salt is replaced with a potassium salt in a stoichiometric amount based on the metal ion content.

Embodiment 91. A food product comprising: a reducing saccharide, a divalent metal ion salt, and an amine-containing additional food ingredient.

Embodiment 92. A food product according to embodiment 36, wherein the additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

Embodiment 93. A food product according to embodiment 92, wherein the amine-containing additional food ingredient is an egg product (e.g. liquid whole egg, liquid egg whites, dried whole egg, dried egg white, a dairy product (e.g. milk, butter, cheese, yoghurt), vegetable solids (e.g. wheat flour, oat flour), or any combination thereof.

Embodiment 94. A food product according to any of embodiments 91 to 93, wherein the amine is a protein, an amino acid, or a combination thereof.

Embodiment 95. A food product according to any of embodiments 91 to 94, wherein the food product comprises a non-reducing saccharide.

Embodiment 96. A food product according to embodiment 95, wherein the non-reducing saccharide is sucrose.

Embodiment 97. A food product according to any of embodiments 91 to 96, wherein the food product has a saccharide content of from about 1% by weight to about 80% by weight relative to the total weight of the food product.

Embodiment 98. A food product according to embodiment 97, wherein the saccharide content of the food product is from about 5% by weight to about 30% by weight relative to the total weight of the unheated food product.

Embodiment 99. A food product according to embodiment 98, wherein the saccharide content of the food product is from about 10% by weight to about 25% by weight relative to the total weight of the unheated food product.

Embodiment 100. A food product according to any of embodiments 91 to 99, wherein a reducing saccharide content of the food product is from about 1% by weight to about 80% by weight relative to the total weight of the unheated food product.

Embodiment 101. A food product according to embodiment 100, wherein the reducing saccharide content of the food product is from about 5% by weight to about 30% by weight relative to the total weight of the unheated food product.

Embodiment 102. A food product according to embodiment 101, wherein the reducing saccharide content of the food product is from about 10% by weight to about 25% by weight relative to the total weight of the unheated food product.

Embodiment 103. A food product according to any of embodiments 95 to 102, wherein a non-reducing saccharide content of the food product is from about 1% by weight to about 80% by weight relative to the total weight of the unheated food product.

Embodiment 104. A food product according to embodiment 103, wherein the non-reducing saccharide content of the food product is from about 5% by weight to about 30% by weight relative to the total weight of the unheated food product.

Embodiment 105. A food product according to embodiment 104, wherein the non-reducing saccharide content of the food product is from about 10% by weight to about 25% by weight relative to the total weight of the unheated food product.

Embodiment 106. A food product according to any of embodiments 95 to 102, wherein the reducing saccharide content of the food product is from about 5% to about 15% by weight relative to the total weight of the unheated food product and the non-reducing saccharide content of the food product is from about 50% to about 15% by weight relative to the total weight of the unheated food product.

Embodiment 107. A food product according to any of embodiments 91 to 106, wherein the food product comprises the divalent metal ion salt in an amount sufficient to provide a free divalent metal ion content of from about 0.01% by weight to about 1% by weight relative to the total weight of the food product.

Embodiment 108. A food product according to embodiment 107, wherein the divalent metal ion salt is provided in an amount sufficient to provide a free divalent metal ion content of from about 0.1% by weight to about 0.3% by weight relative to the total weight of the unheated food product.

Embodiment 109. A food product according to any of embodiments 91 to 108, wherein the food product contains the divalent metal ion salt in an amount of from about 0.1% by weight to about 2.0% by weight relative to the total weight of the food product.

Embodiment 110. A food product according to embodiment 109, wherein the food product contains the divalent metal ion salt in an amount of from about 0.3% to about 0.7% by weight based on the total weight of the unheated food product.

Embodiment 111. A food product according to any of embodiments 91 to 110, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

Embodiment 112. A food product according to embodiment 111, wherein the reducing saccharide is allulose, fructose or soluble corn fibre.

Embodiment 113. A food product according to embodiment 112, wherein the reducing saccharide is allulose.

Embodiment 114. A food product according to embodiment 112, wherein the reducing saccharide is fructose.

Embodiment 115. A food product according to embodiment 112, wherein the reducing saccharide is soluble corn fibre.

Embodiment 116. A food product according to any of embodiments 91 to 115, wherein the divalent metal ion salt is an alkaline earth metal salt.

Embodiment 117. A food product according to embodiment 116, wherein the divalent metal ion salt is a calcium salt or a magnesium salt.

Embodiment 118. A food product according to embodiment 117, wherein the divalent metal ion salt is a calcium salt.

Embodiment 119. A food product according to embodiment 118, wherein the calcium salt is any selected from the group consisting of calcium lactate, calcium carbonate, calcium citrate, calcium chloride, calcium phosphate, calcium sulfate, and any combination thereof.

Embodiment 120. A food product according to embodiment 119, wherein the calcium salt is any selected from the group consisting of calcium lactate, calcium carbonate, calcium chloride, calcium phosphate, calcium sulfate, and any combination thereof.

Embodiment 121. A food product according to embodiment 120, wherein the calcium salt is any selected from the group consisting of calcium lactate, calcium chloride, calcium sulfate, and any combination thereof.

Embodiment 122. A food product according to embodiment 121, wherein the calcium salt is calcium lactate.

Embodiment 123. A food product according to embodiment 121, wherein the calcium salt is calcium chloride.

Embodiment 124. A food product according to embodiment 121, wherein the calcium salt is calcium sulfate.

Embodiment 125. A food product according to any of embodiments 91 to 124, wherein

the food product is a precursor to a heated food product.

Embodiment 126. A food product according to embodiment 125, wherein the food product is a sweet bakery product.

Embodiment 127. A sweet bakery product according to embodiment 126, wherein sweet bakery product comprises a reducing saccharide in an amount of from about 1% by weight to about 45% by weight relative to the total weight of the unheated sweet bakery product (e.g. the dough or the batter).

Embodiment 128. A sweet bakery product according to embodiment 127, wherein the sweet bakery product comprises a reducing saccharide in an amount of from about 5% by weight to about 35% by weight relative to the total weight of the unheated sweet bakery product.

Embodiment 129. A sweet bakery product according to any of embodiments 126 to 128, wherein the sweet bakery product comprises the divalent metal ion salt in an amount sufficient to provide a free divalent metal ion content of from about 0.1% by weight to about 0.5% by weight relative to the total weight of the unheated product.

Embodiment 130. A sweet bakery product according to any of embodiments 126 to 129, wherein the sweet bakery product comprises the divalent metal ion salt in an amount of from about 0.3% by weight to about 0.9% by weight relative to the total weight of the unheated product.

Embodiment 131. A sweet bakery product according to any of embodiments 126 to 130, wherein the sweet bakery product is a dough or batter.

Embodiment 132. A sweet bakery product according to embodiment 131, wherein the sweet bakery product is a biscuit dough or cake batter.

Embodiment 133. A sweet bakery product according to embodiment 132, wherein the biscuit dough or cake batter comprises a reducing saccharide and a non-reducing saccharide.

Embodiment 134. A sweet bakery product according to embodiment 133, wherein the biscuit dough or cake batter comprises the reducing saccharide in an amount of from about 25% to about 37% by weight based on the total weight of the biscuit dough.

Embodiment 135. A sweet bakery product according to embodiment 133 or 134, wherein the biscuit dough or cake batter comprises the non-reducing saccharide in an amount of from about 4% to about 10% by weight based on the total weight of the biscuit dough. Embodiment 136. A sweet bakery product according to embodiment 133, wherein the biscuit dough or cake batter comprises the reducing saccharide in an amount of from about 1% to about 10% by weight based on the total weight of the biscuit dough.

Embodiment 137. A sweet bakery product according to embodiment 133 or 136, wherein the biscuit dough or cake batter comprises the non-reducing saccharide in an amount of from about 7% to about 20% by weight based on the total weight of the biscuit dough.

Embodiment 138. A sweet bakery product according to any of embodiments 133 to 137, wherein the reducing saccharide is allulose, fructose or soluble corn dietary fibre.

Embodiment 139. A sweet bakery product according to any of embodiments 133 to 138, wherein the non-reducing saccharide is sucrose.

Embodiment 140. A sweet bakery product according to any of embodiments 133 to 139, wherein the sweet bakery product is a biscuit dough comprising allulose in an amount of from about 1% by weight to about 10% by weight, sucrose in an amount of from about 6% by weight to about 30% by weight, and a calcium salt in an amount of from about 0.1% by weight to about 2% by weight relative to the total weight of the uncooked biscuit dough.

Embodiment 141. A sweet bakery product according to any of embodiments 133 to 139, wherein the sweet bakery product is a cake batter comprising sucrose in an amount of from about 6% by weight to about 30% by weight, soluble dietary fibre in an amount of from about 1% by weight to about 10% by weight, and a calcium salt in an amount of from about 0.1% by weight to about 2% by weight, relative to the total weight of the uncooked cake batter

Embodiment 142. A sweet bakery product according to any of embodiments 133 to 139, wherein the sweet bakery product is a cake batter comprising sucrose in an amount of from about 6% by weight to about 30% by weight, allulose in an amount of from about 1% by weight to about 10% by weight, and a calcium salt in an amount of from about 0.1% by weight to about 2% by weight, relative to the total weight of the uncooked cake batter

Embodiment 143. A sweet bakery product according to any of embodiments 133 to 139, wherein the sweet bakery product is a cake batter comprising fructose in an amount of from about 1% by weight to about 15% by weight, and a calcium salt in an amount of from about 0.1% by weight to about 2% by weight, relative to the total weight of the uncooked cake batter

Embodiment 144. A sweet bakery product according to any of embodiments 126 to 143, wherein the sweet bakery product comprises allulose, fructose or soluble dietary fibre in an amount of from about 1% by weight to about 45% by weight relative to the total weight of the unheated product.

Embodiment 145. A sweet bakery product according to embodiment 144, wherein the sweet bakery product comprises allulose, fructose or soluble dietary fibre in an amount of from about 10% by weight to about 25% by weight relative to the total weight of the unheated product.

Embodiment 146. A food product according to any of embodiments 91 to 125, which is a pre-made baking mix for preparing a sweet bakery product,

Embodiment 147. A food product according to embodiment 146, wherein the pre-made baking mix comprises the reducing saccharide in an amount sufficient to provide from about 1% by weight to about 45% by weight of the reducing saccharide in the uncooked sweet bakery product.

Embodiment 148. A food product according to embodiment 146 or 147, wherein the pre-made baking mix comprises the divalent metal ion in an amount sufficient to provide from about 0.1% by weight to about 2% by weight of the divalent metal ion in the uncooked sweet bakery product.

Embodiment 149. A food product according to any of embodiments 91 to 148, wherein the food product is less prone to browning than the same food product in which the divalent metal ion salt is replaced with a corresponding potassium salt in a stoichiometric amount based on the free metal ion content and/or the food product is less prone to acrylamide formation than the same food product in which the divalent metal ion salt is replaced with a corresponding potassium salt in a stoichiometric amount based on the free metal ion content.

Embodiment 150. A food product according to any of embodiments 91 to 149, wherein the food product is a heated food product.

Embodiment 151. A food product according to embodiment 150, wherein the heated food product is a cake or biscuit.

Embodiment 152. A food product according to embodiment 150 or 151, wherein the food product is lighter in colour than the same food product in which the divalent metal ion salt is replaced with a corresponding potassium salt in a stoichiometric amount based on the free metal ion content and/or the food product has a lower acrylamide content than the same food product in which the divalent metal ion salt is replaced with a corresponding potassium salt in a stoichiometric amount based on the free metal ion content.

Embodiment 153. A food product according to any of embodiments 91 to 152, wherein the heated food product has an acrylamide content of 20 μg/kg, preferably 15 μg/kg, or more preferably 10 μg/kg or less, 9 μg/kg or less, 8 μg/kg or less, 7 μg/kg or less, 6 μg/kg or less or 5 μg/kg or less.

Embodiment 154. A food product according to any of embodiments 91 to 153, wherein the heated food product has an acrylamide content that is 90% or less of the acrylamide content of the same food product in which the divalent metal ion salt is replaced with a corresponding potassium salt in a stoichiometric amount based on the free metal ion content, preferably 85% or less, more preferably 80% or less, 75% or less, 70% or less, 65% or less, 60% or less, 55% or less 50% or less, 45% or less, 40% or less, 35% or less, 30% or less, or 25% or less. Embodiment 155. A method according to any of embodiments 54 to 90, wherein the heated food product has an acrylamide content of 20 μg/kg, preferably 15 μg/kg, or more preferably 10 μg/kg or less, 9 μg/kg or less, 8 μg/kg or less, 7 μg/kg or less, 6 μg/kg or less or 5 μg/kg or less. Embodiment 156. A method according to any of embodiments 54 to 90 or 155, wherein the heated food product has an acrylamide content that is 90% or less of the acrylamide content of the same food product in which the divalent metal ion salt is replaced with a corresponding potassium salt in a stoichiometric amount based on the free metal ion content, preferably 85% or less, more preferably 80% or less, 75% or less, 70% or less, 65% or less, 60% or less, 55% or less 50% or less, 45% or less, 40% or less, 35% or less, 30% or less, or 25% or less.

1. A sweetener composition comprising a divalent metal ion salt and a reducing saccharide.

2. A sweetener composition according to claim 1, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

3. A sweetener composition according to claim 1 or claim 2, wherein the divalent metal ion salt is an alkaline earth metal salt.

4. A sweetener composition according to any of the preceding claims, wherein the divalent metal ion salt is a calcium salt.

5. A sweetener composition according to claim 4, wherein the calcium salt is any selected from the group consisting of calcium lactate, calcium carbonate, calcium citrate, calcium chloride, calcium phosphate, calcium sulfate, and any combination thereof.

6. A sweetener composition according to any of claims 1 to 5, wherein the sweetener composition comprises a non-reducing saccharide, such as sucrose.

7. A sweetener composition according to any of claims 1 to 6, wherein the sweetener composition is a dry sweetener composition.

8. A sweetener composition according to claim 7, wherein the dry sweetener composition is in granulated form, crystalline form, powder form or tablet form.

9. A sweetener composition according to claim 7 or claim 8, wherein the dry sweetener composition comprises the reducing saccharide in an amount of from about 1% by weight to about 99% by weight based on the total weight of the sweetener composition.

10. A sweetener composition according to any of claims 7 to 9, wherein the dry sweetener composition comprises a non-reducing saccharide in an amount of from about 1% by weight to about 99% by weight based on the total weight of the sweetener composition.

11. A sweetener composition according to any of claims 5 to 8, wherein the dry sweetener composition comprises the divalent metal ion salt in an amount of from about 1% by weight to about 20% by weight based on the total weight of the sweetener composition.

12. A sweetener composition according to any of claims 1 to 6, wherein the sweetener composition is a syrup.

13. A sweetener composition according to claim 12, wherein the syrup has a total dry solids content of from about 50% by weight to about 85% by weight.

14. A sweetener composition according to claim 12 or claim 13, wherein the syrup has a saccharide content of from about 80% by weight to about 99% by weight on a dry solids basis.

15. A sweetener composition according to any of claims 12 to 14, wherein the syrup has a reducing saccharide content of from about 5% by weight to about 99% by weight on a dry solids basis.

16. A sweetener composition according to any of claims 12 to 15, wherein the syrup has a non-reducing saccharide content of from about 5% by weight to about 99% by weight on a dry solids basis.

17. A sweetener composition according to any of claims 12 to 16, wherein the syrup has a divalent metal ion salt content of from about 1% by weight to about 20% by weight on a dry solids basis.

18. A sweetener composition according to any preceding claim, wherein the sweetener composition is less prone to browning when heated in the presence of an amine than the same sweetener composition in which the divalent metal ion salt is replaced with a corresponding potassium salt in a stoichiometric amount based on the metal ion content.

19. A sweetener composition according to any preceding claim, wherein the sweetener composition is less prone to acrylamide formation when heated in the presence of an amine than the same sweetener composition in which the divalent metal ion salt is replaced with a corresponding potassium salt in a stoichiometric amount based on the metal ion content.

20. Use of a divalent metal ion salt for the reduction of browning in a food product comprising a reducing saccharide during heating in the presence of an amine-containing additional food ingredient.

21. Use of a divalent metal ion salt for the reduction of acrylamide formation in a food product comprising a reducing saccharide during heating in the presence of an amine-containing additional food ingredient.

22. A method for reducing browning in a food product, wherein the method comprises:
a) combining a reducing saccharide with a divalent metal salt and at least one amine-containing additional food ingredient to provide an unheated food product; and
b) optionally heating the unheated food product to provide a heated food product.

23. A method for reducing acrylamide formation in a food product, wherein the method comprises:
a) combining a reducing saccharide with a divalent metal salt and at least one amine-containing additional food ingredient to provide an unheated food product; and
b) optionally heating the unheated food product to provide a heated food product.

24. A method according to claim 22 or claim 23, wherein the unheated food product is a precursor to a heated food product, for example wherein the food product is a dough or batter.

25. A method according to any of claims 22 to 24, wherein the amine-containing additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

26. A method according to any of claims 22 to 25, wherein the amine is a protein, an amino acid, or a combination thereof.

27. A method according to any of claims 22 to 26, wherein step a) comprises combining a non-reducing saccharide, such as sucrose, with the reducing saccharide, divalent metal ion salt and amine-containing additional food ingredient to provide an unheated food product.

28. A method according to any of claims 22 to 27, wherein the saccharide content of the unheated food product is from about 1% by weight to about 80% by weight relative to the total weight of the unheated food product.

29. A method according to any of claims 22 to 28, wherein a reducing saccharide content of the unheated food product is from about 1% by weight to about 80% by weight relative to the total weight of the unheated food product.

30. A method according to any of claims 22 to 29, wherein a non-reducing saccharide content of the unheated food product is from about 1% by weight to about 80% by weight relative to the total weight of the unheated food product.

31. A method according to any of claims 22 to 30, wherein the divalent metal ion salt is provided in an amount sufficient to provide a free divalent metal ion content of from about 0.01% by weight to about 1% by weight relative to the total weight of the unheated food product.

32. A method according to claim 31, wherein the divalent metal ion salt is provided in an amount sufficient to provide a free divalent metal ion content of from about 0.1% by weight to about 0.3% by weight relative to the total weight of the unheated food product.

33. A method according to any of claims 22 to 32, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

34. A method according to any of claims 22 to 33, wherein the divalent metal ion salt is an alkaline earth metal salt.

35. A method according to any of claims 22 to 34, wherein the divalent metal ion salt is a calcium salt.

36. A method according to any of claim 35, wherein the calcium salt is any selected from the group consisting of calcium lactate, calcium carbonate, calcium citrate, calcium chloride, calcium phosphate, calcium sulfate, and any combination of the foregoing.

37. A method according to any of claims 22 to 36, wherein the unheated food product is less prone to browning when heated than the same food product in which the divalent metal ion salt is replaced with a corresponding potassium salt in a stoichiometric amount based on the metal ion content.

38. A method according to any of claims 22 to 37, wherein the heated food product is lighter in colour than the same food product in which the divalent metal ion salt is replaced with a potassium salt in a stoichiometric amount based on the metal ion content.

39. A method according to any of claims 22 to 38, wherein the unheated food product is less prone to acrylamide formation when heated than the same food product in which the divalent metal ion salt is replaced with a corresponding potassium salt in a stoichiometric amount based on the metal ion content.

40. A method according to any of claims 22 to 39, wherein the heated food product has a lower acrylamide content than the same food product in which the divalent metal ion salt is replaced with a potassium salt in a stoichiometric amount based on the metal ion content.

41. A food product comprising: a reducing saccharide, a divalent metal ion salt, and an amine-containing additional food ingredient.

42. A food product according to claim 41, wherein the additional food ingredient is any selected from the group consisting of leavening agents (such as yeast and the like), eggs or egg-derived products, fats, oils, milk and/or other dairy products, gums, natural and/or artificial colors, natural and/or artificial flavors (such as vanilla), chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins (including whey protein), amino acids, vitamins, wheat flours, non-wheat flours (such as rice, maize (corn), oat, rye, barley, tapioca, sago, amaranth, arrowroot, sorghum, pea, banana, potato and sweet potato flours), and any combination thereof.

43. A food product according to claim 41 or claim 42, wherein the amine is a protein, an amino acid, or a combination thereof.

44. A food product according to any of claims 41 to 43, wherein the food product comprises a non-reducing saccharide, such as sucrose.

45. A food product according to any of claims 41 to 44, wherein the food product has a saccharide content of from about 1% by weight to about 80% by weight relative to the total weight of the food product.

46. A food product according to any of claims 41 to 45, wherein the food product comprises the divalent metal ion salt in an amount sufficient to provide a free divalent metal ion content of from about 0.01% by weight to about 1% by weight relative to the total weight of the food product.

47. A food product according to any of claims 41 to 46, wherein the food product contains the divalent metal ion salt in an amount of from about 0.1% by weight to about 2.0% by weight relative to the total weight of the food product.

48. A food product according to any of claims 41 to 47, wherein the reducing saccharide is any selected from the group consisting of allulose, tagatose, allose, fructose, glucose, lactose, maltose, a polysaccharide, e.g. a soluble dietary fibre such as soluble corn fibre or polydextrose, or maltodextrin, or any combination of the foregoing.

49. A method according to any of claims 41 to 48, wherein the divalent metal ion salt is an alkaline earth metal salt.

50. A method according to any of claims 41 to 49, wherein the divalent metal ion salt is a calcium salt.

51. A food product according to claim 50, wherein the calcium salt is any selected from the group consisting of calcium lactate, calcium carbonate, calcium citrate, calcium chloride, calcium phosphate, calcium sulfate, and any combination of the foregoing.

52. A food product according to any of claims 41 to 51, wherein the food product is a precursor to a heated food product.

53. A food product according to claim 52, wherein the food product is a dough or batter.

54. A food product according to claim 52 or claim 53, wherein the food product is less prone to browning than the same food product in which the divalent metal ion salt is replaced with a corresponding potassium salt in a stoichiometric amount based on the free metal ion content.

55. A food product according to any of claims 52 to 54, wherein the food product is less prone to acrylamide formation than the same food product in which the divalent metal ion salt is replaced with a corresponding potassium salt in a stoichiometric amount based on the free metal ion content.

56. A food product according to any of claims 41 to 51, wherein the food product is a heated food product.

57. A food product according to claim 56, wherein the heated food product is a cake or biscuit.

58. A food product according to claim 56 or 57, wherein the food product is lighter in colour than the same food product in which the divalent metal ion salt is replaced with a corresponding potassium salt in a stoichiometric amount based on the free metal ion content.

59. A food product according to any of claims 56 to 58, wherein the food product has a lower acrylamide content than the same food product in which the divalent metal ion salt is replaced with a corresponding potassium salt in a stoichiometric amount based on the free metal ion content.
